(19) United States
(12) Patent Application Publication
(10) Pub. No.: US 2022/0085892 A1
(43) Pub. Date: Mar. 17, 2022

(54) SYSTEMS AND METHODS FOR HIGH SPEED INFORMATION TRANSFER

(71) Applicant: Joseph Anthony Sorge, Jackson, WY (US)

(72) Inventor: Joseph Anthony Sorge, Jackson, WY (US)

(21) Appl. No.: 17/343,603

(22) Filed: Jun. 9, 2021

Related U.S. Application Data
(63) Continuation-in-part of application No. 17/109,025, filed on Dec. 1, 2020.
(60) Provisional application No. 63/011,173, filed on Apr. 16, 2020.
(60) Provisional application No. 62/942,641, filed on Dec. 2, 2019.

(51) Int. Cl. H04B 10/524; H04B 13/00

(52) U.S. Cl. CPC H04B 10/524; H04B 13/00

(57) ABSTRACT

Described herein are systems and methods of information transfer using transmission of light through a moving medium in order to achieve higher speeds of information transfer. The medium may be moved through a conduit, either in one direction, or in an oscillating back-and-forth fashion. Light is transmitted through the moving medium in the conduit.

### CROSS REFERENCE TO RELATED APPLICATIONS

This application is a continuation-in-part of U.S. application Ser. No. 17/109,025, filed Dec. 1, 2020, which claims the benefit of U.S. Provisional Application Nos. 62/942,641, filed Dec. 2, 2019, and 63/011,173, filed Apr. 16, 2020, all of which are incorporated herein by reference in their entirety.

### BACKGROUND

### Field of the Invention

The present invention is related to the field of light-based information transfer.

### Description of the Related Art

Communication between two distant points is generally believed to be limited by the speed of light in a vacuum (c). In addition, when an electromagnetic wave is transmitted through a medium, the speed of the wave is slowed by a factor corresponding to the refractive index of the medium (v=c/n, where n is the refractive index). For example, a typical core in a fiber optic cable has a refractive index of about 1.5, reducing the maximum possible speed for information transfer by one third. Thus, there is a need for improved systems and methods that permit the transmission of information at speeds faster than attainable with current systems.

### SUMMARY OF THE INVENTION

The present disclosure is directed to systems and methods of information transfer using transmission of signals through a moving medium, or through media with refractive indices less than 1, in order to achieve higher speeds of information transfer. Some embodiments include a system for transmitting information from a first location to a second location, comprising a conduit running between the first and second locations; a material within the conduit; a material mover in fluid communication with the conduit; a signal source at the first location configured to transmit a signal through the material in the conduit; and a signal detector at the second location configured to detect the signal. Other embodiments include a method of transmitting information from a first location to a second location, the method comprising providing a conduit between the first and second locations; moving material within the conduit at a speed of at least 0.001 c, wherein c is the speed of light coming from a stationary source in vacuum; and transmitting light encoding the information through the moving material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A: The components of the velocity of light in a transverse “light clock” according to Einstein as perceived by Observer 1 traveling in a moving inertial frame of reference (“IRF”).

FIG. 1B: The components of the velocity of light in a transverse “light clock” according to Einstein as perceived by Observer 0 who sees Observer 1's light clock moving in the x-direction. v represents the speed at which the moving frame of reference is traveling in the x-direction. c′_{y} and t′ represent the speed of light and travel time, as perceived by Observer 1. t is the travel time as perceived by Observer 0. γ is the Lorentz factor at velocity v. ϕᵣ′ is the angle that Observer 1 perceives light to travel from bottom mirror to top mirror within the moving IRF. ϕₛ is the angle that Observer 0 perceives light to travel from bottom mirror to top mirror.

FIG. 2A: The components of the velocity of light in a longitudinal “light clock” according to Einstein as perceived by Observer 1 traveling in a moving reference frame.

FIG. 2B: The components of the velocity of light in a longitudinal “light clock” according to Einstein as perceived by Observer 0 who sees Observer 1's longitudinal light clock moving in the x-direction. v represents the speed at which the moving reference frame is traveling in the x-direction. Δt_{d} represents the time light travels downstream, and Δtᵤ represents the time that light travels upstream. γ is the Lorentz factor at velocity v.

FIG. 3: Diagram illustrating light aberration for one stationary source and two moving receivers. For each receiver, the dashed arrow signifies the direction that light travels at speed c and angle ϕₛ from source to receiver. The solid arrow represents the direction that the receiver travels at speed v from the instant light is emitted from the source to the instant light strikes the receiver. The dotted line connecting the source to the location of the receiver at the moment of light emission is shown to form the angle π−ϕᵣ′, which is the angle perceived by the receiver. That is, in special relativity the angle of approach as perceived by the receiver, ϕᵣ′, is the same as the angle subtended by the receiver's velocity vector and the line connecting the source to receiver at the instant of emission. Even though the dashed arrow represents the angle from the source (upon emission) to the receiver (upon detection) as perceived by the stationary source, the dotted line connecting the source to the receiver's location at the instant of emission is the same angle as the angle observed by the receiver upon detection (due to aberration), even though the receiver is located at the terminus of the dashed arrow upon detection.

FIG. 4. Diagram that illustrates an example of a receiver that moves rapidly with respect to light speed. The speed of the receiver in autumn is vₐ, and in spring, vₛₚ.

FIG. 5A is a diagram showing the derivation of the Doppler equation for a Stationary Source and a moving receiver (M.R.) that moves at speed v. A moving receiver (M.R.) located at one of the wavefronts is traveling leftward at speed yᵣ. The period of emissions coming from the stationary source is T₀. The wavelength coming from the source is cT₀. The wavelength experienced by the moving receiver is λᵣλ, and the angle formed by the direction of the light wave normal and the direction of the receiver is ϕₛ.

FIG. 5B shows advancement of the wavefronts from FIG. 5A and further displacement leftward of the moving receiver, where it comes in contact with the next wavefront.

FIG. 5C shows the angle ϕₛ formed by the directions of receiver and light, consistent with the conventions in FIG. 4.

FIG. 6: The emission of light from a source S that travels a distance γₛvT₀ to position S′ in one period. Light emitted at point S travels at speed γ_{ϕ}c, tracing a radius of length r=γ_{ϕ}cγₛT₀ shown as a red ellipse. The distance between S′ and the wavefront at the end of a period is the wavelength, λᵣ, between the initial wavefront emitted at point S and the subsequent wavefront emitted at point S′. A receiver at point I will perceive the light to have originated at point S even though the source has moved to point S′ while the light traveled from point S to point I. Since the Doppler effect for a moving source occurs at the moment of emission, the angle ϕ is what is used to compute the Doppler effect. Therefore there is no need to compute an aberration angle for purposes of computing wavelengths or frequencies coming from a moving source as observed by a stationary receiver. For receivers that are far from the source (many wavelengths), the γₛvT₀ distance becomes small as compared to the r distance as ϕ approaches π/2.

FIG. 7A: Plots of wavefronts predicted by the relativistic Doppler equation for receivers moving leftward at speed v/c=0.5 in the frame of the moving receivers. Aberration angles were used to compute the wavelengths, which is appropriate when the receiver is moving. Note the compression to the right and expansion to the left caused by the motion of the receivers relative to the stationary source.

FIG. 7B: Plots of wavefronts predicted by the alternative Doppler equation for receivers moving leftward at speed v/c=0.5 in the frame of the receivers. Note that the compression to the right is not as extreme, and the expansion to the left is greater, reflecting the lack of length contraction along the horizontal axis.

FIG. 7C: Plots of wavefronts predicted by the relativistic Doppler equation for a source moving rightward at speed v/c=0.5 in the frame of a stationary receiver. Note the compression to the right is unusual in shape. This pattern was generated with the classical relativistic Doppler equation using normal angles (which are the relevant angles for a moving source). The radial distances between the origin and points on the ellipses in panels A and C are the same, but the spatial locations are different due to the aberration angles. The differences in shapes between the plots in panels A and C raise concerns with respect to the principle of relativity.

FIG. 7D: Plots of wavefronts predicted by the alternative Doppler equation for a source moving rightward at speed v/c=0.5 in the frame of a stationary receiver. Note the regularity of the wave patterns. The alternative model does not support the principle of relativity, and so the different shapes between panels B and D is as expected.

FIG. 8: The graph compares the speed of light through moving water predicted by Fizeau's equation, special relativity's velocity addition formula, and the alternative velocity addition formula. Water speed is expressed as a fraction of c. Water speed is negative when it is flowing antiparallel (against) to the direction of light velocity. Note that special relativity predicts a significantly asymmetrical, non-linear change in light speed in response to negative water speeds.

FIG. 9A: The shift in wavelength, in meters, due to the first-order Doppler effect measured in the Ives Stilwell experiment compared to the shift predicted by special relativity and by the alternative model (“revised”).

FIG. 9B: The shift in wavelength, in meters, due to the higher-order Doppler effect measured in the Ives Stilwell experiment compared to the shift predicted by special relativity and by the alternative model (“revised”).

FIG. 10A: A stationary IRF in which a central light source (green star) emits light at the same wavelength, frequency, and speed in all direction. Concentric circles represent light waves. Dotted black arrows represent photons being emitted vertically and to the right horizontally. The vertical photon aligns with vertical grid line zero. Receivers R1 and R3 are within the IRF and detect light of the same wavelength, frequency, and speed. Receiver R2 is stationary, but not in the same IRF.

FIG. 10B: The same IRF as in A), but now in motion to the right. Receivers R1 and R3 move rightward, together with the source. For clarity, the first order Doppler effect is not shown in this figure. Only the higher order Doppler effect is shown. Receiver R2 is not in the same IRF and remains stationary on vertical grid line 2. The vertically moving photon shown in FIG. 10A has now reached receiver R3 as receiver R3 crosses vertical grid line zero. Photons emitted vertically from the source will continue to reach receiver R3 at a right angle to the direction of IRF motion. Photons emitted rightward from the source reach both receivers R1 and R2. The source is shown in red instead of green, to symbolize the higher order Doppler wavelength shift of the source. If length contraction were real, then receiver R1 should not see the higher order Doppler effect. This is symbolized as a green color at receiver R1. Receiver R2 is stationary, and represents a stationary observer in the Ives Stilwell experiment, where a higher order Doppler wavelength red shift was observed. The postulated lack of red shift at receiver R1 and the measured red shift at receiver R2 are mutually inconsistent. Given that special relativity postulates no length contraction in the direction transverse to IRF motion, receiver R3 should detect a higher order Doppler wavelength red shift. The detection of different wavelengths by receivers R1 and R3 would also violate one of Einstein's postulates.

### DETAILED DESCRIPTION

While not being bound by any particular theory, it is known that the speed of light through a medium increases relative to a stationary frame when the medium itself is moving relative to the stationary frame, parallel to the direction of light transmission. However it is widely believed that the speed of electromagnetic signal communication cannot exceed speed “c” in our universe. It is now determined that in some cases, effective superluminal speeds (greater than c) may be obtained by moving the source and/or the medium relative to the stationary frame at very high speeds. Accordingly, by transmitting electromagnetic radiation from a moving source, or through a moving medium, information may be transmitted at speeds higher than previously attainable.

In one embodiment, a conduit is provided between a first location and a second location. The conduit is filled with a medium, which is then moved generally along a central axis of the conduit. Light is then transmitted through the medium in the conduit from the first location and then detected at the second location. In some embodiments, information is encoded within the light, such as by frequency modulation, amplitude modulation, phase modulation, or pulse modulation.

The conduit may be constructed from any suitable material, including a metal, glass, or polymer. In some embodiments, the conduit is a closed loop such that two lengths of conduit run between the first and second locations which are then in fluid communication with each other at both the first and second locations. In some embodiments, light is transmitted from the first location using a laser and detected at the second location using a photodetector. In some embodiments, the conduit includes windows (e.g., made of glass) at the first and second locations to permit light to pass in and out of the conduit. In other embodiments, the light source and detector are incorporated within the conduct, with appropriate electronic cabling passing through a side wall of the conduit. Light transmission and detection electronics may be substantially as is used in current fiber optic systems. In some embodiments, the inner surface of the conduit includes a material that is reflective or has an index of refraction that is such to permit total internal reflection of the light as it passes through the medium in the conduit.

In some embodiments, the medium within the conduit has an index of refraction less than 2, 1.5, 1.4, 1.3, 1.2, 1.1, 1.05, 1.01, 1.001, 1.0001, 1.00001, 1.000001, or a range between any two of these values. In some embodiments, the medium within the conduit is a fluid, such as a gas, a supercooled substance, or a superconductor. In some embodiments, the medium within the conduit is helium, or supercooled helium. In some embodiments, the medium within the conduit is air. The medium may be moved within the conduit using any suitable mechanism for moving fluids, such as a variety of pumps. In some embodiments, the medium is moved substantially in one direction through the conduit. In such embodiments, the direction of medium flow may be either substantially parallel or anti-parallel to the direction of light passing through the conduit. In some embodiments, the speed of the medium through the conduit is at least 0.000001 c, 0.00001 c, 0.001 c, 0.005 c, 0.01 c, 0.05 c, 0.1 c, or a range between any two of these values.

In other embodiments, the direction of flow of the medium through the conduit is oscillated back and forth, such that during a first period of time, the direction of flow of the medium is generally parallel to the direction of signal passing through the conduit, and during a second period of time, the direction of flow of the medium is generally anti-parallel to the direction of signal passing through the conduit. In some embodiments, the frequency of oscillation of the medium is at least 1 Hz, 100 Hz, 1 kHz, 5 kHz, 10 kHz, 50 kHz, 100 kHz, 500 kHz, 1 MHz, 5 MHz, 10 MHz, 50 MHz, 100 MHz, 500 MHz, 1 GHz, or a range between any two of these values. In some embodiments where the direction of flow of the medium is oscillated back and forth, the maximum speed of the medium during the oscillation is at least 0.000001 c, 0.00001 c, 0.001 c, 0.005 c, 0.01 c, 0.05 c, 0.1 c, or a range between any two of these values.

In one embodiment, the conduit includes coils configured to generate magnetic fields suitable for containing charged particles within the conduit. For example, the coils may include dipole, quadrapole, and/or higher-pole coils. In some embodiments, the coils are constructed from superconducting material and the conduit includes suitable cooling apparatus for maintaining the material in a superconducting state. In some such embodiments, the medium within the conduct is a plasma (e.g., a helium plasma). Accordingly, some embodiments include an ionizer for ionizing gas (e.g., helium gas) and introducing it into the conduit. Some embodiments include a linear accelerator for accelerating the ionized gas prior to introduction into the conduit. In some embodiments, the plasma within the conduit is oscillated back and forth by modulating the magnetic field coils.

In another embodiment, the source of signal is generated by a source moving with respect to the stationary frame. Electromagnetic signal emitted in the longitudinal direction will travel, both parallel to the direction of the source and antiparallel to the direction of the source, faster than speed “c” with respect to a reference frame not moving relative to the source. There will be no upper limit to the speed of this longitudinal signal transmission, since signal speed will be a function that increases with source velocity.

### Principle of Operation

In his special theory of relativity, Einstein postulated that the laws of physics are equivalent in all inertial reference frames (“IRFs”), and that light travels in a vacuum at a constant speed regardless of reference frame [1]. These postulates led to a number of remarkable findings with respect to time, space, momentum, and energy. The concepts of “time dilation” and “length contraction” are based on these two postulates [2].

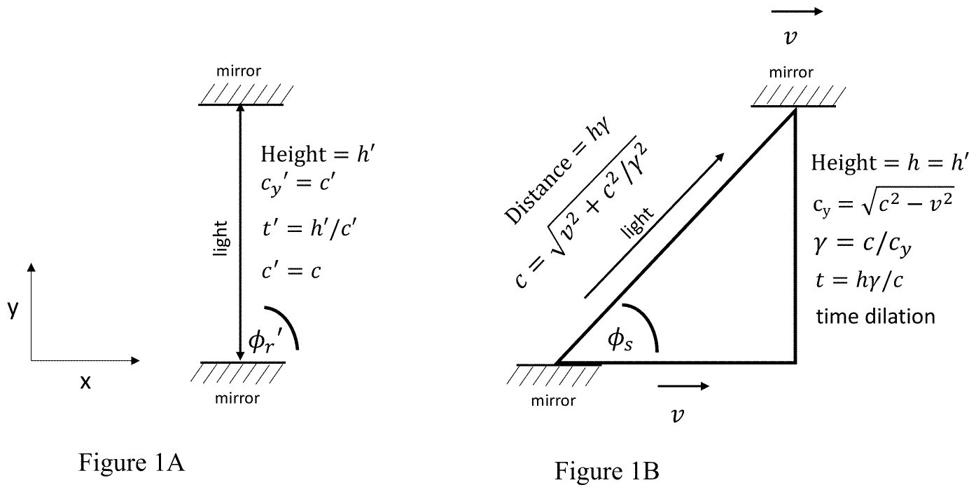

A well-known illustration of time dilation utilizes a thought experiment in which a light beam appears to travel between two parallel mirrors, along an axis that is 90 degrees to the direction of motion of an IRF moving at velocity v (FIGS. 1A and 1B). An observer within the moving IRF (Observer 1) will perceive light to be moving at a right angle to the direction of IRF motion. But an observer in a different IRF (Observer 0), will see the light beam traveling along a diagonal path [2]. FIGS. 1A and 1B illustrates two perceived paths; where, according to Einstein's postulates, the diagonal speed of light must be equal to c, which is 299,792,458 meters per second.

According to Einstein the y-component of light's velocity, c_{y} must equal \sqrt{c²−v²}, which must be less than c if v is not zero (FIG. 1B). Einstein utilized the Lorentz transformations to quantify the resulting impact on distance and speed [3]. The Lorentz transformations utilize a scaling factor represented by the symbol gamma,

$$γ = \frac{1}{\sqrt{1 - \frac{{v}^{2}}{{c}^{2}}}}$$

where v is the velocity of one inertial reference frame with respect to another reference frame, and c is the speed of light, both measured in meters per second. Note that if the numerator and denominator of the right side of the gamma equation are multiplied by c, the resulting quotient is equivalent to the ratio of the speed at which light is perceived to travel along the diagonal side of the right triangle in FIG. 1B, divided by the speed at which light is perceived to travel along its vertical side.

$$γ = \frac{c}{\sqrt{{c}^{2} - {v}^{2}}}$$

The equation c_{y}=\sqrt{c²−v²} can be rewritten as

c_{y}=c/γ (1)

In essence, the Lorentz factor reflects the factor by which the speed of the moving IRF causes the y-component of light's velocity, as seen by Observer 0, to be less than c.

If time is kept by the periodic bouncing of light against the mirrors, Observer 0 will see the vertical component of Observer 1's light traveling slower than light in a light clock in Observer 0's IRF, because Observer 0 will see Observer 1 ‘ s light traveling diagonally, γ fold farther at speed c. Whereas the light in a light-clock in Observer 1’ s IRF will not (appear to Observer 1 to) travel diagonally. Observer 1 does not know that the y-component of light speed is γ fold slower than c, because Observer 1's clock is calibrated to the ticks of light hitting the mirrors, and so a second′ for Observer 1 (per convention, primes will be used to denote properties of the moving IRF as observed by Observer 1) has a γ fold longer duration than a second for Observer 0 (“time dilation”). When Observer 1 unknowingly divides the γ-fold longer diagonal distance by a γ-fold longer second′, Observer 1 computes the same speed of light as Observer 0.

If the mirrors in FIG. 1A are separated by h′ meters′, the time that elapses while light travels from mirror to mirror and back is

Δt′=2h′/c′ seconds′,

as measured in Observer 1's meters′ and meters′ per second′ [2].

Observer 0, on the other hand, will measure the duration of the round trip interval, to be

Δt=2h/c_{y}=2γh/c seconds (2)

as counted in Observer 0's seconds. Since Einstein believed that Δx′/Δt′meters′/second′=c′=Δx/Δt meters/second=c, and h′ transverse meters'=h transverse meters, Observer 0 will record a larger number of seconds (because gamma is always equal to or greater than 1) than the number of seconds' recorded by Observer 1.

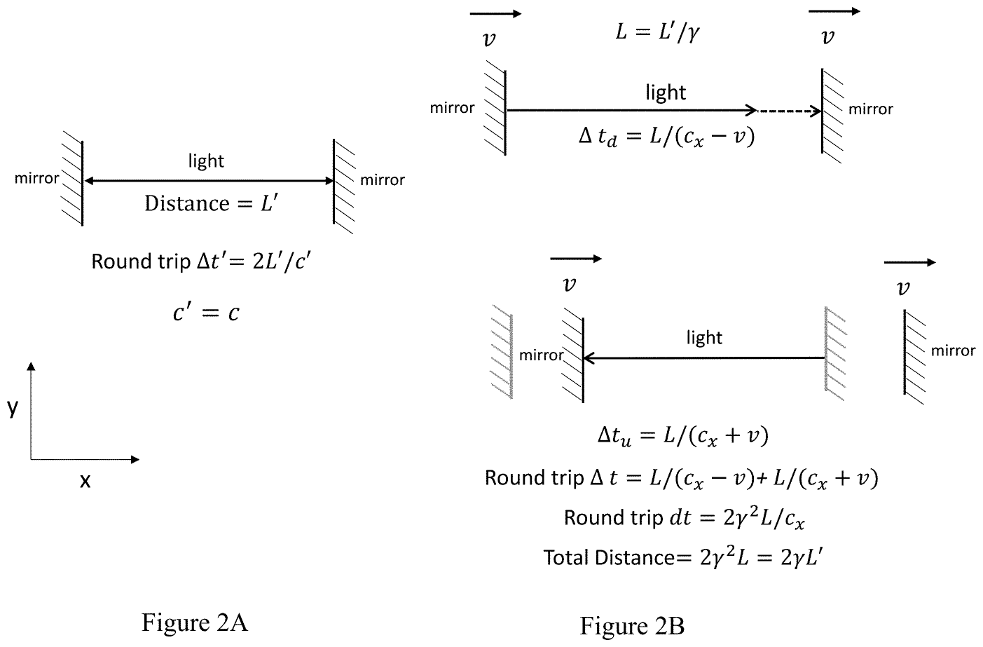

The situation becomes more complicated if light is bounced longitudinally within the moving IRF (FIGS. 2A and 2B). When light travels in the direction of the reference frame's motion, the “downstream” mirror recedes from the light. If we accept Einstein's postulate that light travels at a constant speed, c, regardless of the speed of the source of the light, then the relative speed at which Observer 0 measures light approaching the downstream mirror will be cₓ−v, where cₓ=c meters per second. When the reflected light returns “upstream”, its speed relative to the approaching upstream mirror will be cₓ+v meters per second. If the mirrors are separated by the static distance L′ meters′, then the length of time for light to travel from one mirror to the other and back should appear to Observer 1 to be

Δt′=2L′/c seconds′

But to Observer 0, who sees the different relative speeds (cₓ−v) and (cₓ+v),

$$Δ t = ( \frac{{L}^{′}}{{c}_{x} - v} + \frac{{L}^{′}}{{c}_{x} + v} )$$

which, if cₓ=c is equal to,

Δt=2γ²L′/c seconds (3)

provided that L′ meters′ are the same as L′ meters.

If the distance h′ between the mirrors in FIGS. 1A and 1B is equal to the distance L′ between the mirrors in FIGS. 2A and 2B, h′=L′ meters′; and if the horizontal length between mirrors observed by Observer 0 is also L′ meters=L′ meters′, then the longitudinal travel time, as measured by Observer 0, would be predicted by Equation (3) to be gamma times longer than the time required for light to travel the same distance in the transverse direction (Equation (3) divided by Equation (2)), provided that c, =c.

In 1887 Michelson and Morley published their famous experiment attempting to determine the speed at which the Earth was moving through a hypothetical “aether” [4]. They assumed that Equations (2) and (3) would yield different travel times for light moving in-line with the Earth's motion versus light moving perpendicular to Earth's motion. They found no difference, nor has anyone who has repeated the experiment with ever-greater precision since. Although Einstein later concluded that their experiment was destined to produce a null result in Earth's moving reference frame, he needed to explain how Observer 0 would also measure no difference between the time light travels along both arms of the Michelson Morley apparatus.

Lorentz, Fitzgerald, and Einstein (“LFE”) all concluded that lengths contract in the direction of the motion of an inertial reference frame, as observed by Observer 0 [1,3,5]. They conjectured that when Δt=0 (simultaneous in Observer 0's frame), the distance between longitudinally placed mirrors would physically contract by a factor of gamma, and the contracted meters' would equal a fewer number of uncontracted meters.

L_{c}=L′/γ meters

The time required for light to make the contracted longitudinal trip in Observer 0's frame would be,

$$Δ t = \frac{{L}_{c}}{{c}_{x} - v} + \frac{{L}_{c}}{{c}_{x} + v}$$

If cₓ=c then Equation (3) can be rewritten as

Δt(length contracted)=(2γ²L_{c}/c)=2γL′/c (4)

seconds.

To be clear, an uncontracted meter′ is the same length as a meter, but a contracted meter′ is shorter than a meter by a factor of γ. L′ in Equation (4) represents the original number of uncontracted meters′, whereas L_{c} represents the smaller number of meters that are equivalent in length to L′ contracted meters′. And if L′ meters′ (uncontracted)=h′=h, then the times for longitudinal and transverse light travel would be the same.

According to special relativity, the transverse (higher order) Doppler effect (“TDE”) reflects an actual reduction in the frequency emitted by a moving source (as detected in the stationary frame) compared to the frequency of the same source when stationary. This has been demonstrated experimentally in the longitudinal direction by Ives and Stilwell [6], Kaivola, et al [7], Grieser et al [8], and Botermann et al [9], and in the transverse direction by Chou, et al [23]. When light is transmitted from moving source to moving receiver within an IRF, the receiver's time dilation masks this higher-order reduction in frequency, since co-moving sources and receivers both measure frequency in the same gamma-fold, time dilated units of waves per second′. Since light speed equals wavelength times frequency, λf=c in special relativity, the actual reduction of frequency requires light either to travel slower, or wavelength to increase. Consistent with the transverse (higher order) Doppler effect, as demonstrated by Ives and Stilwell [6], wavelength increases gamma fold. This presents a concern in the moving frame. If emission wavelengths increase in the moving frame, observers in the moving IRF might see a higher order red shift from sources within their own IRF.

It is helpful to separate the primary and higher-order Doppler effects in this case. The primary Doppler compression of waves caused by a source moving parallel to the emitted light will be exactly reversed by a receiver moving at the same speed and in the same direction as the source. However, the higher order Doppler effect (TDE) will cause the source's emission frequency to be lower by a factor of γ_{L}, which will cause the emitted wave crests to be farther apart than otherwise. This would violate one of Einstein's postulates, that the laws of physics are the same regardless of the speed of the IRF. The LFE solution to this issue is length contraction between the source and receiver within the moving IRF. If lengths contract gamma fold between the source and receiver, then wavelengths will also contract gamma fold, and this will negate a longitudinal intra-IRF red shift. Thus, moving receivers would detect no red shift of longitudinal light coming from a source moving at the same velocity within the same IRF.

The very basic equation,

λ₀·f₀=c

could be written as,

$${λ}^{′} {f}^{′} = ( \frac{{γ}_{higher order Doppler}}{{γ}_{longitudinal length contractiom}} ) {λ}_{0} \cdot ( \frac{{γ}_{receiver time dilation}}{{γ}_{higher order Doppler}} ) {f}_{0} = c \qquad ( 5 )$$

for the moving IRF, to reflect the postulated compensations for a) intra-IRF red shift (compensated for by contracting wavelengths in the direction of motion) and b) moving emitter frequency reduction (compensated for by time dilation of the moving receiver).

The Lorentz transformations and Einstein's special theory of relativity are built upon the assumption that longitudinal light traveling within a moving IRF moves between contracted distances, and thus will exhibit contracted wavelengths to Observer 0. This concept of longitudinal length contraction of wavelengths means that everything between every intra-IRF source-receiver pair: every cloud, planet, star, and galaxy must physically contract in the LFE model, potentially over distances of billions of light years. If true, this must happen for billions of source-receiver pairs in concert. And when non-colinear IRFs intersect, then objects within the intersecting region must contract in more than one dimension simultaneously. Additionally, after one IRF passes through another IRF, objects that were once within the intersection must re-inflate as the IRFs disentangle, and re-contract when other IRFs pass through.

The LFE contraction, if it is real, cannot merely be an illusion or virtual effect. Length contraction is not the same as the Terrell effect, which has to do with the time required for light to travel from an object to a distant observer [10]. According to the Lorentz transformation for Δx′, when Δt=0 (simultaneous events in Observer 0's frame) Δx′=γΔx, which means that Δx=Δx′/γ. Which means that the physical distance separating simultaneous events in Observer 0's frame, such as for example the firing of paintballs downward from the front and back of a moving train of proper length Δx′ uncontracted meters, will result in actual paint marks on the tracks Δx′/γ meters apart. The distance between the marks will be shorter than the train length at rest. The Lorentz transformations do not provide room for an inattentive Observer 0 to believe that non-simultaneous events occur simultaneously. The Lorentz transformations refer to when events occur in the relevant frame, not when they are perceived to occur. Therefore, if the Lorentz transformations provide a true description of reality, then lengths, including wavelengths and intra-IRF source-receiver distances, must physically contract, in real time, changing constantly in different dimensions as myriad source-receiver pairs cross paths.

Attempts to measure length contraction have been less than conclusive [11,12,13,14]. Various paradoxes have been put forth to examine the validity of length contraction [15,16,17,18]. Rotating objects that are contracted along one axis must re-expand, and then contract along a different axis during rotation relative to the direction of motion. Little has been published to examine the inevitable impact on intramolecular and subatomic forces and energies that would result from length contraction. Rigid materials would have to contract as easily and quickly as compressible materials. The energy and thermodynamic implications of length contraction and re-expansion, especially over billions of light years, has not been adequately explained. Yet, likely because a viable alternative has not been put forth, the concept has generally been accepted.

Fortunately, the result of the Michelson Morley experiment, and other tests of special relativity, can be explained in other ways. One trivial alternative would be “length expansion” in the direction perpendicular to the motion of the reference frame. But this alternative raises objections similar to those raised by length contraction. Another explanation would be an anisotropic effect of motion on time. For example, time dilation could occur in the longitudinal direction, but not perpendicular to it. Or time contraction could occur perpendicular to the direction of motion, but not longitudinally. However, there is substantial evidence for time dilation in rough proportion to yin GPS satellite clock systems [19], and there have been no reports of non-isotropic time dilation to date.

Another alternative to length contraction would challenge one of Einstein's fundamental postulates: the constancy of the speed of light in space. If light traveled at a different speed longitudinally versus transversely, as perceived by Observer 0, the Michelson Morley result could be explained without length contraction. For example, if light traveled c/γ in the transverse direction, Observer 0 would measure the time of travel to be same in both arms of the Michelson Morley apparatus. Unfortunately, this solution would require the y-component of light, c_{y} in FIG. 1B, to travel at c/γ² instead of the c/γ speed predicted by special relativity. This would cause time dilation to be proportional to γ² instead of γ, which would not be consistent with experimental evidence related to time dilation.

Another alternative is for light to travel at speed c transverse to the direction of IRF motion, and a factor of “gamma” faster in the direction of IRF motion. The present disclosure analyzes this possibility.

### Postulates

For purposes of the present disclosure, the relationships between distance, time, speed, mass, and energy can be elucidated with the following postulates:
(1) Time measurements will be dilated in an inertial reference frame moving at speed β=v/c by a factor of γₛ=\sqrt{1+β²}.
(2) As measured from a stationary frame, the speed of light emitted from an inertial reference frame moving at speed β=v/c will be γ_{ϕ}·c=\sqrt{(1+β²)/(1+β² sin²ϕ)}·c meters per second, where the angle ϕ is the direction of light-travel measured with respect to the direction of motion of the moving inertial reference frame.

### The Alternative Model

Assume a universe where meter sticks are the same length as in Einstein's universe but do not contract. Since the mathematical relationships in the longitudinal Lorentz transformations assume length contraction, the alternative model assumes that the Lorentz time-dilation factor γₜ is here replaced with γₛ, the Lorentz length transformation factor γₗ is replaced with γ_{ϕ}, Δx′ is replaced with γ_{ϕ}Δx′ to reverse the assumption of length contraction in Lorentz's transformations. (Lorentz and Einstein used the symbol γ to mean different things in different equations. y either means meters/contracted meters′ or seconds/seconds′ (shown as γₗ and γₜ respectively) or contracted meters′/meter or seconds′/second (shown as γₗ, and γₜ, respectively) to convert between frames. In the alternative transformations, with no length contraction, the conversion between observed travel distance in the moving versus stationary frames is a unitless γ_{ϕ}²; and γₛ denotes the velocity-dependent time dilation function that converts seconds′ in the moving frame to seconds in the stationary frame.) And the speed of light in the longitudinal direction is labeled cₓ.

| Lorentz | Alternative (first step) |
|---|---|
| Δx = γₗΔx′ + γₜΔt′ | Δx = γ_{ϕ}²Δx′ + γₛvΔt′ |
| Δt = γₜΔt′ + γₗvΔx′/c² | Δx = γₛΔt′ + γ_{ϕ}²vΔx′/cₓ² |
| Δx′ = γ_{l′}Δx − γ_{l′}vΔt | γ_{ϕ}Δ′ = γ_{ϕ}Δx − γ_{ϕ}vΔt |
| Δt′ = γ_{t′}Δt − γ_{t′}vΔx/c² | Δt′ = γₛΔt − γ_{ϕ}vΔx/cₓ² |

When Δx′=0, events occur at the same location within a moving IRF. The alternative Δt transformation then becomes Δt=γₛΔt′, revealing that, as in the original Lorentz transformations, the tempo of time at a single location within a moving IRF is different than in a relatively stationary IRF (the formula for γₛ will be derived below).

Equation (2) shows Δt for a “round trip”. For the one-way trip in the alternative model, Equation (2) is divided by 2 and γ is replaced with γₛ,

$$Δ t = \frac{{γ}_{s} h}{c} .$$

In agreement with special relativity (and with the absence of length contraction in any dimension), Δy′=Δy, which in this example means that h′=h. Therefore,

$$\frac{Δ y}{Δ t} = \frac{hc}{{γ}_{s} h} = \frac{c}{{γ}_{s}} .$$

As observed from the stationary frame, the y-component of light speed for light that originated within a moving IRF is c/γₛ.

Since Δy′=Δy and h′=h, the equation above becomes,

Δy′/Δt=h′c/γₛh=c/γₛ

And since Δt=γₛΔt′ when Δx′=0,

$$\frac{Δ {y}^{′}}{Δ {t}^{′}} = \frac{Δ {y}^{′}}{Δ t / {γ}_{s}} = {γ}_{s} c / {γ}_{s} = c$$

confirming that light speed in the y direction for light that originated within a moving IRF as observed from within the moving IRF is equal to c. The same would be true in the z direction.

Since the Lorentz length-contraction and time-dilation factors are numerically equivalent, it will be assumed for the moment (and confirmed below) that the same is true for motion in the longitudinal direction in the alternative model,

γ_{ϕ}(longitudinal)=γₛ

If the alternative Δx transformation is divided by the Δt transformation, the numerator and denominator divided by Δt′, and Δx′/Δt′ replaced with c (an assumption that will be proved below), an expression is obtained for Δx/Δt,

$$\frac{Δ x}{Δ t} = \frac{{γ}_{ϕ}^{2} c + {γ}_{s} v}{{γ}_{s} + {γ}_{ϕ}^{2} vc / {c}_{x}^{2}}$$

Renaming Δx/Δt as cₓ, equating γ_{ϕ} with γₛ, and rearranging,

$${γ}_{s} {c}_{x} + \frac{{γ}_{s}^{2} vc}{{c}_{x}} = {γ}_{s}^{2} c + {γ}_{s} v$$

Solving for cₓ yields

cₓ=γₛc.

That is, longitudinal light speed as observed from a “stationary” frame is scaled in proportion to the alternative gamma factor γₛ.

γₛ can be derived by computing round trip time Δt with respect to γₛc and v.

$$Δ t = \frac{{L}^{′}}{{γ}_{s} c - v} + \frac{{L}^{′}}{{γ}_{s} c + v} = \frac{2 {γ}_{s} {cL}^{′}}{{γ}_{s}^{2} {c}^{2} - {v}^{2}} \qquad ( 6 )$$

Since the Michelson Morley result must also hold true in the alternative model, the value for Δt must be consistent with Equations (2) and (4) when γ is replaced with γₛ.

$$\frac{2 {γ}_{s} {cL}^{′}}{{γ}_{s}^{2} {c}^{2} - {v}^{2}} = \frac{2 {γ}_{s} {L}^{′}}{c} \\ c / ( {γ}_{s}^{2} {c}^{2} - {v}^{2} ) = 1 / c \\ {c}^{2} = {γ}_{s}^{2} {c}^{2} - {v}^{2} \\ {γ}_{s}^{2} = ( {c}^{2} + {v}^{2} ) / {c}^{2} = 1 + {v}^{2} / {c}^{2} \\ {γ}_{s} = \sqrt{1 + {v}^{2} / {c}^{2}} \qquad ( 7 )$$

The validity of Equation (7) is supported by substituting cₓ for c in the equation for Lorentz's γ,

$${γ}_{s} = \frac{1}{\sqrt{1 - \frac{{v}^{2}}{{c}_{x}^{2}}}}$$

By squaring both sides of cₓ=γₛc

$${c}_{x}^{2} = \frac{{c}^{2}}{1 - \frac{{v}^{2}}{{c}_{x}^{2}}} \\ {c}_{x}^{2} - {v}^{2} = {c}^{2} \\ {c}_{x} = \sqrt{{c}^{2} + {v}^{2}} = c \sqrt{1 + {v}^{2} / {c}^{2}} = c {γ}_{s} \\ {γ}_{s} = \sqrt{1 + {v}^{2} / {c}^{2}}$$

The speed of light emitted longitudinally from a moving source is γₛc in a universe with no length contraction. In such a universe, motion causes longitudinal light speed to increase by γₛ and time to dilate by γₛ. Interestingly, γₛ grows from 1, when v=0, to a number larger than 1 with no upper bound, even when the absolute value of v exceeds c. Clocks continue to slow as v increases, and speeds and frequencies, as expressed in time-dilated meters/second′, continue to increase. Lorentz's γ tends toward infinity as v approached c. That necessarily follows from the assumption that motion causes length contraction. Without that assumption, superluminal speeds are not prohibited.

The expressions in Equations (2), (3), and (4), restated using γₛ, become

$$Δ t = \frac{2 {γ}_{s}^{2} L}{{c}_{x}} = \frac{2 {γ}_{s}^{2} L}{{γ}_{s} c} = \frac{2 {γ}_{s} L}{c} = \frac{2 {γ}_{s} {L}^{′}}{c} = \frac{2 {γ}_{s} {h}^{′}}{c} = \frac{2 {γ}_{s} h}{c}$$

thereby reconciling the Michelson Morley result in all frames without length contraction.

The last ratio might be interpreted to imply that, from the stationary perspective, if light is aimed so that it strikes a target lying orthogonal to but co-moving with the light's source, it will travel a round trip distance of 2γₛh at speed c. Actually, the one-way diagonal distance (as seen from the stationary frame) that light travels when aimed so that it strikes the orthogonally positioned, co-moving target is,

$$diagonal distance = \sqrt{{h}^{2} + {v}^{2} {γ}_{s}^{2} Δ {{t}^{′}}^{2}}$$

where time dilation is represented by Δt=γₛΔt′, and distance the IRF moves is represented by vΔt=vγₛΔt′.

The speed at which light travels to the co-moving target (Δx′=0 when co-moving), from the perspective of the stationary frame is,

$${c}_{diagonal} = \frac{diagonal distance}{Δ t} = \sqrt{\frac{{h}^{2}}{Δ {t}^{2}} + {v}^{2}} = \sqrt{\frac{{c}^{2}}{{γ}_{s}^{2}} + {v}^{2}} \qquad ( 8 )$$

Dividing diagonal distance by c_{diagonal} yields Δt, which is the same time as in the restated Equations (2), (3), and (4) above. Expressed differently, the details behind the Michelson Morley result are revealed in,

$$Δ t = Δ {t}_{diagonal} = Δ {t}_{longitudinal} = Δ {t}_{transverse}$$

$$Δ t = \frac{\sqrt{{h}^{2} + {v}^{2} {γ}_{s}^{2} Δ {{t}^{′}}^{2}}}{\sqrt{\frac{{c}^{2}}{{γ}_{s}^{2}} + {v}^{2}}} = \frac{{γ}_{s}^{2} L}{{γ}_{s} c} = \frac{h}{c / {γ}_{s}}$$

The expression for c_{diagonal} contains the y-component of light speed as seen from the stationary frame, c/γₛ, when the light is aimed orthogonally at a co-moving target from the perspective of the moving IRF (c_{y}=c/γₛ), and the x-component of light speed, v. For confirmation, since the Michelson Morley result must hold in all IRFs, round trip travel time in the x and y directions must be equal. Therefore if L=h, as in the Michelson Morley experiment, then h divided by the y-component of light speed must equal the longitudinal distance, γₛ²L, divided by longitudinal light speed, γₛc.

$$\frac{2 {γ}_{s}^{2} L}{{γ}_{s} c} = 2 h / {c}_{y}$$

After substitutions,

$${c}_{y} ( the y component of light speed = Δ y / Δ t ) = \frac{hc {γ}_{s}}{{γ}_{s}^{2} L} = \frac{c}{{γ}_{s}}$$

When v=0, γₛ=1, and the y-component of light speed equals c. To be clear, when light is aimed 90 degrees from the direction of IRF motion, where the angle is measured from the stationary perspective, the light will travel at speed c; but when light is aimed 90 degrees from the direction of IRF motion, where the 90 degree angle is measured by observers in the moving IRF (also referred to as ϕ′), the light will travel at an angle, ϕ, from the perspective of observers in the stationary frame,

$$ϕ = arctan ( \frac{h}{v Δ t} )$$

Its speed will be c_{diagonal} meters per second, and the y-component of its speed will be c/γₛ meters per second.

The equation for c_{diagonal} can be rewritten as,

$${c}_{diagonal} = c \sqrt{\frac{1}{{γ}_{s}^{2}} + \frac{{v}^{2}}{{c}^{2}}} = c \sqrt{\frac{1 + {β}^{2} + {β}^{4}}{1 + {β}^{2}}} = c \sqrt{1 + {β}^{2} \frac{{β}^{2}}{1 + {β}^{2}}} < c \sqrt{1 + {β}^{2}} = c {γ}_{s} ,$$

where β=v/c. That is, light travels faster than c along a diagonal path, but not as fast as light travels along a longitudinal path.

A similar but independent way to derive c_{diagonal} for a Michelson Morley type setup is to again equate a) the time required for light to travel diagonally with b) the average time required for light to travel longitudinally. Light aimed transversely from the perspective of the moving frame (90 degree aberration angle) is observed to move diagonally from the perspective of the stationary frame.

As above, t_{diagonal} can be derived from,

$$Δ {t}_{diagonal}^{2} = \frac{{h}^{2} + {v}^{2} Δ {t}_{diagonal}^{2}}{{c}_{diagonal}^{2}} ,$$

which after several algebraic steps,

$$Δ {t}_{diagonal} = \frac{h}{\sqrt{{c}_{diagonal}^{2} - {v}^{2}}} .$$

As derived earlier, the average time for light to travel longitudinally is,

$$Δ {t}_{longitudinal , average} = 0.5 ( \frac{{L}^{′}}{{c}_{x} - v} + \frac{{L}^{′}}{{c}_{x} + v} ) = \frac{{L}^{′} {c}_{x}}{{c}_{x}^{2} - {v}^{2}} ,$$

where cₓ=γₛc is the speed of light in the longitudinal direction.

If the average longitudinal time is equated with the diagonal time, then

$$\frac{h}{\sqrt{{c}_{diagonal}^{2} - {v}^{2}}} = \frac{{L}^{′} {c}_{x}}{{c}_{x}^{2} - {v}^{2}} .$$

Substituting γₛc for c, and L′ for h (these distances are equal in the Michelson Morley setup) the following is obtained,

$$\frac{{L}^{′}}{\sqrt{{c}_{diagonal}^{2} - {v}^{2}}} = \frac{{L}^{′} {γ}_{s} c}{{γ}_{s}^{2} {c}^{2} - {v}^{2}} \\ \frac{1}{\sqrt{{c}_{diagonal}^{2} - {v}^{2}}} = \frac{{γ}_{s} c}{{c}^{2} + {v}^{2} - {v}^{2}} = \frac{{γ}_{s}}{c} \\ \frac{1}{{c}_{diagonal}^{2} - {v}^{2}} = \frac{{γ}_{s}^{2}}{{c}^{2}} \\ \frac{{c}^{2}}{{γ}_{s}^{2}} + {v}^{2} = {c}_{diagonal}^{2} \\ \frac{{c}^{2}}{1 + {v}^{2} / {c}^{2}} + {v}^{2} = {c}_{diagonal}^{2} \\ \frac{{c}^{2} + {v}^{2} + {v}^{4}}{1 + {v}^{2} / {c}^{2}} = {c}_{diagonal}^{2}$$

If longitudinal light travels at γₛc, and pure transverse light (as observed from the stationary frame) travels at c, then it is reasonable to assume that c_{diagonal} will travel at some intermediate speed. If the angle formed between the diagonal light path and the longitudinal axis is ϕ, then this intermediate speed can be represented as,

$${c}_{diagonal} = {γ}_{ϕ} c . \\ and so , \\ \frac{{c}^{2} + {v}^{2} + {v}^{4} / {c}^{2}}{1 + {v}^{2} / {c}^{2}} = {γ}_{ϕ}^{2} {c}^{2} .$$

Dividing both sides by c² and taking the square root of both sides,

$${γ}_{ϕ , MM} = \sqrt{\frac{1 + \frac{{v}^{2}}{{c}^{2}} + \frac{{v}^{4}}{{c}^{4}}}{1 + \frac{{v}^{2}}{{c}^{2}}}} = \sqrt{\frac{1 + {β}^{2} + {β}^{4}}{1 + {β}^{2}}} = \sqrt{1 + {β}^{2} \frac{{β}^{2}}{1 + {β}^{2}}} < \sqrt{1 + {β}^{2}} = {γ}_{s}$$

This confirms the formula derived above (MM refers to a Michelson Morley setup). Light traveling diagonally at an angle ϕ with respect to the longitudinal axis (the axis of IRF motion) travels at speed γ_{ϕ}c.

Now with a formula for γ_{ϕ}, it is possible to confirm that the time required for light to travel diagonally as observed from the stationary frame is γₛ times L′/c,

$$Δ {t}_{diagonal} = \frac{diagonal distance}{{c}_{diagonal}} = \frac{diagaonal distance}{{γ}_{ϕ} c} = \sqrt{\frac{{{L}^{′}}^{2} + {v}^{2} Δ {t}_{diagonal}^{2}}{{γ}_{ϕ} c}}$$

$$Δ {t}_{diagonal} = \frac{\sqrt{{{L}^{′}}^{2} + {v}^{2} Δ {t}_{diagonal}^{2}}}{\sqrt{\frac{1 + {β}^{2} + {β}^{4}}{1 + {β}^{2}} c}}$$

$$\sqrt{\frac{1 + {β}^{2} + {β}^{4}}{1 + {β}^{2}}} c Δ {t}_{diagonal} = \sqrt{{{L}^{′}}^{2} + {v}^{2} Δ {t}_{diagonal}^{2}}$$

$$( \frac{1 + {β}^{2} + {β}^{4}}{1 + {β}^{2}} ) {c}^{2} Δ {t}_{diagonal}^{2} = {{L}^{′}}^{2} + {v}^{2} Δ {t}_{diagonal}^{2}$$

$$Δ {t}_{diagonal}^{2} = \frac{{{L}^{′}}^{2}}{( \frac{1 + {β}^{2} + {β}^{4}}{1 + {β}^{2}} ) {c}^{2} - {v}^{2}}$$

$$Δ {t}_{diagonal}^{2} = \frac{{{L}^{′}}^{2}}{\frac{{c}^{2}}{1 + \frac{{v}^{2}}{{c}^{2}}}} = \frac{{γ}_{s}^{2} {{L}^{′}}^{2}}{{c}^{2}}$$

$$Δ {t}_{diagonal} = \frac{{γ}_{s} {L}^{′}}{c} .$$

And, as shown above, since the time required for light to travel diagonally round trip must equal the time required for light to travel longitudinally round trip in the Michelson Morley experiment,

$$\frac{2 {γ}_{s} {L}^{′}}{c} = \frac{2 {γ}_{s} {cL}^{′}}{{γ}_{s}^{2} {c}^{2} - {v}^{2}}$$

light must travel at speed γₛc in the longitudinal direction and at speed γ_{ϕ}c when traveling at angle ϕ with respect to the axis of IRF motion.

The formula for γ_{ϕ,M,M} above is appropriate for a Michelson Morley experiment where the angle ϕ is determined by the velocity v of the IRF. However, light can be emitted from a moving source at any angle. A more general formula can be derived for γ_{ϕ} as a function of the emission angle. When c_{diagonal} is plotted as a function of v it traces an elliptical pattern with major axis equal to γₛcΔt and minor axis equal to cΔt. The distance that light travels in Δt seconds for any value of v can be computed with the equation for an ellipse,

$$\frac{{x}^{2}}{{γ}_{s}^{2}} + {y}^{2} = {c}^{2} Δ {t}^{2}$$

When v=0, then γₛ=1 and the equation resolves to the equation for a circle with radius cΔt.

In three dimensions, when v=0, light waves travel in concentric spheres. But when v≠0, the waves form an ellipsoid with y, z symmetry around the x-axis (where the x-axis is the direction of IRF motion), of the form

$$\frac{{x}^{2}}{{γ}_{s}^{2}} + {y}^{2} + {z}^{2} = {c}^{2} Δ {t}^{2}$$

Or, loosely analogous to the space-time interval of special relativity,

$${c}^{2} Δ {t}^{2} - \frac{{x}^{2}}{{γ}_{s}^{2}} + {y}^{2} + {z}^{2} = {s}^{2}$$

If y=z, and s=0, then

$$y = z = \sqrt{\frac{{c}^{2} Δ {t}^{2} - {x}^{2} / {γ}_{s}^{2}}{2}}$$

When y and z are zero, x and −x are at their maximum and minimum, respectively. When x=0, y and z are at their maxima.

In polar coordinates, the radius of an ellipse can be computed with,

$${r}_{ellipse} = \frac{ab}{\sqrt{{a}^{2} {sin}^{2} ϕ + {b}^{2} {cos}^{2} ϕ}} ,$$

where a represents the major axis, which here would be γₛcΔt, and b represents the minor axis, which here would be cΔt. This produces the equation,

$${r}_{ellipse} = \frac{{γ}_{s} c Δ tc Δ t}{\sqrt{{( {γ}_{s} c Δ t )}^{2} {sin}^{2} ϕ + {( c Δ t )}^{2} {cos}^{2} ϕ}}$$

Factoring cΔt from numerator and denominator,

$${r}_{ellipse} = \frac{{γ}_{s}}{\sqrt{{γ}_{s}^{2} {sin}^{2} ϕ + {cos}^{2} ϕ}} c Δ t = \frac{\sqrt{1 + {v}^{2} / {c}^{2}}}{\sqrt{1 + {v}^{2} {sin}^{2} ϕ / {c}^{2}}} c Δ t$$

In general, the wave pattern of light (in two dimensions) coming from a moving source is in the shape of an ellipsoid (ellipse) described (in two dimensions) by,

$${γ}_{( t )} cΔt = \sqrt{\frac{1 + {β}^{2}}{1 + {β}^{2} {sin}^{2} ϕ}} c Δ t$$

where ϕ is the angle between the direction of the moving source and the direction of light emitted from the source, as measured from the perspective of the stationary frame. Therefore a more general formula for γ_{ϕ} at any emission angle is,

$${γ}_{ϕ} = \sqrt{\frac{1 + {β}^{2}}{1 + {β}^{2} {sin}^{2} ϕ}}$$

For any given value of IRF speed v, light travels at its greatest speed in the longitudinal direction (sin ϕ=0 and γ_{ϕ}=γₛ). When sin ϕ=1 light travels at speed c in the transverse direction.

This formula for γ_{ϕ} is consistent with the formula derived from the Michelson Morley experiment,

$${γ}_{ϕ , MM} = \sqrt{\frac{1 + {β}^{2} + {β}^{4}}{1 + {β}^{2}}}$$

confirming that light radiates in an elliptical pattern from a moving source, as observed from the stationary frame.

When the alternative Δx′ transformation is divided by the Δt′ transformation, an expression is obtained for light speed in the x-direction within the moving IRF,

$$\frac{Δ {x}^{′}}{{Δt}^{′}} = \frac{Δx - v Δ t}{{γ}_{s} Δ t - \frac{{γ}_{s} v Δ x}{{γ}_{s}^{2} {c}^{2}}}$$

When numerator and denominator are divided by Δt,

$$\frac{Δ {x}^{′}}{Δ {t}^{′}} = \frac{{γ}_{s} c - v}{{γ}_{s} - \frac{v}{c}} = \frac{c ( {γ}_{s} - \frac{v}{c} )}{{γ}_{s} - \frac{v}{c}} = c$$

confirming that the alternative transformations are consistent with an observer in the moving IRF measuring light to be traveling at speed c in the x-direction (as well as in the y and z directions).

Thus the alternative transformations describe a universe that is consistent with our Earth-bound observations (light travels at speed c in all directions) and with the result of the Michelson Morley experiment. Light emitted by a stationary source also travels at speed c in the stationary frame (γ_{ϕ}=1), but can be perceived to travel at γₛc meters per second′ by a moving observer due to dilation of the observer's clock. It is only light emitted by a moving source as observed from a stationary frame that travels at γ_{ϕ}c, a difference that would be imperceptible except for sources moving very rapidly toward or away from a stationary observer.

### Relativistic Doppler Effect

Einstein predicted that the frequency of light emitted by a moving source would decrease with increasing speed in proportion to the Lorentz factor [20]. This is called the transverse Doppler effect. Champeney et al performed a Mossbauer experiment [21] showing that a stationary receiver will detect a lower frequency when light comes from a moving source versus from a stationary source, supporting Einstein's prediction (In special relativity, when reference is made to a “stationary frame”, the frame can be any reference frame deemed to be stationary. However the concept of an arbitrary stationary frame is problematic, even for special relativity. The alternative model assumes that the stationary frame is a unique frame, such as the frame of the cosmic microwave background radiation “CMBR”).

To be clear, a moving source will emit light at a frequency that is γ-fold lower as measured in a stationary observer's waves per second (fᵣ=fₛ′/γ waves per second) (22). On the other hand, observers in the frame of the moving source will detect fₛ′=f₀ waves for every one of their time-dilated moving seconds′. The frequency f₀ is the frequency emitted by a source when such source is stationary within an inertial reference frame (the reference frame may be moving, but the source is not moving within the frame).

Champeney et al (21) and Chou (23) also showed that a receiver moving with respect to a source (and with respect to the laboratory) will measure a higher frequency, in units of waves per second′, as compared to when the source and receiver are stationary.

Einstein modified the classical Doppler equations for a moving receiver and a stationary source, and for a moving source and a stationary receiver, compensating each moving object for time dilation, and thereby derived two equations for the relativistic Doppler effect [20].

$$\begin{matrix}{f}_{r}^{′} = {f}_{0} {γ}_{L} ( 1 - \frac{{v}_{γ}}{c} cos {ϕ}_{s} ) , \\ and & ( 9 ) \\ {f}_{r} = \frac{{f}_{s}^{′}}{{γ}_{L} ( 1 - \frac{{v}_{s}}{c} cos {ϕ}_{r} )} , & ( 10 )\end{matrix}$$

where, fᵣ′ is the frequency observed by a receiver that is moving with respect to a reference observer (expressed in waves per time-dilated second′); fᵣ is the frequency observed by a receiver that is stationary within the frame of a reference observer (expressed in waves per stationary-frame second); f₀ is the emission frequency coming from a source that is stationary in the frame of a reference observer (expressed in waves per second) and fₛ′ is the emission frequency coming from a source that is moving with respect to the frame of a reference observer as measured in the frame of the moving source (expressed in waves per time-dilated seconds′). γ_{L}=1/\sqrt{1−v²/c²} is the Lorentz factor, where v is the speed of the object that is deemed to be moving, as measured in meters per second from the frame that is considered to be stationary. Note that the Lorentz factor that Einstein used is independent of the direction of motion of the moving object. This is because the modifications that Einstein made to the classical Doppler equations have to do with time dilation, which is independent of the direction of object motion. vᵣ is the speed of a receiver (expressed in meters per second) relative to a stationary reference observer. Einstein chose to deviate from the Doppler convention with respect to the polarity of receiver speed. In the classical Doppler formulas, speed is positive when a source and receiver move closer to each other, and it is negative when they move farther apart. Einstein instead chose to conform to a Lorentz setup, where moving objects are considered to be moving parallel to the x-axis, and having positive speed when moving in the positive x-direction. If a stationary source lies at the origin of the stationary frame, then a receiver moving in the positive x-direction would have a positive speed using the Einstein convention and a negative speed using the Doppler convention. Thus Einstein used a minus sign in Equation (9) whereas such would be a plus sign in the classical Doppler formula for a moving receiver. vₛ is the speed of a source (expressed in meters per second) relative to a stationary observer where a positive speed represents the source moving toward the receiver. This latter polarity is consistent with the Doppler convention, but not with respect to movement along the x-axis. c is light speed expressed in meters per stationary frame second, and ϕₛ is the angle subtended by the vector connecting the source at the instant of emission to the receiver at the instant of observation, and the vector describing the velocity of the moving element (receiver or source), where the origins of such vectors (light and moving element) are superimposed. Note that the angles ϕₛ and ϕᵣ are measured from the stationary frame in both cases. The origin of the light ray for ϕₛ remains with the stationary source while light travels from the source to the receiver. However the origin of the light ray for ϕᵣ remains at the point in space where the moving source first emitted the ray, and connects the point of origin to the point at which the ray reaches the stationary receiver.

These equations can be combined to produce,

$${f}_{r}^{′} = {f}_{s}^{′} \frac{{γ}_{L , r} ( 1 - \frac{{v}_{r} cos {ϕ}_{s}}{c} )}{{γ}_{L , s} ( 1 - \frac{{v}_{s} cos {ϕ}_{r}}{c} )} \qquad ( 11 )$$

where γ_{L,s} is the Lorentz factor computed using the speed of the source traveling in any direction through the (stationary) frame, and γ_{L,r} is the Lorentz factor computed using the speed of the receiver traveling in any direction through the (stationary) frame.

It can be shown that Equation (11) is consistent with the commonly used forms of the relativistic Doppler equation when the motion of the source and receiver are purely longitudinal, by setting cos ϕ to 1, and vₛ or vᵣ to zero. When vₛ=0, the frequency observed by a moving receiver measured in waves per second′ (The source and receiver must be moving directly toward or away from each other in order for the commonly used form of the relativistic Doppler equation to be valid. If either moves at an angle to the direction of light transmission, then the (1−v/c) term is replaced with (1−v cos ϕ/c) and the formulas cannot be reduced to a simple ratio of square roots.) is,

$${f}_{r}^{′} = {f}_{0} {γ}_{L , r} ( 1 - \frac{{v}_{r}}{c} ) = \frac{{f}_{0} ( 1 - \frac{{v}_{r}}{c} )}{\sqrt{1 - \frac{{v}_{r}^{2}}{{c}^{2}}}} = {f}_{0} \frac{\sqrt{1 - \frac{{v}_{r}}{c}}}{\sqrt{1 + \frac{{v}_{r}}{c}}}$$

Likewise, when vᵣ is set to zero, the frequency observed by the stationary receiver, in waves per second, is,

$${f}_{r} = ( {f}_{s}^{′} / {γ}_{L , s} ) \frac{1}{1 - \frac{{v}_{s}}{c}} = {f}_{0} \frac{\sqrt{1 + \frac{{v}_{s}}{c}}}{\sqrt{1 - \frac{{v}_{s}}{c}}}$$

Although these equations would appear to be equal when yᵣ=−v and vₛ=0 as compared to when vₛ=v and vᵣ=0, they differ by the units by which frequency is measured, fᵣ′ being measured in the frame of a moving receiver in waves per second′, and fᵣ being measured in the frame of a stationary receiver in waves per second with respect to the clock of a stationary reference observer. This difference in units is caused by the difference in clock rates in the respective inertial reference frames. A stationary observer would not agree that fᵣ′ and fᵣ are the same; but to local observers measuring frequency with their own clocks, the frequencies are numerically equivalent.

If a source moves transversely with respect to a receiver that is stationary in the frame of a stationary reference observer, and such source emits a light signal when the source reaches its point of closest approach to the receiver, γ_{L,r} will equal 1 (cos ϕ=0 as determined from the stationary frame). Therefore,

$${f}_{r} = \frac{{f}_{s}^{′}}{{γ}_{L , s}} = \frac{{f}_{0} ( numerically )}{{γ}_{L , s}}$$

Since the receiver is not moving relative to the reference observer, the prime is removed from the fᵣ frequency term and expressed in waves per stationary observer seconds.

If the source resides in the frame of the stationary reference observer and the receiver moves transversely, the source's clock will “beat” in stationary seconds. If the stationary observer were to perceive light to strike the moving receiver at a right angle (cos ϕₛ=0), the frequency measured by the moving receiver will be

$${f}_{r}^{′} = {γ}_{L , r} {f}_{s} = {γ}_{L , r} {f}_{0}$$

The dimensions here are waves per receiver seconds′.

This would appear to present a challenge to the principal of relativity, since the receiver should detect the same frequency whether the receiver or the source is considered to be the moving object. These last two equations produce results that differ by gamma squared, which cannot be explained simply by a gamma-fold difference in clock rates. Einstein invoked the aberration of light as an explanation for the apparent contradiction [1,20].

### Aberration of Light

Einstein provided a formula to calculate the change in the angle of light's approach (due to light aberration) as perceived by a moving receiver. The formula can be derived from the Lorentz transformations. In FIG. 1A, the source (mirror on the floor) and receiver (mirror on the ceiling) are both moving. An observer located at the mirror on the ceiling in FIG. 1A perceives light to be approaching from angle ϕᵣ′=90° (note that ϕᵣ′ is measured from the perspective of the moving frame, in contrast to ϕᵣ which is measured from the perspective of a stationary receiver in a stationary frame). The vertical distance between mirrors times the cosine of this angle represents the distance that light moves in the x-direction, Δx′, as perceived by observers traveling within the train car (which is zero meters in the x′-direction in FIG. 1A since the mirrors are in the same vertical plane). The length of the vertical light path is the speed of light, c meters per second′, times the travel time from floor to ceiling, Δt′.

$${cos ϕ}_{r}^{′} = \frac{{Δ x}^{′}}{{c Δ t}^{′}} .$$

Similarly, in FIG. 1B, the angle, ϕₛ is subtended by the train's velocity vector and the light ray connecting the source at the moment of light emission to the receiver at the moment of light detection (and is thus the same angle as measured in the Doppler equation for a stationary source and a moving receiver—the movement of the source in the train subsequent to emission is irrelevant to ϕₛ as measured from the stationary frame). The cosine of this angle can be represented as the distance that light travels in the x-direction, Δx, divided by the line connecting the source mirror to the receiving mirror, cΔt,

$${cos ϕ}_{s} = \frac{Δ x}{{c Δ t}^{′}} .$$

Using the Lorentz transformations,

$${cos ϕ}_{s} = \frac{Δ x}{c Δ t} = \frac{γ ( {Δ x}^{′} + {v Δ t}^{′} )}{c γ ( {Δ t}^{′} + \frac{v Δ x '}{{c}^{2}} )}$$

By cancelling the gamma factors in numerator and denominator, dividing both by Δt′, and substituting

$$\frac{{Δ x}^{′}}{{Δ t}^{′}} = {c cos ϕ}_{r}^{′}$$

where appropriate, the formula for cos ϕₛ can be derived,

$${cos ϕ}_{s} = \frac{( {c cos ϕ}_{r}^{′} + v )}{c ( 1 + \frac{{vc cos ϕ}_{r}^{′}}{{c}^{2}} )} = \frac{( {cos ϕ}_{r}^{′} + \text{v} \text{/} \text{c} )}{( 1 + \frac{v}{c} {cos ϕ}_{r}^{′} )}$$

In other words, according to Einstein, if a moving receiver perceives light to be approaching from angle ϕᵣ′ with respect to the receiver's direction of motion, a stationary observer will perceive the same light ray to approach the receiver at angle ϕₛ with respect to the receiver's direction of motion. (The equation is valid even if the source does not move in tandem with the receiver since the angles are measured from the source at the instant of emission to the receiver at the instant of reception.)

Likewise, the angle from which a moving receiver will perceive light to be approaching can be computed from the angle observed by a stationary observer (or stationary source) [1],

$${cos ϕ}_{r}^{′} = \frac{{Δ x}^{′}}{{c Δ t}^{′}} = \frac{γ ( Δ x - v Δ t )}{c γ ( Δ t - \frac{v Δ x}{{c}^{2}} )} = \frac{{cos ϕ}_{s} - \frac{v}{c}}{1 - \frac{v}{c} {cos ϕ}_{s}}$$

According to these formulas, in the case where a receiver moving transverse to a stationary source (cos ϕₛ=0) reaches the geometric point of closest approach (as measured from the stationary frame), the receiver's speed contributes a transverse component of relative velocity to light's total velocity as viewed from the receiver's frame. The light's velocity with respect to the moving receiver is a combination of the y-component of velocity coming from the source, and the sum of the velocity of the receiver in the x-direction plus any x-component to the velocity of the light ray with respect to the source. From the receiver's reference frame, the combination of velocities causes the light to appear to approach the receiver at angle ϕ′ᵣ, which would be a cos(−v/c) when cos ϕₛ=0 according to the formula for cos ϕᵣ′.

According to the principal of relativity, if a receiver were not moving and a source were moving at speed −v/c such that the source's light approached the receiver at an angle yielding cos ϕᵣ=−v/c, the receiver would detect a frequency of,

$${f}_{r} = \frac{{f}_{s}^{′}}{{γ}_{L , s} ( 1 + \frac{v}{c} {cos ϕ}_{r} )} = {f}_{s}^{′} \frac{\sqrt{1 - \frac{{v}^{2}}{{c}^{2}}}}{1 - \frac{{v}^{2}}{{c}^{2}}} = {f}_{s}^{′} {γ}_{r}$$

In other words, a stationary receiver expects that light approaching at angle ϕᵣ=arccos (−v/c) (the angle being measured by the stationary receiver) will have a frequency of fₛ′γᵣ, waves per second, and not frequency fₛ′/γᵣ; the latter being the frequency expected if a stationary receiver were to perceive light to approach at a right angle.

In the case where a moving receiver perceives the light to approach at a right angle (cos ϕᵣ′=0), the cosine of the angle as seen by an observer in the frame of a stationary source will be,

$${cos ϕ}_{s} = \frac{{cos ϕ}_{r}^{′} + \frac{v}{c}}{1 + \frac{v}{c} {cos ϕ}_{r}^{′}} ,$$

which is equal to v/c. The frequency of light approaching a moving receiver at angle ϕₛ, the angle being measured in the frame of a stationary source, would be,

$${f}_{r}^{′} = {f}_{s} {γ}_{r} ( 1 - \frac{v}{c} {cos ϕ}_{s} ) = \frac{{f}_{s} ( 1 - \frac{{v}^{2}}{{c}^{2}} )}{\sqrt{1 - \frac{{v}^{2}}{{c}^{2}}}} = \frac{{f}_{s}}{{γ}_{r}}$$

waves per second′. This then explains how a moving receiver that perceives light to be approaching at a right angle will detect a frequency of fₛ/γᵣ waves per second′, while a moving receiver that is struck by light at the geometric point of closest approach (cos ϕₛ=0 and cos ϕᵣ′=−v/c) will detect a frequency of fₛγᵣ waves per second′.

But there is a conceptual problem with this last example. From the perspective of the stationary frame, a moving receiver that is struck by light at the geometric point of closest approach (cos ϕₛ=0, cos ϕᵣ′=−v/c, fᵣ′=fₛγᵣ waves per second′), will cause no contraction of lengths at the moment of detection, when ϕₛ=90°. The direction of relative motion is at a right angle to the direction of the wave normal (light ray). According to special relativity, there is no contraction of lengths in directions orthogonal to the direction of relative motion, and there is no “aberration of length” formula. Therefore, wavelength must be the same as that being emitted by the stationary source, λ₀. The aberration of light might change its perceived angle of approach, but nothing in the Lorentz transformations would change wavelength in this setup. Therefore if wavelength is unchanged, yet frequency as perceived by the receiver is increased by a factor of γᵣ, light speed must be λ₀γᵣf₀=γᵣc meters per second′. This violates the notion that all observers observe light to travel at speed c.

There are other significant conflicts between special relativity, the relativistic Doppler effect, and light aberration. According to special relativity theory, when relative motion is longitudinal (ϕ=0=ϕ′), a moving receiver will detect frequencies of

$${γ}_{L , r} {f}_{0} ( 1 ∓ \frac{v}{c} )$$

and wavelengths of

$${λ}_{0} / ( {γ}_{L , r} ( 1 ∓ \frac{v}{c} ) )$$

between the receiver and a stationary source. In contrast, according to the classical Doppler effect, wavelength detected by a moving receiver is determined by the equation,

$${λ}_{r} ( classical ) = \frac{{λ}_{0}}{1 \pm \frac{v}{c}} .$$

The average wavelength experienced by two receivers moving in the same direction, encountering light coming longitudinally from a single, omnidirectional source located between the receivers is,

$${λ}_{r}^{′} ( average , special relativity ) = 0.5 ( \frac{{λ}_{0}}{{γ}_{L , r} ( 1 + \frac{v}{c} )} + \frac{{λ}_{0}}{{γ}_{L , r} ( 1 - \frac{v}{c} )} ) = {γ}_{L , r} {λ}_{0}$$

$${λ}_{r}^{′} ( average , classical ) = 0.5 ( \frac{{λ}_{0}}{( 1 + \frac{v}{c} )} + \frac{{λ}_{0}}{( 1 - \frac{v}{c} )} ) = {γ}_{L , r}^{2} {λ}_{0}$$

According to special relativity, the average wavelength of longitudinal light is gamma-fold shorter than that predicted by the classical Doppler equation.

The same result is attained by using the Lorentz transformation for average longitudinal distance traveled by light relative to two flanking receivers that are moving parallel and antiparallel to the light's direction,

Δx=0.5(γ_{L,r}Δx′+γ_{L,r}vΔdt′+γ_{L,r}Δx′−γ_{L,r}vΔdt′)=γ_{L,r}Δx′

instead of the classical distance traveled

$$Δ {x}_{average , classical} = {c Δ t}_{a v e r a g e} = c * 0.5 ( \frac{{Δ x}^{′}}{c - v} + \frac{{Δ x}^{′}}{c + v} ) = \frac{{Δ x}^{′}}{1 - {v}^{2} / {c}^{2}} = {γ}_{L , r}^{2} {Δ x}^{′}$$

According to the Lorentz transformations, the distance Δx is the distance light travels longitudinally in the stationary frame, and represents a physical contraction of length between the moving receivers. Since the Michelson-Morley result requires the round trip time for light to travel in the longitudinal (upstream+downstream) and transverse (distally+proximally) directions to be equal, special relativity requires the longitudinal contraction in both inertial reference frames (but only noticeable from the stationary frame, since the measuring standards in the moving frame are also contracted). Such length contraction must apply to wavelengths between receivers as well as to the distance between receivers, as confirmed by the wavelength equation above, and by the requirement that wave fronts not be destroyed. Thus, according to special relativity, wavelengths associated with receivers moving longitudinally must be a factor of gamma shorter than those predicted by the classical Doppler effect.

If a stationary source is flanked by two pairs of receivers moving along the same axis longitudinally with respect to the source, and at time t=0 the receivers of the more proximal pair travel at speed v₁ as measured in the frame of the source, while the receivers of the more distal pair travel at speed v₂ as measured in the frame of the source, the speed of each pair will cause the distance between each pair to contract differentially by their respective Lorentz factors. Thus the two pairs will encounter an impossible conflict with respect to the distances between the pairs, since the speed of the distal pair will force the proximal pair to contract according to the speed of the distal pair while the speed of the proximal pair will cause it to contract according to its own speed. Since the speeds of the pairs are both measured with respect to the stationary source, the speeds are not additive, either classically or relativistically. Any compound length-contraction of intervals within the region would cause the intra-pair distances to be other than that predicted by the Lorentz transformations, thereby distorting the wavelengths, frequencies, and speed of light between the pairs. If this were the case, and somehow source-receiver pairs were subject to some type of “entanglement”, it would have to be true for all overlapping inertial reference frames comprising sets of source-receiver pairs traveling at different speeds, creating myriad conflicts for the special theory of relativity. For example, the color of light on the Earth would have to change continuously as the Earth rotates within other inertial reference frames, requiring length contraction and wavelength contraction, pursuant to their relative orientations and velocities. But this does not happen.

There are significant problems with relativistic light aberration as well. As described above, Einstein's formula for light aberration (often called stellar aberration or annual aberration) requires the contraction of lengths and wavelengths between source and receiver. According to Einstein's aberration formula, the distance Δx′ represents the difference in x′-axis coordinates that separate the source (at the point of emission) from the receiver (at the instant of emission) as observed from the moving frame. For example in FIG. 1A, if the mirror on the ceiling of the train car were located in the mid-portion of the train car instead of immediately above the source mirror at the back of the train car, the distance that an observer would pace along the floor of the train car to walk from the source mirror to the point immediately beneath the ceiling mirror would be Δx′ meters. Observers in the train car would perceive light to travel at an angle ϕᵣ′ within the train car, and this angle would not change whether the train car is moving or not. However, a stationary observer (including a stationary observer at the location of the stationary source) would perceive the angle connecting the source at the moment of emission to the receiver at the moment of reception to change, and (according to special relativity) the distance between the source and the receiver, Δx′, would contract based on the speed of the train.

To help illustrate one of the inconsistencies of relativistic aberration, a quarterback in an American football game throws the football to the position where the receiver is projected to be after the ball has traveled from the quarterback to the receiver. The angle ϕₛ is the angle, as seen from the stationary frame, formed by the velocity vector of the football and the velocity vector of the receiver at the moment the ball is released. In contrast to special relativity, the receiver perceives the same angle as the angle perceived by the quarterback. This is not true in special relativity, where the moving receiver must apply the Lorentz transformations, including length-contraction of the football field, to compute the receiver's perceived angle of approach ϕᵣ′. This is problematic because another relativistic receiver moving at a different velocity with respect to the quarterback would require the football field to simultaneously contract by a different ratio (with respect to the original field size). These simultaneous length-contractions would each affect the final position of the other receiver, an untenable prospect.

The problem is further supported by the special relativity aberration formulas. According to special relativity, the tangent of the angle ϕₛ is equal to the y-component of light's velocity divided by the x-component of light's velocity, as computed using the Lorentz transformations. The y-component of light's velocity is,

$${c}_{y} ( special relativity ) = \frac{Δ y}{Δ t} = \frac{{Δ y}^{′}}{γ ( {Δ t}^{′} + \frac{v Δ x '}{{c}^{2}} )}$$

Note that Δy′ can be used instead of Δy since these are of the same length in special relativity. The x-component of light's velocity is,

$${c}_{x} ( special relativity ) = \frac{Δ x}{Δ t} = \frac{γ ( {Δ x}^{′} + {v Δ t}^{′} )}{γ ( {Δ t}^{′} + \frac{v Δ x '}{{c}^{2}} )}$$

And the tangent of ϕₛ, after dividing numerator and denominator by cΔt′ is,

$${tan ϕ}_{s} ( special relativity ) = \frac{{c}_{y}}{{c}_{x}} = \frac{\frac{{Δ y}^{′}}{{c Δ t}^{′}}}{γ ( \frac{Δ x '}{{c Δ t}^{′}} + \frac{v}{c} )} = \frac{{sin ϕ}_{r}^{′}}{γ ( {cos ϕ}_{r}^{′} + \frac{v}{c} )}$$

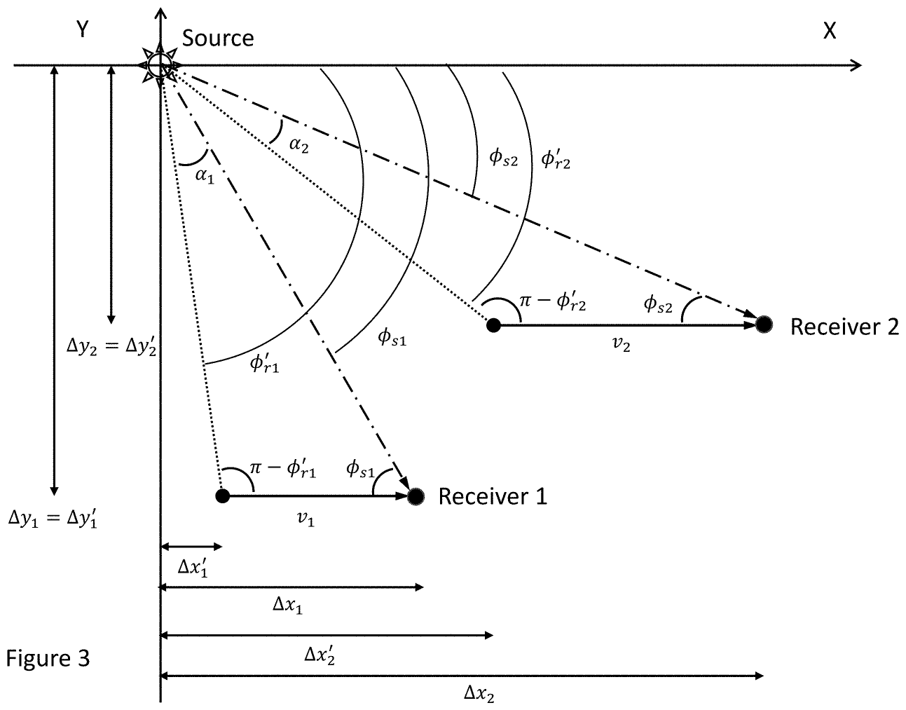

FIG. 3 illustrates the concept of aberration for one stationary source and two moving receivers. For each receiver, the dashed arrow signifies the direction that light travels at speed c and angle ϕₛ from source to receiver. The solid arrow represents the direction that the receiver travels at speed v from the instant light is emitted from the source to the instant light strikes the receiver. The dotted line connecting the source to the location of the receiver at the moment of light emission is shown to form the angle π−ϕᵣ′, which is the angle perceived by the receiver. That is, in special relativity the angle of approach as perceived by the receiver, ϕᵣ′, is the same as the angle subtended by the receiver's velocity vector and the line connecting the source to receiver at the instant of emission. Even though the dashed arrow represents the angle from the source (upon emission) to the receiver (upon detection) as perceived by the stationary source, the dotted line connecting the source to the receiver's location at the instant of emission is the same angle as the angle observed by the receiver upon detection (due to aberration), even though the receiver is located at the terminus of the dashed arrow upon detection.

The special relativity formula for tan ϕₛ contains a gamma factor in the denominator. This gamma factor is computed using the speed of the relevant receiver as measured in the frame of the stationary source. That is, if receiver 1 and receiver 2 are moving at different speeds relative to the source, the gamma factor used to compute tan ϕₛ₁ will depend on v1, and the gamma factor used to compute tan ϕₛ₂ will depend on v2. The relativistic velocity addition formula (see below) does not play a role here, since both speeds are measured relative to the stationary source, not relative to each other. If receiver 1 is moving but receiver 2 is stationary, then γᵥ₁ will determine the degree to which length Δx₁′ contracts and time Δt₁′ dilates. Similarly, if receiver 2 is moving but receiver 1 is stationary, then γᵥ₂ will determine the degree to which length Δx₂′ contracts and time Δt₂′ dilates. But if receiver 2 begins to move after receiver 1 is already in motion, then receiver 2 will distort the length contraction caused by γᵥ₁, thereby causing tan ϕₛ₁ to change. And since v1 and v2 may be very different, the degree of length contraction caused by the movement of each receiver may be very different. If v1 and v2 are the speeds of two different planets observing the same stationary star, special relativity demands that the location and the angle of perception, ϕᵣ₁′, of the planet moving at speed v1 be altered by the speed and/or direction of motion of the planet moving at speed v2. That is, if receiver 2 in FIG. 3 were traveling in the y-direction instead of the x-direction, receiver 2's motion would not contract the x-axis. But if receiver 2 instead were moving in the x-direction, it would now contract the x-axis, and cause the actual distance between receiver 1 and the source to contract!

Special relativity demands that receiver 2 has the power to change the position of receiver 1 in space! Length contraction, as required by the Lorentz transformations, is not a virtual effect, nor is it an observer-specific effect. The Michelson Morley result combined with the Lorentz transformations require length contraction to be real and to apply to the region between source and receiver. Therefore, each change in the direction of motion of receiver 2 would allegedly alter the distance between receiver 1 and the source. This would presumably cause one receiver to change the wavelengths and perceived angles of approach as perceived by another receiver. This requirement of special relativity is untenable.

In order to obey the principle of relativity, Einstein's aberration formula must predict the location of the receiver at the moment of light emission, since this must be the location of a stationary receiver in a reciprocal setup in which the source moves in the opposite direction. Specifically, special relativity predicts angle ϕᵣ′ using angle ϕₛ using the formula,

$${tan ϕ}_{r}^{′} = \frac{{sin ϕ}_{s}}{γ ( {cos ϕ}_{s} - \frac{v}{c} )}$$

However, the Earth does not move linearly like the receivers in FIG. 3; it orbits the Sun in an elliptical pattern. And so Einstein's aberration formula does not predict the location of the Earth at the moment light is emitted.

Nor would a reciprocal aberration formula be able to predict the position of the emitting star at the moment of detection. That is, if an orbiting observer uses their angle of observation, cos ϕ′ᵣ to predict cos ϕₛ,

$${cos ϕ}_{s} = \frac{{cos ϕ}_{r}^{′} - \frac{v}{c}}{1 - \frac{v}{c} {cos ϕ}_{r}^{′}}$$

an orbiting observer will compute the wrong location for the source at the instant of emission, because the formula for cos ϕₛ is based on the assumptions of the Lorentz longitudinal transformations that the receiver moves linearly and that the distance between the observer and source will contract parallel to the observer's direction of motion.

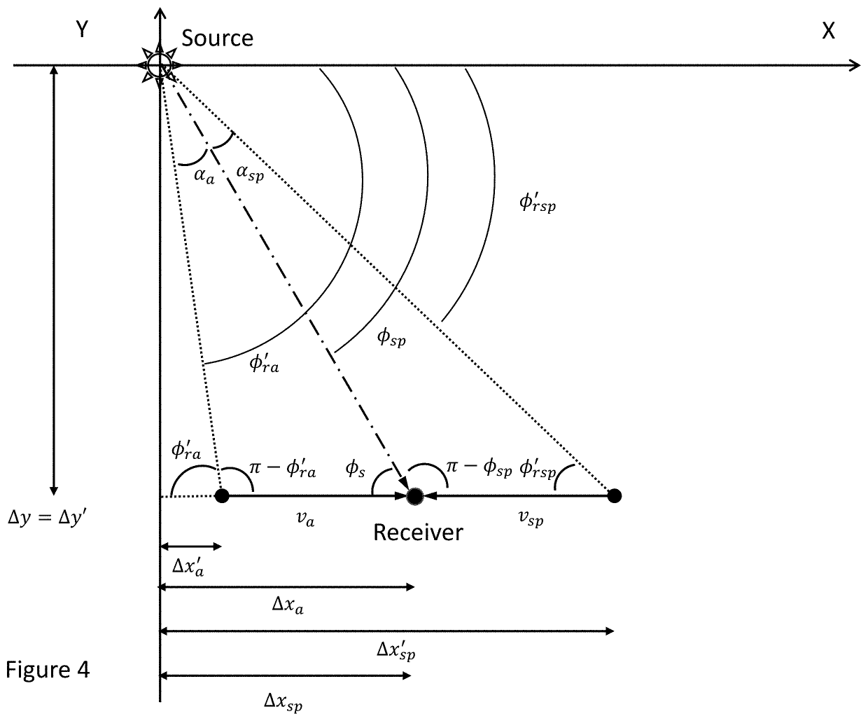

FIG. 4 illustrates an example of a receiver that moves rapidly with respect to light speed. If the speeds of the receiver in autumn, vₐ, and in spring, vₛₚ, are equal but opposite in direction, special relativity would predict the angles ϕᵣₐ′ and ϕₛₚₐ′ to be

$${cos ϕ}_{ra}^{′} = \frac{{cos ϕ}_{s} + \frac{{v}_{a}}{c}}{1 + \frac{{v}_{a}}{c} {cos ϕ}_{s}}$$

$$and$$

$${cos ϕ}_{rsp}^{′} = \frac{{cos ϕ}_{s} - \frac{{v}_{s p}}{c}}{1 - \frac{{v}_{s p}}{c} {cos ϕ}_{s}}$$

respectively (the opposite polarity of the speeds is reflected in these formulas; that is, vₐ and vₛₚ are both positive quantities but opposite in orientation). The angle ϕₛ is still predicted consistently from,

$${cos ϕ}_{s} = \frac{{cos ϕ}_{ra}^{′} - \frac{{v}_{a}}{c}}{1 - \frac{{v}_{a}}{c} {cos ϕ}_{ra}^{′}} = \frac{{cos ϕ}_{rsp}^{′} + \frac{{v}_{s p}}{c}}{1 + \frac{{v}_{s p}}{c} {cos ϕ}_{rsp}^{′}} ,$$

which is no surprise since these formulas are variants of the Lorentz transformations, which are invertible with respect to reference frames. However, it should be clear from the formulas for the angles perceived by the moving receiver and from FIG. 4 that

cos ϕᵣₐ′>cos ϕᵣₛₚ′.

More importantly, the Lorentz formulas predict the locations of the receiver at the instant of light emission to be (xₐ′, y′) and (xₛₚ′, y′) in the autumn and spring respectively, which is incorrect since the receiver could be tightly orbiting location (xₐ,y) at a high speed.

Even more troublesome, the relativistic aberration formulas do not obey Cartesian geometry. As Einstein admitted, the Lorentz-derived formulas do not obey the “law of parallelogram of velocities” [1]. The angles of triangles typically do not add to 180 degrees in special relativity, and will vary depending on the velocity of objects. Applying the standard law of sines to the springtime angles in FIG. 4,

$${sin α}_{s p} = \frac{{v}_{s p}}{c} {sin ϕ}_{rsp}^{′}$$

the sine of the angle of aberration (the difference between the angle observed in the moving frame and the angle observed in the stationary frame) should equal the receiver's velocity as a fraction of c, times the sine of the angle observed by the moving receiver (assuming that angle is an acute angle). Solving for alpha,

$${α}_{s p} = arcsin ( \frac{{v}_{s p}}{c} {sinϕ}_{rsp}^{′} ) .$$

Based on angle definitions, the angle of aberration, αₛₚ, must equal the angle observed by the moving receiver, ϕᵣₛₚ′ minus the angle formed by the line connecting the stationary source to the point of observation, ϕₛ. That is,

αₛₚ=ϕᵣₛₚ′−ϕₛ.

But these relationships do not hold for special relativity.

$${ϕ}_{rsp}^{′} - {ϕ}_{s} \neq arcsin ( \frac{{v}_{s p}}{c} {sin ϕ}_{rsp}^{′} )$$

Astronomers have measured a maximum angle of aberration for α(max), called the “stellar aberration constant” for the Earth's orbit. When ϕᵣ′ is 90 degrees, alpha is equal to its maximum,

$$α ( max ) = arcsin ( \frac{v}{c} )$$

where v is the orbital speed of the Earth around the Sun, and c is the light constant. The stellar aberration constant is about 20.5 arcseconds. Cartesian geometry requires alpha to grow smaller as ϕᵣ′ deviates from 90 degrees. So stars that appear at lower declinations on the celestial sphere will show lesser amounts of seasonal variation in their declination. But the alpha predicted by special relativity α=ϕᵣ′−ϕₛ does not agree with the geometric formula for alpha, due to the non-Cartesian nature of length contraction.

One might assume that experimentation could differentiate the Cartesian from the special relativity predictions, but the orbital speed of the Earth, being about 0.01% of c, does not provide for a great enough angular difference to exceed the degree of angular sensitivity of modern space telescopes (about 0.04 arcseconds). A receiver would need to move at about 0.1% of c in order for the predicted aberration angles to be measurable by an instrument such as the Hubble space telescope. Or a more sensitive telescope would need to be built to measure the difference.

The non-Cartesian nature of special relativity is often explained away by referring to the properties of “spacetime”, which allegedly allows distances to warp as a function of speed. A stationary observer should see the same degree of spacetime contraction if a receiver is moving at the same speed in either the positive or negative x-direction. With respect to FIG. 4, the time required for light to travel from the source at the instant of emission (the location marked Source in FIG. 4) to the receiver at the instant of reception (the location marked Receiver in FIG. 4), t, is the same in both seasons since the setup in FIG. 4 places the source and receiver at the same locations in both seasons. And since v is the same (but in opposite direction) in both seasons, the distance vt will be the same (special relativity theory does not demand length contraction of vt). The Cartesian sum of Δxₐ′+vt should equal Δxₛₚ′−vt, assuming that v and t are the same in spring and autumn; and the “event” of light moving from the Source to the Receiver is the same “event” whether occurring in the spring or autumn. Yet the special relativity sum of Δxₐ′+vt will not equal Δxₛₚ′−vt, since special relativity contracts both Δxₐ′ and Δxₛₚ′ differentially in spring and autumn. That is, the distance Δxₐ′ will not be the same in the autumn and the spring, and Δxₛₚ′ also will not be the same in the autumn and the spring, even though the receiver in the spring moves at exactly the same speed (albeit in opposite direction) as the receiver in the autumn.

Spacetime should not contract asymmetrically based solely upon the direction from which an object approaches a location in space, yet special relativity requires such. This problem is amplified by the situation where the receiver is orbiting at a high speed but with a relatively small radius. Δxₐ′ and Δxₛₚ′ will have similar values in the Lorentz transformations, and thus in their contributions to the computations of cos ϕᵣₐ′ and cos ϕᵣₛₚ′, thereby causing the formulas for these angles to provide incorrect solutions. If there were two receivers orbiting each other, similar to how binary stars orbit each other, then the same asymmetry in the predictions of ϕᵣₛₚ′ and ϕᵣₐ′ would occur, even though orbits of the receivers were symmetric.

Since the relativistic aberration formula is critically dependent on length contraction, the relativistic aberration model requires the distances between the Earth and other celestial objects in the universe to contract and re-expand constantly, since the receiver's velocity vector is constantly changing orientation. Each change in orientation of the Earth's velocity must cause a universe-wide change in distances between the Earth and the other celestial objects. And this must be true for every planet, asteroid, and receiver in the universe as well. There is no evidence for this.

The concept of length contraction is thus hopelessly unworkable.

### Doppler Effects in the Alternative Model

In the alternative model a source that is stationary will emit light at a wavelength of λ₀ meters per wave, at a frequency of f₀ waves per second, and at a speed of c=λ₀f₀ meters per second (γₛ=1 and γₛc=c). And a source that is moving will emit at a wavelength (averaged in the longitudinal and anti-longitudinal directions) of γ_{ϕ}γₛλ₀ meters per wave, at a frequency of f₀/γₛ waves per second, and at a speed of γ_{ϕ}λ₀f₀=γ_{ϕ}c meters per second.

The alternative model does not require wavelength contraction, because it does not require light to travel at speed c in all directions in all reference frames. The alternative model proposes that moving sources emit light in an ellipsoidal pattern.

If the alternative model were to simply use an analog to Equation (11), it would be,

$${f}_{r}^{′} = {f}_{s}^{′} \frac{{γ}_{s , r} ( 1 - \frac{{v}_{r} {cos ϕ}_{s}}{{γ}_{ϕ} c} )}{{γ}_{s , s} ( 1 - \frac{{v}_{s} {cos ϕ}_{r}}{{γ}_{ϕ} c} )} \qquad ( 12 )$$

Here γ_{s,r}=\sqrt{1+vᵣ²/c²}, γ_{s,s}=\sqrt{1+vₛ²/c²}, γ_{ϕ}=\sqrt{1+vₛ²/c²}/\sqrt{1+vₛ² sin²ϕₛ/c²}, and when aberration angles are relevant,

$${tan ϕ}_{r}^{′} = \frac{{sin ϕ}_{s}}{{cos ϕ}_{s} - \frac{{v}_{r}}{{γ}_{ϕ} c}} ,$$

This formula can be derived from,

$${Δ y}^{′} = Δ y = {γ}_{ϕ} {c Δ t sin ϕ}_{s}$$

$${Δ x}^{′} = Δ x - {v}_{r} Δ t = {γ}_{ϕ} {c Δ t cos ϕ}_{s} - {v}_{r} Δ t$$

$${tan ϕ}_{r}^{′} = \frac{{Δ y}^{′}}{{Δ x}^{′}} = \frac{{sin ϕ}_{s}}{{cos ϕ}_{s} - \frac{{v}_{r}}{{γ}_{ϕ} c}}$$

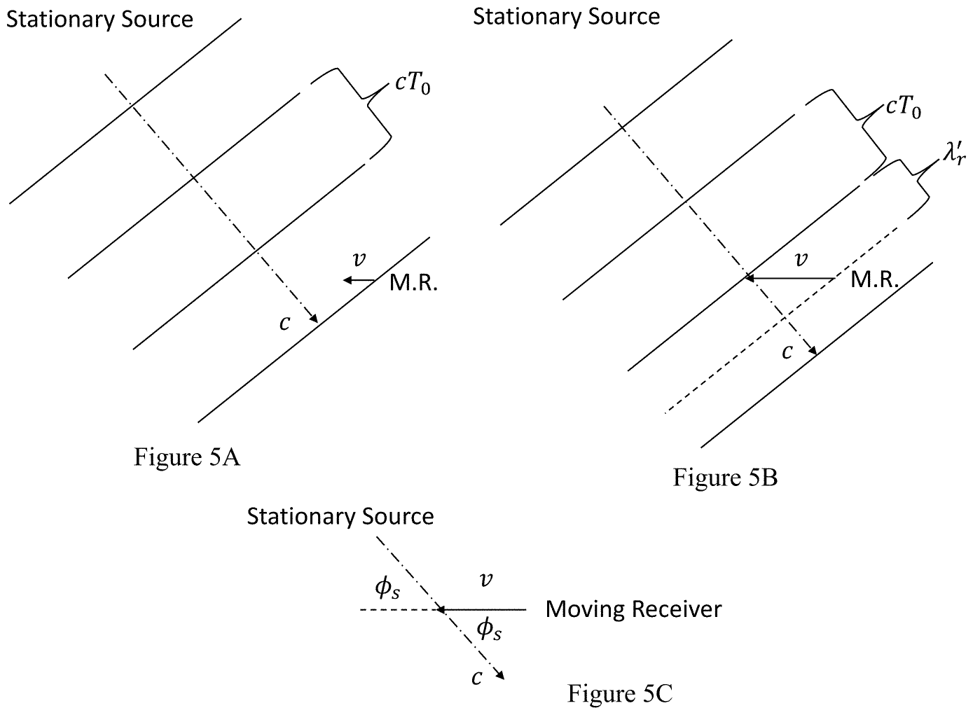

A graphical derivation of the equation for the frequency observed by a moving receiver when light is coming from a distant, stationary source is shown in FIG. 5). It is assumed that the stationary source is a great distance away from a receiver. It emits light in a circular pattern, which because of the distance between source and receiver, appears as evenly spaced, linear wavefronts. The stationary source emits at a frequency f₀=1/T₀, and wavelength λ₀=cT₀.

FIG. 5A shows a moving receiver (M.R.) located at one of the wavefronts traveling leftward at speed vᵣ (Einstein's convention of using Cartesian coordinates for the moving receiver Doppler effect would assign a negative value to vᵣ). The dashed arrow represents the direction of light coming from the source at speed c. FIG. 5B shows advancement of the wavefronts and further displacement leftward of the moving receiver, where it comes in contact with the next wavefront. FIG. 5C shows the angle ϕₛ formed by the directions of receiver and light, consistent with the conventions in FIG. 4. FIG. 5B shows that the wavelength experienced by the moving receiver, λᵣ′, will be shorter than λ₀ due to the Doppler effect. The wavelength λᵣ′ can be derived by assigning the variable t to the stationary frame time required for the receiver to travel from one wavefront to the next.

t(c−vᵣ cos ϕₛ)=cT₀,

(where again, a leftward moving receiver would have a negative value for vᵣ, and therefore the term in the parenthesis would be equal to c+vᵣ cos ϕₛ). The frequency observed by the receiver, in the receiver's time-dilated waves per second′, will be fᵣ′=γ_{s,r}/t, where the alternative model γ_{s,r} factor is used for time-dilation based on the speed of the receiver. Therefore,

$${f}_{r}^{′} = \frac{{γ}_{s , r} ( 1 - \frac{{v}_{r}}{c} {cos ϕ}_{s} )}{{T}_{0}} = {γ}_{s , r} {f}_{0} ( 1 - \frac{{v}_{r}}{c} {cos ϕ}_{s} ) \qquad ( 13 )$$

In the alternative model, under conditions where the source is stationary and the receiver moves longitudinally toward the source (where vᵣ is negative when moving in the negative x-direction using Einstein's format, and where vₛ=0, cos ϕₛ=1, and fₛ′=f₀); Equation (13) reduces to,

$${f}_{r}^{′} = {γ}_{s , r} {f}_{0} ( 1 - \frac{{v}_{r}}{c} )$$

That is, when the receiver moves in the negative x-direction toward the source (Einstein format), vᵣ will be negative and therefore,

$$( 1 - \frac{{v}_{r}}{c} ) > 1 .$$

In the alternative model, when the source is stationary a receiver moving longitudinally will experience light traveling at γ_{s,r}c meters per second′ (ignoring clock location effects), and the wavelength measured by the moving receiver in meters per wave is,

$${λ}_{r , longitudinal}^{′} = \frac{{γ}_{s , r} c}{{f}_{r}^{′}} = \frac{{γ}_{s , r} c}{{f}_{0} {γ}_{s , r} ( 1 - \frac{{v}_{r}}{c} )} = \frac{{λ}_{0}}{1 - \frac{{v}_{r}}{c}} \qquad ( 14 )$$

The formula for wavelength contains no gamma factor. Neither time dilation nor length contraction (if it were to exist) can affect the wavelength observed by a longitudinally moving receiver in vacuum. The wavelength is modulated only by the primary Doppler effect. Equation (14) could form the basis for experimental differentiation between special relativity and the alternative model, provided measurements are made in a pure vacuum without refractive media (see Impact of Refractive Media on Doppler Effect section). Unfortunately, it is difficult to measure wavelengths in a vacuum using a receiver moving extremely rapidly. Champeney et al (21) measured frequency of a rotating receiver, not wavelength.

The Doppler-shifted frequency at a receiver moving longitudinally, measured in the stationary frame in waves per second, will be

$${f}_{r , s}^{′} = \frac{{f}_{r}^{′}}{{γ}_{s , r}} = {f}_{0} ( 1 - \frac{{v}_{r}}{c} ) \qquad ( 15 )$$

The wavelengths, frequencies, and aberration angles derived thus will differ from those derived using special relativity.

Special relativity assumes that a moving receiver will measure light to travel at c meters per second′, using the receiver's time-dilated clock. This means that the distance between the source and the receiver at the moment of light emission, Δx′, must be contracted by a factor of gamma. This contraction should be dependent on the angle between the direction of the receiver and direction of the wave normal (light ray) that strikes the receiver. The relativistic frequency is computed with Equation (9).

$${f}_{r}^{′} ( special relativity ) = {γ}_{L} {f}_{0} ( 1 - \frac{{v}_{r}}{c} cos {ϕ}_{s} )$$

The relativistic wavelength would then be relativistic light speed, c, divided by relativistic frequency,

$${λ}_{r}^{′} ( special relativity ) = \frac{c}{{γ}_{L} {f}_{0} ( 1 - \frac{{v}_{r}}{c} cos {ϕ}_{s} )} = \frac{{λ}_{0}}{{γ}_{L} ( 1 - \frac{{v}_{r}}{c} cos {ϕ}_{s} )} .$$

According to these formulas, the Lorentz factor, y_{L}, is dependent on the speed of the receiver but independent of the direction of the receiver. The Lorentz factor represents length contraction in the special relativity formula for λᵣ′. However, there is an inconsistency. According to special relativity theory, length contraction only occurs in the direction of motion. When the receiver travels transverse to the wave normal (light ray) there should be no length contraction in the direction of the wave normal, and so the Lorentz factor in the receiver wavelength equation really should be dependent on the direction of receiver motion,

$${γ}_{L , {ϕ}_{s}} = \frac{1}{\sqrt{1 - \frac{{v}_{r}^{2}}{{c}^{2}} {cos}^{2} {ϕ}_{s}}}$$

If this were the formula for the Lorentz factor in the special relativity formula for λᵣ′, as it should be, then length contraction would be dependent on the angle ϕₛ. However, this would force the formula for moving receiver frequency, fᵣ′, also to be dependent on γ_{L,ϕ}_{ₛ} instead of γ_{L}, otherwise light speed would not be constant. But γ_{L} in the frequency formula is a time-dilation factor, not a length-contraction factor. Time dilation is not affected by direction of motion, and so it cannot be dependent on the receiver's direction of motion. This reveals another significant inconsistency in the special theory of relativity. Special relativity uses the Lorentz factor interchangeably for time-dilation and length-contraction; yet they are not interchangeable when the direction of motion and the direction of the wave normal are not parallel.

The length contraction embedded in the relativistic Doppler equation for a moving receiver requires light to be emitted by a stationary source in a pattern of elliptically shaped waves. This elliptical pattern is not merely an illusion as perceived by the moving receiver; but according to the Lorentz transformations (as shown above) special relativity requires longitudinal lengths (and wavelengths) to be contracted in the frame of the source. Once again, the outcome of the Michelson Morley experiment can only be explained by the special theory of relativity if lengths in the longitudinal dimension are contracted in the frame of the source. And therefore the eccentricity of the contracted ellipse of light must be determined by the speed of the receiver observing the light emitted by the source. Different receivers traveling at different speeds would require the same stationary source to emit light in different elliptical patterns, again revealing a fatal conflict in the theory. To preserve the constancy of the speed of light, not only must the stationary frame frequency of light emitted by the source be a function of the emission angle, but the wavefronts must be emitted by the source first in the transverse directions (with respect to the movement of the receiver) followed by emission more and more towards the longitudinal directions. In other words, light must first “emerge” from the stationary source orthogonal to the longitudinal dimension and then spread toward the longitudinal poles, as governed by the speed of a source that might lie light years from the source. These constraints are unrealistic in the extreme.

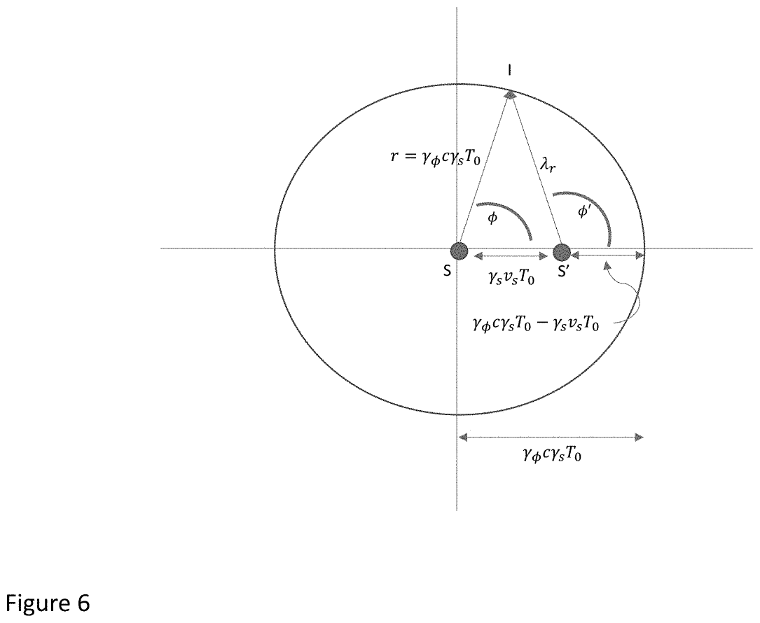

For the alternative model, the frequency and wavelength of light emitted in a vacuum by a moving source and detected by a stationary receiver can be derived using the law of cosines. FIG. 6) illustrates the emission of light from a moving source S that travels a distance γₛvₛT₀ to position S′ in one period (here, T₀ is the period between emissions when the source is not moving, and γₛT₀ is the time-dilated period between emissions from a source moving at speed vₛ). In the alternative model, light emitted at point S travels at speed γ_{ϕ}c (a positive number when the source moves in the positive x-direction toward the receiver), tracing a radius of length r=γ_{ϕ}cγₛT₀. The distance between S′ and the wavefront at the end of a period is the wavelength, λᵣ, between the initial wavefront emitted at point S and the subsequent wavefront emitted at point S′.

If it is assumed that ϕ for the n+1th wave and ϕ′ for the adjacent, nth wave are approximately the same for a given stationary receiver lying a large distance from the source, and that wave n trails wave n+1 by the normal wavelength between them minus vₛ·γₛT₀·cos ϕ.

$${λ}_{r} = {γ}_{ϕ} c {γ}_{s} {T}_{0} ( n + 1 ) - {γ}_{0} c {γ}_{s} {T}_{0} n - {v}_{s} {γ}_{s} {T}_{0} cos ϕ = {γ}_{s} {T}_{0} ( {γ}_{0} c - {v}_{s} cos ϕ ) \\ and thus , {λ}_{r} = {λ}_{0} {γ}_{s} {γ}_{ϕ} ( 1 - \frac{{v}_{s}}{{γ}_{ϕ} c} cos ϕ ) . \qquad ( 16 )$$

If the source emits light in a vacuum, longitudinally with respect to its velocity, Equation (16) becomes,

$${λ}_{r , vacuum} = {γ}_{s}^{2} {λ}_{0} ( 1 - \frac{{v}_{s}}{{γ}_{s} c} )$$

For purely longitudinal motion, this equation can be manipulated algebraically to yield,

$${λ}_{r , longitudinal , vacuum} = \frac{{λ}_{0}}{( 1 + \frac{{V}_{s}}{{γ}_{s} c} )} \qquad ( 17 )$$

The frequency emitted by a moving source at point S′ and detected by a stationary receiver at point I can be computed using,

$${f}_{r} ( alternative ) = \frac{{γ}_{ϕ ′} c}{{λ}_{s}^{′}} = \frac{{γ}_{ϕ ′} {f}_{s}^{′}}{{γ}_{s} \sqrt{\frac{{v}_{s}^{2}}{{c}^{2}} {cos}^{2} ϕ + {γ}_{ϕ}^{2} - 2 {γ}_{ϕ} \frac{{v}_{s}}{c} cos ϕ}} \\ {ϕ}^{′} = a sin ( \frac{{γ}_{ϕ} {γ}_{s} sin ϕ}{\sqrt{\frac{{γ}_{s}^{2} {v}^{2}}{{c}^{2}} + {γ}_{ϕ}^{2} {γ}_{s}^{2} - \frac{2 {γ}_{ϕ} {γ}_{s}^{2} v}{c} cos ϕ}} ) , and \\ {γ}_{{ϕ}^{′}} = \sqrt{\frac{1 + \frac{{v}^{2}}{{c}^{2}}}{1 + \frac{{v}^{2}}{{c}^{2}} {sin}^{2} {ϕ}^{′}}} . \qquad ( 18 )$$

A speed of γ_{ϕ},c is used to compute fᵣ since the second wavefront originates at point S′ and proceeds to point I at angle ϕ′ and speed γ_{ϕ′}c. However, when the receiver is very far from the source, γ_{ϕ′}γ_{ϕ}, and the equation for fᵣ becomes,

$${f}_{r} ( alternative ) = \frac{{f}_{s}^{′}}{{γ}_{s} ( 1 - \frac{{v}_{s}}{{γ}_{ϕ} c} cos ϕ )} . \qquad ( 19 )$$

When the wavelength of a moving source is computed using the relativistic Doppler formula for special relativity,

$${λ}_{r} ( special relativity ) = {λ}_{0} {γ}_{L} ( 1 - \frac{{v}_{s}}{c} cos ϕ )$$

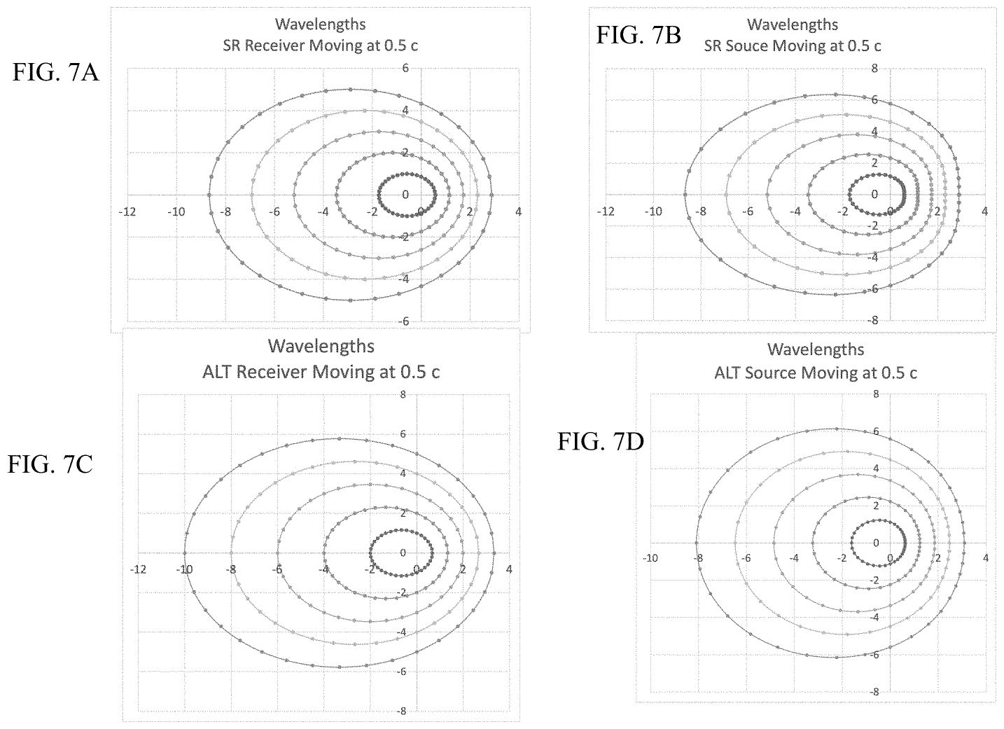

This equation produces a distorted wavefront, especially as v approaches c. And the distribution is different than the distribution of wavelengths generated by the relativistic Doppler formula for a moving receiver when using either aberration angles or normal angles (FIGS. 7A-7D). This challenges the validity of the principle of relativity as incorporated into the special theory of relativity.

Under conditions where a source is moving longitudinally and a receiver is stationary, Equation (19) resolves to,

$${f}_{r} = \frac{{f}_{s}^{′}}{{γ}_{s} ( 1 - \frac{{v}_{s}}{{γ}_{s} c} )}$$

This formula differs from the analogous formula of special relativity, in that the gamma factor is different and light speed is γₛc instead of c. These differences could provide a basis for experimental differentiation of the alternative model from special relativity (see below).

If ϕᵣ=90°, Equation (19) produces the transverse Doppler effect observed by a stationary receiver when a moving source emits light at their geometric point of closest approach. At this angle, wavelength is red-shifted to

$${λ}_{r , transverse} = \frac{c}{{f}_{r}} = {γ}_{s} {λ}_{0}$$

When both source and receiver move longitudinally with respect to a stationary observer, frequency is determined by Equation (12), and wavelength is computed by considering relative light speed.

$$relative light speed at moving receiver = c \sqrt{1 + \frac{{( {v}_{s} - {v}_{r} )}^{2}}{{c}^{2}}} \qquad ( 20 )$$

This formula uses the Einstein convention that vᵣ and vₛ are positive when moving in the positive x-direction. Wavelength perceived by the moving receiver will be relative light speed divided by frequency,

$${λ}_{r}^{′} = \frac{c \sqrt{1 + \frac{{( {v}_{s} - {v}_{r} )}^{2}}{{c}^{2}}}}{{f}_{r}^{′}}$$

If vₛ=vᵣ, then fᵣ′=f₀ and λᵣ′=λ₀. Which means that a receiver traveling at the same speed and direction as a source in an IRF will perceive source frequency to be f₀ waves per second′, wavelength to be λ₀ meters per wave, and light speed to be c meters per second′.

If velocities are longitudinal with respect to light's direction, and equal but opposite (−vᵣ=vₛ=v), the relationship between source and receiver frequencies for the alternative model, is,

$${f}_{r}^{′} = {f}_{s}^{′} \frac{1 + \frac{v}{{γ}_{s} c}}{1 - \frac{v}{{γ}_{s} c}}$$

Therefore, when a receiver and a source move toward each other at the same speed relative to a stationary medium, both movements contribute to an increase in frequency at the receiver. This result is similar to the one produced by Equation (11), except light speed with respect to the stationary frame is γₛc instead of c, which affects the final frequency. Equation (11) approaches infinity as v approaches c, and zero when v approaches −c; the alternative version does not. In the alternative model, longitudinal light coming from a moving source travels faster than the source, and so light from the source will reach the receiver before the source reaches the receiver. Longitudinal light coming from a stationary source travels at c, and so the frequency observed by a receiver moving away from a stationary source at speed c will be zero (the light never reaches the receiver and the receiver sees no waves). The frequency observed by a receiver moving at c towards a stationary source will be 2\sqrt{2}f₀ waves per second′, and wavelength will be λ₀/2 meters. This difference might potentially provide a means for differentiating the alternative model from special relativity

### Doppler Transformations

(Note the symbols Δ and d are used interchangeably in this specification to represent small changes.) When the longitudinal Doppler equations are expressed in reference frame transformation format, the “proper period” can be considered to be,

$$d t ' = \frac{1}{{f}_{s}} = \frac{1}{{f}_{0}}$$

When the source is stationary, fₛ is denominated in waves per second, and dt′ is denominated in seconds per wave. When the source moves, source frequency fₛ′ and proper period dt′ maintain their numerical values when measured in source-frame waves per seconds' and seconds′ per wave respectively. These seconds' can be converted to stationary-frame seconds per wave by multiplying dt′ by γ_{s,s} (using the speed of the source) seconds per second′, but the computation of dt requires further manipulation (see below). If the source remains stationary and the receiver moves, the source emission frequency remains f₀ waves per second, but the moving receiver perceives these as γ_{s,r}f₀ (using the speed of the receiver) waves per receiver seconds′ (The magnitude of seconds per second′ is determined by the speed of the observer determining time. If the source and receiver are both moving, each will measure time based on their respective speeds. A second can only be universal if there is a preferred frame of reference by which to define a second.). Special relativity and the alternative model agree on these principles, but differ with respect to the formulas for gamma.

The proper length in meters is,

dx′=λ₀

If the source moves, its average longitudinal emission wavelength increases by a factor of γ_{s,s} or γ_{L,s} depending on the model (transverse Doppler red shift). In the alternative model, if the receiver moves transversely, the source and receiver continue to observe a wavelength of λ₀, but the receiver will measure a frequency of γ_{s,r}f₀ waves per second′ and a speed of light equal to γ_{s,r}c meters per second′ when the receiver is geometrically at right angles to the approaching light. In special relativity theory, if the receiver moves transversely, holding light speed to c meters per second′ would require the source and receiver to observe a contracted wavelength of λ₀/γ_{L,s} meters, the receiver to measures a frequency of γ_{L,r}f₀ waves per second′, and a speed of light equal to c meters per second′.

For both special relativity theory and the alternative model, if a receiver is stationary, light speed emitted transversely by either a stationary or moving source, measured in meters per second by the stationary receiver (convert meters per second′ to meters per second by dividing by γₛ), will be,

$$\frac{{dx}^{′}}{d t '} transverse , stationary receiver = {γ}_{s} {λ}_{0} ( \frac{{f}_{0}}{{γ}_{s}} ) = c$$

However, for the alternative model, a receiver moving transversely will measure light to be moving at γ_{s,r}c meters per second′ when at the point of closest approach to the source,

$$\frac{{dx}^{′}}{{dt}^{′}} transverse , moving receiver , alt = {λ}_{0} \cdot {γ}_{s , r} {f}_{0} = {γ}_{s , r} c$$

whereas special relativity theory contemplates the moving receiver to measure light speed at c contracted meters per second′,

$$\frac{{dx}^{′}}{d t '} transverse , moving receiver , SR = \frac{{γ}_{L , r} {λ}_{0} {f}_{0}}{{γ}_{L , r}} = c$$

Longitudinal light follows similar reference frame transformation principles. For the alternative model, stationary receiver wavelength is light speed multiplied by dt seconds,

$$dx alt = {λ}_{r} = lightspeed x dt = {γ}_{s , s} c {γ}_{s , s} {dt}^{′} + \frac{{γ}_{s , s} c {v}_{s} {dx}^{′}}{{c}^{2}} = {γ}_{s , s}^{2} {λ}_{0} + {γ}_{s , s} {v}_{s} {λ}_{0} / c$$

The time period as observed by a stationary receiver in waves per second, is

$$d t = \frac{1}{{f}_{r}} = {γ}_{s , s} {dt}^{′} + \frac{{v}_{s} {dx}^{′}}{{c}^{2}} = \frac{{γ}_{s , s} {λ}_{0}}{c} + \frac{{v}_{s} {λ}_{0}}{{c}^{2}}$$

And longitudinal light speed as detected by a stationary receiver is,

$$\frac{d x}{d t} = {γ}_{s , s} c$$

### Energy

For purposes of describing the energy associated with light, the Doppler convention of assigning a positive speed to a source moving toward a receiver or a receiver moving toward a source, will provide a more intuitive understanding of the relationships. Therefore throughout the remainder of this section on energy, both vᵣ and vₛ will be positive when one object moves toward the other object.

In 1901, Max Planck proposed that energy could be quantized in proportion to frequency [24],

E=hf

which Einstein referenced to explain the photoelectric effect [25]. Multiplying both sides of Equation (11) by Planck's constant yields what would be predicted for photon energy as observed by a moving receiver according to special relativity (as measured in joule·second/second′, a unit that is smaller than a joule by a factor of γ_{L}),

$${E}_{r}^{′} = {hf}_{s}^{′} \frac{{γ}_{L , r} ( 1 + \frac{{v}_{r} {cos ϕ}_{s}}{c} )}{{γ}_{L , s} ( 1 - \frac{{v}_{s} {cos ϕ}_{r}}{c} )}$$

If this equation is divided by γ_{L,r} the units are converted to stationary frame joules.

$${E}_{r , s}^{′} = {hf}_{s}^{′} \frac{( 1 + \frac{{v}_{r} {cos ϕ}_{s}}{c} )}{{γ}_{L , s} ( 1 - \frac{{v}_{s} {cos ϕ}_{r}}{c} )} \qquad ( 21 )$$

(This equation represents energies as measured in the stationary frame.

Multiplying both sides of the equation by the same numerical value for Planck's constant yields energy in stationary frame joules on both sides of the equation. It is conceivable that if Planck were to have derived his constant in a different inertial reference frame having a different clock rate, yielding dimensional units of joule′-seconds′, a different numerical value for the constant would have been derived. If such dimensional units were used for a moving frame, h′ could be converted to a stationary frame h by dividing it by γ_{s,r} in the same manner that fᵣ′ is converted to stationary frame f_{r,s}′.)

When the source is stationary and the receiver is in motion, the photon energy detected by the moving receiver, as expressed in stationary frame joules is,

$${E}_{r , s}^{′} = h {f}_{0} ( 1 + \frac{{v}_{r} {cos ϕ}_{s}}{c} ) .$$

(One can think of this equation in terms the receiver encountering particles, each having energy hf₀, at a rate proportional to 1+vᵣ/c (when cos ϕₛ=1). For example a machine gun might fire bullets having a mass of m, traveling at speed c, at a rate of f₀ bullets per second, where each bullet has energy hf₀. If a target moves directly toward or away from the machine gun, the target will encounter more or fewer bullets per second depending on the ratio of the speed of the target divided by the speed of the bullets. The movement of the target does not increase the mass, stationary frame speed, or stationary frame energy of each bullet, merely the rate at which the target encounters the bullets.)

When receiver and source velocities are zero, the equation further simplifies to,

E_{r,s}′=hf₀

which is the Planck-Einstein relation for light coming from a stationary source as detected by a stationary receiver.

According to Einstein [20] and to Equation (11), when a receiver is stationary and a source is moving, the energy of a photon coming longitudinally from the moving source is (in joules),

$${E}_{r} = h {f}_{r} = \frac{{hf}_{s}^{′}}{{γ}_{L , s} ( 1 - \frac{{v}_{s} {cos ϕ}_{r}}{c} )}$$

When source motion is strictly transverse, cos ϕᵣ=0, and photon energy at the point of closest approach as seen in the stationary frame is,

$${E}_{r} = h {f}_{r} = \frac{{hf}_{s}^{′}}{{γ}_{L , s}} = \frac{h {f}_{0}}{{γ}_{L , s}}$$

This is consistent with a moving source emitting lower-frequency photons transversely than a stationary source.

According to special relativity, when two photons are emitted from a moving source longitudinally in opposite directions (cos ϕ=1) the average energy (in joules) of the photons as measured by flanking stationary receivers will be,

$${E}_{r photon average} = 0.5 \frac{{hf}_{2}^{′}}{{γ}_{L , s}} ( \frac{1}{1 - \frac{{v}_{s}}{c}} + \frac{1}{1 + \frac{{v}_{s}}{x}} ) = \frac{{hf}_{s}^{′}}{{γ}_{L , s}} {γ}_{L , s}^{2} = {γ}_{L , s} {hf}_{s}^{′} = {γ}_{L , s} {hf}_{0}$$

whereas the average energy (measured in stationary frame joules) transferred to two receivers moving longitudinally at the same speed in the same direction and flanking a stationary source is,

$${E}_{r , s photon average}^{′} = 0.5 h {f}_{0} ( ( 1 + \frac{{v}_{r}}{c} ) + ( 1 - \frac{{v}_{r}}{c} ) ) = h {f}_{0}$$

Therefore, according to special relativity, the average photon energy experienced by the stationary receivers (as measured in joules) increases as the speed of the source increases (such speed increases the γ_{L,s} factor). This not due to time dilation of the receivers' clocks; the receivers are not moving. This increase in average energy experienced by the stationary receivers (and thus emitted by the moving source) is independent of the fundamental emission frequency of the source when measured in the source's frame, fₛ′ waves per second′=f₀ waves per second′. In other words, although the transverse Doppler effect reduces the stationary frame emission frequency to f₀/γ_{L,s} waves per second, the average frequency experienced by the receivers (and thus emitted by the moving source) increases to γ_{L,s}f₀ and the average energy increases to γ_{L,s}hf₀. Since the γ_{L,s}-fold increase in energy is not due to a clock effect, the increase in average energy of the emitted light must be due to some other effect.

One might speculate that the energy experienced by the receivers is a function of their “relative motion” with respect to the moving source. But the average relative velocity of the receivers with respect to the moving source is zero; and the increased energy is being measured in joules, not in time-dilated joule·seconds/second′. If relative speed were the explanation for change in energy, then moving toward a source (or a source moving toward a receiver) would cause a greater increase in energy than moving away from a source (or a source moving away from a receiver), and thus a moving source would have to lose different amounts of energy depending upon its direction of motion relative to a stationary receiver. This is not consistent with the concept that the kinetic energy of a body is related to its absolute speed relative to an observer, independent of its direction. Thus the residual energy of a moving source that has emitted two photons longitudinally in opposite directions is a function of its speed relative to the observers measuring its residual energy; and the total energy of the emitted photons is not only a function of photon frequency, but also a function of source speed! This presents an inconsistency in the Planck-Einstein formula.

If the stationary frame energies for light transmitted and received longitudinally are equated for a moving source/stationary receiver and a stationary source/moving receiver, where fₛ′ is shown as its numerical equivalent f₀,

$$\frac{h {f}_{0}}{{γ}_{L , s} ( 1 - \frac{{v}_{s}}{c} )} = h {f}_{0} ( 1 + \frac{{v}_{r}}{c} ) ,$$

one can solve for the speed at which a moving receiver must travel to encounter a photon coming longitudinally from a stationary source having energy (expressed in stationary frame joules) equal to the energy that a stationary receiver experiences when colliding with a photon coming from a moving source. Solving for vᵣ,

$${v}_{r} = \frac{c}{{γ}_{L , s} ( 1 - \frac{{v}_{s}}{c} )} - c$$

which can be rearranged using a conversion valid for longitudinal light,

$$\frac{c}{{γ}_{L , s} ( 1 - \frac{{v}_{s}}{c} )} \times \frac{{γ}_{L , s} ( 1 + \frac{{v}_{s}}{c} )}{{γ}_{L , s} ( 1 + \frac{{v}_{s}}{c} )} = {γ}_{L , s} ( c + {v}_{s} ) \\ to yield , \\ {v}_{r} = ( {γ}_{L , s} - 1 ) c + {γ}_{L , s} {v}_{s} \qquad ( 22 )$$

Equation (22) has significant implications. It shows that a moving receiver must move toward a stationary source faster than a moving source must move toward a stationary receiver in order for the moving receiver to encounter photons having stationary frame energy equal to that of photons coming from the moving source. A receiver must travel not only γ_{L,s} times faster than a moving source (in special relativity but not in the alternative model—see below), but must also travel (γ_{L,s}−1)c faster yet. This latter term is intriguing. It represents the difference between speeds γ_{L,s}c and c; that is, an amount by which some speed exceeds speed c. In other words, part of the energy difference can be replicated by a receiver traveling faster than a source by an amount equal to the amount by which speed γ_{L,s}c exceeds speed c. It should be emphasized that nothing from the alternative model has been invoked to reach this conclusion for special relativity.

The (γ_{L}−1)c term reveals that a moving receiver will have to travel in the direction of the source by an additional amount of speed equal to the difference between a speed faster than light speed, γ_{L}c and speed c. And the receiver must attain this differential speed in the direction of the source regardless of whether the source moves toward or away from the stationary receiver (since γ_{L}≥1 regardless of the direction of source motion). This phenomenon cannot be caused or modulated by the action of a primary Doppler effect (“PDE”), since a PDE cannot result in an increase of frequency and energy in both directions. This finding is consistent with a moving source emitting parallel and antiparallel photons possessing greater combined energy than photons emitted by a stationary source (and thus losing more energy than a stationary source), where such greater energy is related in some way to a speed that exceeds light speed c. Again,

$${E}_{r photon average} = 0.5 \frac{{hf}_{s}^{′}}{{γ}_{L , s}} ( \frac{1}{1 - \frac{{v}_{s}}{c}} + \frac{1}{1 + \frac{{v}_{s}}{c}} ) = \frac{{hf}_{s}^{′}}{{γ}_{L , s}} {γ}_{L , s}^{2} = {γ}_{L , s} {hf}_{s}^{′} = {γ}_{L , s} h {f}_{0}$$

$$whereas , \\ {E}_{r , s photon average}^{′} = 0.5 ( h {f}_{0} ( 1 + \frac{{v}_{r} cos {ϕ}_{s}}{c} ) + h {f}_{0} ( 1 - \frac{{v}_{r} cos {ϕ}_{s}}{c} ) ) = h {f}_{0}$$

If photons behaved like massive objects, this energy difference could be represented as photons traveling at speed γ_{L,s}c when emitted longitudinally by a moving source versus speed c when emitted by a stationary source. Particles/wave-fronts do not take on a higher frequency simply because transmission speed is increased. Absent the primary Doppler effect, particle/wave-front frequency is determined by the core emission frequency at the source, not particle/wave-front speed. Thus, if the wave-nature and particle-nature of light were to both travel at γ_{L,s}c, the higher speed would not in itself affect wave frequency, but (in contrast to the teachings of the Plank-Einstein relation) it would affect particle energy.

These findings can be explained more consistently by postulating that the speed of photons emitted by a moving source depends on the angle of emission according to the following formula,

$${v}_{p} = c \sqrt{( {c}^{2} + {v}_{s}^{2} ) / ( {c}^{2} + {v}_{s}^{2} {sin}^{ 2} {ϕ}_{s} )} = c {γ}_{ϕ}$$

That is, photons (and light waves) emitted in the longitudinal direction (ϕ=0 or π) travel \sqrt{1+vₛ²/c²} faster than photons emitted transversely (which are emitted at speed c when cos ϕₛ=0); and travel faster than photons emitted in any direction by a stationary source (which are emitted at speed c when vₛ=0).

If a photon were to be modeled as a Newtonian particle, its Newtonian kinetic energy would be,

$$K {E}_{N e w t o n} = \frac{1}{2} {m}_{N} {v}_{p}^{2}$$

To be consistent with the Planck-Einstein convention, the “mass-energy” of a photon emitted by a stationary source can be defined as

$${m}_{0} = \frac{{m}_{N}}{2} = \frac{{E}_{0}}{{c}^{2}} = \frac{h {f}_{0}}{{c}^{2}}$$

Using this Newtonian model, the emission energy of a photon coming from a moving source, subject to γ_{s,s}-fold time dilation of its emission frequency (momentarily ignoring the PDE) would be approximated by,

$${E}_{photon} = \frac{h {f}_{0}}{{c}^{2} {γ}_{s , s}} {( c {γ}_{ϕ} )}^{2} = \frac{{m}_{0}}{{γ}_{s , s}} {( c {γ}_{ϕ} )}^{2} = \frac{{m}_{0} {c}^{2}}{{γ}_{s , s}} ( \frac{1 + \frac{{v}_{s}^{2}}{{c}^{2}}}{1 + {( \frac{{v}_{s}^{2}}{{c}^{2}} sin )}^{2} {ϕ}_{s}} )$$

where γ_{s,s} is an angle-independent time dilation (TDE) factor, γ_{s,s}=\sqrt{1+vₛ²/c²}. That is, when ϕ≠±π/2, photons traveling at speed γ_{ϕ}c possess greater energy than photons traveling at speed c. In this Newtonian model, the additional speed accounts for an approximately γₛ² fold increase in the energy of photons emitted in opposite directions longitudinally versus transversely, which reflects the square of their difference in speed.

However a moving source emits an asymmetric wave pattern. That is, a moving source trails the waves it emits in the forward direction and moves farther away from waves it emits in the rearward direction, thereby creating an asymmetric distribution of wavelengths, frequencies, and energies as viewed from the stationary frame (FIG. 7D). A moving receiver experiences wavelengths asymmetrically due to its motion (FIG. 7C), but the actual wave pattern coming from a stationary source as observed in the stationary frame is spherical and symmetric. The asymmetric distribution of energy created by a moving source, as observed from the stationary frame, must raise entropy in the stationary frame. This asymmetric pattern represents a degree of disorder compared to a spherical wave pattern, and additional energy is required to establish this disorder. Therefore the 360 degree average of frequencies and energies from a stationary source should equal f₀ and hf₀, respectively, but should exceed those values from a moving source.

Using the alternative model, when two photons are emitted in opposite directions by a moving source, the PDE-modulated, average emission energy is,

$${E}_{2 photons average} = \frac{{m}_{0} {c}^{2}}{{γ}_{s , s}} ( \frac{0.5}{1 - \frac{{v}_{s} cos {ϕ}_{s}}{{γ}_{ϕ} c}} + \frac{0.5}{1 + \frac{{v}_{s} cos {ϕ}_{s}}{{γ}_{ϕ} c}} ) = \frac{{m}_{0} {c}^{2}}{{γ}_{s , s} ( 1 - \frac{{v}_{s}^{2} {cos}^{2} {ϕ}_{s}}{{γ}_{ϕ}^{2} {c}^{2}} )}$$

Summing the right side of the equation over 360°, and averaging, yields an amount of energy that is greater than m₀c²=hf₀. That is, a moving source emits photons of higher energy when averaged in all directions as compared to the energy from a stationary source. Special relativity and the Newtonian model fail to account for this required incremental energy (and lower entropy).

The asymmetric distribution of energy associated with (not caused by) the PDE can be computed by subtracting the Newtonian energy (which lacks an entropy component) from the alternative model energy of a single photon emitted at the same angle,

$$Δ {E}_{P D E} ( ϕ ) = \frac{{m}_{0} {c}^{2}}{{γ}_{s , s}} ( \frac{1}{1 - \frac{{v}_{s} cos {ϕ}_{s}}{{γ}_{ϕ} c}} - {γ}_{ϕ}^{2} ) .$$

If the symbol Σₚ² is defined as,

$${Σ}_{p}^{2} = \frac{1}{( 1 - \frac{{v}_{s}^{2} {cos}^{2} {ϕ}_{s}}{{γ}_{ϕ}^{2} {c}^{2}} )} ,$$

Eq. (19) can be conformed according to the postulates of the present disclosure and multiplied by Planck's constant to yield,

$${E}_{p} = \frac{h {f}_{0}}{{γ}_{s , s}} \frac{1}{1 - \frac{{v}_{s} cos ϕ}{{γ}_{ϕ} c}} = \frac{h {f}_{0}}{{γ}_{s , s}} {Σ}_{p}^{2} ( 1 + \frac{{v}_{s} cos {ϕ}_{s}}{{{γ}_{ϕ}}^{C}} ) = \frac{{m}_{0} {c}^{2}}{{γ}_{s , s}} {Σ}_{p}^{2} ( 1 + \frac{{v}_{s} cos {ϕ}_{s}}{{γ}_{ϕ} c} ) \qquad ( 23 )$$

The m₀c²Σₚ/γ_{s,s} term represents the bi-directional average photon energy (including the entropy component) for a given angle ϕ. The velocity term represents the PDE modulation of that energy. Integration of the PDE-term in parentheses over 360° yields zero, reflecting the passive nature of the PDE.

Note that when transmission is longitudinal (i.e. cos ϕ=1) then Σₚ²=γₛ², in which case

$${E}_{2 photons opposite longitudinal} = {γ}_{s} {m}_{0} {c}^{2} = {γ}_{s} h {f}_{0}$$

In other words, photons obey the mass-energy relation when viewed longitudinally, provided the appropriate gamma factor is used.

When the source is stationary, this reduces to the mass-energy relation,

$${E}_{p} = {m}_{0} {c}^{2} = h {f}_{0}$$

When cos ϕ=0, γ_{ϕ}=1 and the energy of a transverse photon from a moving source is,

$${E}_{p} = \frac{1}{{γ}_{s , s}} {m}_{0} {c}^{2} = \frac{h {f}_{0}}{{γ}_{s , s}}$$

Reassuringly, Eq. (23) exactly equals Planck's constant times Eq. (19) for all angles of ϕ, where Eq. (19) has been conformed to a photon speed of γ_{ϕ}c. Eq. (23) reveals that the core emission energy from a moving source is a function of emission angle and source speed, as then further modulated by PDE changes in the aggregate photon density leading and lagging the moving source.

For strictly longitudinal motion in the alternative model (cos ϕ=1), if the stationary frame energies are equated for a moving source/stationary receiver and a stationary source/moving receiver, where fₛ′ is shown as its numerical equivalent f₀,

$$\frac{h {f}_{0}}{{γ}_{s , s} ( 1 - \frac{{v}_{s}}{{γ}_{s , {s}^{C}}} )} = h {f}_{0} ( 1 + \frac{{v}_{r}}{c} )$$

one can solve for the speed at which a moving receiver experiences a photon coming longitudinally from a stationary source possessing energy (in joules) equal to the energy that a stationary receiver experiences when colliding with a photon coming from a moving source. Solving for vᵣ,

$${v}_{r} = \frac{c}{{γ}_{s , s} ( 1 - \frac{{v}_{s}}{{γ}_{s , {s}^{C}}} )} - c$$

which can be rearranged to separate out a vₛ term using a conversion valid for longitudinal light,

$$\frac{c}{{γ}_{s , s} ( 1 - \frac{{v}_{s}}{{γ}_{s , {s}^{C}}} )} x \frac{{γ}_{s , s} ( 1 + \frac{{v}_{s}}{{γ}_{s , {s}^{C}}} )}{{γ}_{s , s} ( 1 + \frac{{v}_{s}}{{γ}_{s , {s}^{C}}} )} = {γ}_{s , s} ( c + {v}_{s} / {γ}_{s , s} ) \\ to yield , \\ {v}_{r} = ( {γ}_{s , s} - 1 ) c + {v}_{s} \qquad ( 24 )$$

This equation is very similar to Equation (22) of special relativity except that there is no gamma factor modifying the vₛ term, and γ_{s,s} uses the alternative model formula rather than the Lorentz formula. This means that the speed that a receiver must travel longitudinally to encounter photons with energy equal to the energy of photons coming longitudinally from a moving source is simply (γ_{s,s}−1)c faster than vₛ. This is consistent with the alternative model, where photons emitted longitudinally by a moving source travel at γₛc. These relationships, and Equation (24) imply that light emitted longitudinally from a moving source travels at speed γₛc, and that this fact is buried deep within the relativistic energy and Doppler equations.

If the value of vᵣ from Equation (24) is used in the energy equation for a moving receiver in the stationary frame (Equation 13),

$${E}_{r , s}^{′} = h {f}_{0} + h {f}_{0} \frac{( {γ}_{s , s} - 1 ) c + {v}_{s}}{c} = h {f}_{0} ( {γ}_{s , s} + \frac{{v}_{s}}{c} )$$

confirming that moving versus stationary receiver energies are equal when receiver velocity equals (γ_{s,s}−1)c+vₛ.

A receiver receding from a stationary source will need to travel away c(γ_{s,s}−1) less rapidly than a receding source relative to a stationary receiver in order to encounter the same energy as that encountered by the stationary receiver. By receding less rapidly, the receiver increases the relative speed of the photon emitted by the stationary source, and the factor of c(γ_{s,s}−1) compensates for the difference in speed between a photon emitted at γ_{s,s}c from the receding source versus a photon emitted at c from a stationary source.

Analogous to Einstein's derivation of the mass-energy relation for moving receivers [26], Equation (23) shows that when two photons are emitted longitudinally in opposite directions from a moving source, the change in energy is,

$$Δ {E}_{moving source , average}^{′} = \frac{{m}_{0}}{{γ}_{s , s}} {( {\sum }_{p} c )}^{2} .$$

If ΔE_{source} is the average change in energy of a stationary source (γ_{s,s}=γ_{ϕ}=1) after emitting a single photon,

$$Δ {E}_{s o u r c e}^{′} - Δ {E}_{s o u r c e} = \frac{{m}_{0}}{{γ}_{s , s}} {( {Σ}_{p} c )}^{2} - {m}_{0} {c}^{2} = ( \frac{{Σ}_{p}^{2}}{{γ}_{s , s}} - 1 ) {m}_{0} {c}^{2} = ( \frac{{Σ}_{p}^{2}}{{γ}_{s , s}} - 1 ) h {f}_{0}$$

This difference is the energy associated with the asymmetric distribution of wave fronts caused by the movement of the source. The 360 degree sum of this quantity is the energy associated with the increase in entropy.

$$\frac{{m}_{0} {c}^{2}}{{γ}_{s , s}} ( \frac{1}{1 - \frac{{v}_{s} cos {ϕ}_{s} 1}{{γ}_{ϕ} c}} - {γ}_{ϕ}^{2} ) = {m}_{0} {c}^{2} ( \frac{{Σ}_{p}^{2}}{{γ}_{s , s}} - 1 )$$

When emission is longitudinal Σₚ=γ_{s,s}, and therefore,

ΔE_{source}′−ΔE_{source}=γ_{s,s}m₀c²−m₀c²=(γ_{s,s}−1)m₀c²=(γ_{s,s}−1)hf₀

This equals Einstein's formula for the change in kinetic energy of a moving source versus a stationary source after emitting a photon (using the more general γ_{s,s} factor instead of the Lorentz factor), derived directly from the alternative model without the truncation of an infinite series (a criticism of Einstein's derivation for a moving receiver). However, when emission is transverse,

$$Δ {E}_{source}^{′} - Δ {E}_{source} = \frac{1}{{γ}_{s , s}} {m}_{0} {c}^{2} - {m}_{0} {c}^{2} = ( \frac{1}{{γ}_{s , s}} - 1 ) {m}_{0} {c}^{2}$$

A moving source loses less energy than a stationary source upon transverse photon emission (red shift). A stationary observer will consider such a moving source to retain more energy than a stationary source counterpart.

The Relationship Between γₛ and γ_{L}

The energy equations of the alternative model and special relativity are closely related, except that γₛ is the more general factor, whereas the Lorentz factor is appropriate when the source has been accelerated with the use of a field that operates at speed c. The γₛ factor does not require the untenable concept of length contraction; and it transforms to the Lorentz factor when forces are mediated by fields at speed c.

The more general form of the mass-energy relation is then

E=γₛmc²

which implies a more general energy-momentum relation,

$$E = \sqrt{{m}^{2} {c}^{4} + {p}^{2} {c}^{2}} = \sqrt{{m}^{2} {c}^{4} + {m}^{2} {v}^{2} {c}^{2}} = \sqrt{1 + {v}^{2} / {c}^{2}} m {c}^{2} = {γ}_{s} m {c}^{2}$$

When v is replaced with γ_{L}vₑ (where vₑ is the velocity of a particle accelerated in a field that acts at speed c), then the energy-momentum relation transforms into,

$$E = \sqrt{1 + {γ}_{L}^{2} {v}_{e}^{2} / {c}^{2}} m {c}^{2} = \frac{m {c}^{2}}{\sqrt{1 - \frac{{v}_{e}^{2}}{{c}^{2}}}} = {γ}_{L} m {c}^{2}$$

The origin of the γ_{L,s}yₛ term in Equation (22) now becomes more clear, since there is no analogous gamma factor in Equation (24). The answer is related to the peculiarities of relativistic mechanics. In special relativity, particles are accelerated by a constant field operating at speed c according to,

a=F/(γ_{L}³m₀)

As particle velocity increases, γ_{L}³, increases, causing less and less acceleration of the particle under a constant field. The velocity of such a particle is equal to its momentum divided by the Lorentz gamma factor times the particle's rest mass.

$${v}_{e} = \frac{p}{{γ}_{L} {m}_{0}} = \frac{F t}{{γ}_{L} {m}_{0}}$$

Stated differently,

$${γ}_{L} {v}_{e} = \frac{F t}{{m}_{0}}$$

In Newtonian mechanics, Newtonian velocity is

$${v}_{N} = \frac{F t}{{m}_{0}}$$

In other words, under the laws of special relativity, particle velocity is gamma fold slower than the same particle accelerated under Newtonian mechanics,

$${v}_{e} = \frac{{v}_{N}}{{γ}_{L}} = \frac{v}{{γ}_{L}} ,$$

where Newtonian velocity is symbolized as v. It is common to find particle velocity accompanied by a Lorentz gamma factor throughout special relativity, as exemplified in Equation (22) and in the formula for momentum. The alternative model does not follow the same laws of force and acceleration as does special relativity, because it does not necessarily assume that particle velocity is the result of acceleration by a field operating at speed c.

Interestingly, the Lorentz inverted transformation for distance also reveals the relationship between velocity in special relativity versus in the alternative model.

$$Δ {x}^{′} = {γ}_{L} Δ x - {γ}_{L} {v}_{e} Δ t = Δ {x}^{′} ( {γ}_{L}^{2} - \frac{{γ}_{L}^{2} {v}_{e}^{2}}{{c}^{2}} ) where$$

$$Δ x = {γ}_{L} Δ {x}^{′} + {γ}_{L} {v}_{e} Δ {t}^{′} and Δ t = {γ}_{L} Δ {t}^{′} + {γ}_{L} {v}_{e} Δ {x}^{′} / {c}^{2}$$

$$Therefore , \\ {γ}_{L}^{2} - \frac{{γ}_{L}^{2} {v}_{e}^{2}}{{c}^{2}} = 1 and$$

$${γ}_{L} ( {v}_{e} ) = \frac{1}{\sqrt{1 - \frac{{v}_{e}^{2}}{{c}^{2}}}} = \sqrt{1 + \frac{{γ}_{L}^{2} {v}_{e}^{2}}{{c}^{2}}} = {γ}_{s} ( {γ}_{L} {v}_{e} )$$

It then follows that,

$${γ}_{L} ( v / {γ}_{s} ) = \frac{1}{\sqrt{1 - \frac{{v}^{2}}{{γ}_{s}^{2} {c}^{2}}}} = \sqrt{1 + \frac{{v}^{2}}{{c}^{2}}} = {γ}_{s} ( v )$$

In other words, the inverted Lorentz transformation for distance Δx′ shows that γ_{L} and γₛ are the same when vₑ is replaced with v/γₛ in the formula for γ_{L} and when v is replaced with γ_{L}vₑ in the formula for γₛ. Essentially γₛ is the appropriate gamma factor when forces act directly on objects (such as when ejecting fuel from the back of a rocket) rather than being acted upon by a field that operates at speed c from a distance. γ_{L} is the appropriate gamma factor when a force is transmitted by a field that acts at speed c (such as with an electromagnetic field).

A reconciliation of Equations (22) and (24) shows that v=γ_{L}vₑ when photon energies are equalized. Therefore, when a source travels at vₑ in the special relativity model, it emits photons having the same energy as those emitted by a source traveling at v=γ_{L}vₑ in the alternative model. This suggests that objects traveling at vₑ in the special relativity model are either a) traveling faster than recognized, b) associated with additional energy that is not embodied solely in the longitudinal speed of the particle, or c) the light speed of the system is faster than c, and the ratio of vₑ/c is equivalent to v/γₛc.

For massive objects, when v=γ_{L}vₑ, then

γₛ=γ_{L}=\sqrt{1+vₛ²/c²}

and when this is multiplied by mc²,

γₛmc²=γ_{L}mc²=\sqrt{m²c⁴+m²v²c²}=\sqrt{m²c⁴+γ_{L}²m²vₑ²c²}

This is Einstein's relativistic energy-momentum relation (It should be noted that velocity in these equations can be computed with the velocity addition formula if needed.),

$$γ m {c}^{2} = \sqrt{{m}^{2} {c}^{4} + {γ}^{2} {m}^{2} {v}_{e}^{2} {c}^{2}}$$

This further supports the notion that particles traveling at vₑ, under conditions consistent with special relativity, may be associated with additional energy (by a factor of γ_{L}) not embodied within the longitudinal velocity of the particle as measured in the stationary frame. This is the “relativistic” adjustment to velocity found in the relativistic energy-momentum relation.

Special relativity provides for a computation of kinetic energy by subtracting rest energy from total energy.

E_{kinetic}=Eₜₒₜₐₗ−Eᵣₑₛₜ=(γ_{L}−1)mc²

In the alternative model, kinetic energy can be computed similarly,

E_{kinetic}=Eₜₒₜₐₗ−Eᵣₑₛₜ=(γₛ−1)mc²

The MacLaurin series expansion of γₛ−1 is,

$${γ}_{s} - 1 \approx \frac{1}{2} {v}^{2} / {c}^{2} - \frac{3}{8} {v}^{4} / {c}^{4} + \frac{1}{16} {v}^{6} / {c}^{6} - …$$

When the first term of this expansion is multiplied by mc² the result is the familiar ½mv². As IRF velocity and/or object velocity within an IRF increases, the higher order terms become significant, and cause this series expansion to deviate from the series expansion of the Lorentz y factor. Therefore, both models predict the same rest energy, but an object moving at speed v in the alternative model would be associated with less kinetic energy than an object moving at speed vₑ in special relativity.

There is little numerical difference between the γₛ−1 and γ_{L}−1 terms at low velocity. However, as velocity grows large, special relativity predicts that kinetic energy tends toward infinity. This has led to the belief that it would require an infinite amount of energy to accelerate a mass to the speed of light. That may be true when the accelerating force acts at speed c; but in the alternative model, the kinetic energy needed to accelerate a mass to the speed of light would be (\sqrt{2}−1) times mc², which would be possible if the mass is accelerated with a force that itself is not limited by transmission speed c. It is still a large amount of energy, but nowhere near the infinite amount of energy required as predicted by special relativity. (Interestingly, the alternative model predicts that the energy of a particle increases in proportion to γₛ, and the harmonic frequency of a particle decreases in proportion to γₛ (higher order Doppler effect); thus the increase in kinetic energy of the center of mass of a moving IRF is directly proportional to the decrease in kinetic energy resulting from “clock rate time-dilation”.)

Since total energy can be expressed in terms of either the Lorentz gamma factor or the alternative gamma factor,

Eₜₒₜₐₗ=γ_{L}mc² OR γₛmc²

the values of these gamma factors can be computed by taking the ratio of total energy divided by rest energy,

Eₜₒₜₐₗ/Eᵣₑₛₜ=γ_{L}=γₛ

The corresponding velocities can then be obtained by rearrangement,

$$v / c = \sqrt{{( {E}_{total} / {E}_{rest} )}^{2} - 1} and$$

$${v}_{e} / c = \sqrt{1 - {( {E}_{rest} / {E}_{total} )}^{2}}$$

In other words, if the total energy and rest energy are known, then v and vₑ can be computed. If the actual, measured velocity matches a computed velocity of vₑ/c, then the system is such that velocity has been tempered by the transmission speed of the accelerating force (for example, electromagnetic forces act at speed c, which cannot accelerate a particle beyond that speed regardless of how much energy has been applied to the particle). Whereas if the actual measured velocity matches a computed velocity of vₛ/c, then the accelerating forces are not limited by a transmission speed of c.

As with Einstein's model, the term m²c⁴ is invariant in the alternative model,

γₛ²m²c⁴−m²vₛ²c²=m²c⁴

### Momentum

The energy-momentum relation can be written in terms of momentum.

$${E}_{total} = {γ}_{s} m {c}^{2} = \sqrt{{m}^{2} {c}^{4} + {p}^{2} {c}^{2}}$$

Using the velocity of the alternative model, momentum is computed using the classical formula,

p=mv

In contrast, relativistic momentum is defined using a gamma factor to bring velocity to the equivalent of v,

p_{SR}=mγ_{L}vₑ

Physicists once believed that mγ_{L} was the “relativistic mass”, where mass increased as a particle's velocity increased. The analysis above suggests that there is something unique about particles traveling at vₑ under “relativistic conditions”; that they seem to be associated with an amount of additional momentum and energy not represented in the longitudinal velocity of the particle itself.

### Photon Mass/Energy

It is generally believed that photons have no mass, essentially because Lorentz's gamma factor equals infinity when vₑ=c, which would cause the relativistic momentum, mγvₑ, to become infinite. The special relativity solution to this issue is to deem the mass of a photon to be zero. Hypothetically, infinity multiplied by zero could equal something that corresponds with experimental measurement, but it is an odd way to compute a finite number. Special relativity assumes that the m²c⁴ term of the energy-momentum relation is zero for a photon, and that the γ²m²vₑ²c² term, where zero mass is squared and multiplied by infinity squared, and then multiplied by vₑ², which is assumed to be equal to c², all equals photon energy squared. Which somehow leads to,

$${E}_{photon , special relativity} = \sqrt{{γ}^{2} {m}^{2} {c}^{4}} = \sqrt{{∞}^{2} {0}^{2} {c}^{4} ?} = h f$$

where h is Planck's constant. Based on that assumption, special relativity then suggests that photon momentum equals a photon's energy divided by c.

$${p}_{photon , special r elativity} = \frac{{E}_{photon}}{c} = h f / c$$

The alternative model is more concrete. γₛ does not go to infinity at speed c; instead it equals \sqrt{2}.

Drawing from the alternative model equation for stationary receiver frequency, the energy of a photon emitted by a moving source toward a stationary receiver is,

$${E}_{p} = \frac{h {f}_{0}}{{γ}_{s , s}} \frac{1}{1 - \frac{{v}_{s} cos ϕ}{{γ}_{ϕ} c}} = \frac{{Σ}_{p}^{2}}{{γ}_{s , s}} {m}_{0} {c}^{2} ( 1 + \frac{{v}_{s} cos ϕ}{{γ}_{ϕ} c} )$$

It is interesting to note that photon mass-equivalent energy is not a constant. The larger the emission frequency of a given source element energy transition, fₛ′, the greater the mass-equivalent energy of the emitted photon.

Whether a photon has “true mass” or a mass-equivalent of energy is beyond the scope of this disclosure. However, photons are subject to gravitation, create an impact upon collision, and are part of a group of gauge bosons, the other members of which W⁺, W⁻, and Z⁰, have mass (Note that in the alternative model, the mass, momentum, and energy of a photon increase linearly with frequency, and therefore the model is consistent with the energy of a photon traveling at speed c increasing linearly with frequency. At light speeds much greater than c, γₛ begins to grow linearly with incremental vₛ, causing total photon energy to increase linearly.).

### Velocity Addition

Einstein developed a longitudinal velocity addition formula by dividing the Lorentz transformation for Δx by the Lorentz transformation for Δt, and subsequently dividing both numerator and denominator by Δt′. Since all terms in the Lorentz transformations are preceded by γ, both numerator and denominator also can be divided by γ to eliminate these factors. The basic concept is that vΔt′ represents movement of the IRF and Δx′ represents movement within the IRF. When these terms are divided by Δt′, v is simply the velocity of the IRF measured in meters per second, and Δx′/Δt′ is the velocity of an element, such as light, within the IRF measured in meters per second′. Since the mathematics of the Lorentz transformations require length contraction, Einstein's velocity addition formula would be erroneous if length contraction did not exist.

The alternative longitudinal velocity addition formula assumes that length contraction does not exist. It can be derived by dividing the first two alternative transformations by γₛΔt′, renaming Δx′/Δt′“v₂′”, and computing γₛ with speed v₁.

$$\frac{Δ x / {γ}_{s} Δ {t}^{′}}{Δ t / {γ}_{s} Δ {t}^{′}} ( alt velocity addition ) = ( {γ}_{s} {v}_{2}^{′} + {v}_{1} ) / ( 1 + {v}_{2}^{′} {v}_{1} / {γ}_{s} {c}^{2} ) \qquad ( 25 )$$

It is important to note that v₂′ is measured within the moving IRF in meters per second′. When γₛv₂′=−v₁ then Δx/Δt=0. Interestingly, when light travels within a moving IRF at speed v₂′=c meters per second′, the longitudinal velocity addition formula predicts that the total speed at which light moves through the IRF, relative to an outside observer's reference frame, will be γₛc. This is consistent with the postulates of this disclosure.

When velocity v₁ is negative, the IRF moves opposite to the direction of light. The velocity addition formula, and the alternative transformations, predict that light will travel a distance γₛ²Δx′ minus γₛvΔt′ (due to negative v₁). The combined distance will be less than the distance traveled when v₁ is positive, but the time required to reach the approaching target within the IRF will also be less; and the value of Δx/Δt will again be γₛc. This means that, as in Einstein's model, light originating within an IRF will travel longitudinally at the same speed, as seen by an outside observer, regardless of the direction of IRF motion. Similarly, when IRF motion is in the positive x-direction, but light travels in the opposite direction (negative Δx′), the resulting longitudinal light speed, as seen by an outside observer, will be negative γₛc (negative x-direction); but identical in magnitude as when light travels in the same direction as IRF motion.

Therefore, the longitudinal velocity addition formula has important practical implications. Assume two clocks, one calibrated in seconds in the CMBR reference frame, and another clock calibrated in seconds' in a reference frame moving relative to the CMBR frame at speed v meters per CMBR-second. If a first observer is stationary within the CMBR frame of reference, then light that is emitted from a source within the moving reference frame, where the direction of such light is oriented longitudinally toward or away from the first observer, such light will travel at speed γₛc meters per second as calculated by the first observer, where the γₛ term

$${γ}_{s} = \sqrt{1 + \frac{{v}^{2}}{{c}^{2}}} = \sqrt{1 + \frac{{( {γ}_{s} v )}^{2}}{{( {γ}_{s} c )}^{2}}} ,$$

is clock-independent and frame-independent. To a second observer traveling in the frame of the moving source, the γₛ term will equal 1, since the relative speed of the source and the second observer is zero, and such second observer will observe the speed of longitudinally-directed light to be c meters per second′. Likewise, if a source that is stationary in the CMBR frame emits light longitudinally toward a observer that is stationary in the CMBR frame, γₛ will again equal 1, and said observer will measure light to travel at speed c meters per second. That is, light coming longitudinally from a source moving at speed v with respect to the CMBR will travel at γₛc meters per CMBR second, whereas light coming from a source that is stationary within the CMBR will travel at c meters per CMBR second, both measurements made with a CMBR-calibrated clock that “beats” in CMBR seconds. If a moving frame observer measures the speed of light approaching from a stationary source in the CMBR, the moving frame observer will observe light to travel at γₛc meters per second′, since the moving frame observer's seconds' will be γₛ longer in duration that a stationary observer's seconds.

If a CMBR-frame observer were to compute light speed coming from a moving source, but using a clock that has been calibrated to “beat” in units of moving frame seconds′, then such first observer would compute the speed of such light to be γₛ²c meters per second′, since seconds' have a duration γₛ times longer than CMBR frame seconds. Thus the CMBR observer will compute light to travel γₛ² times faster than an observer in the moving frame when using comparable clocks.

If a moving-frame observer were to procure a CMBR-calibrated clock, then such moving frame observer would compute light coming from a source stationary in the CMBR to be traveling at speed c meters per CMBR-second. In other words, the frames and clocks are not symmetric. Yet observers in each frame compute the speed of light to be numerically identical when using clocks calibrated and synchronized in their respective frames of reference.

The alternative velocity addition formula demonstrates that variable longitudinal light speed is not solely a phenomenon caused by clocks beating at different rates. Longitudinal light actually travels γₛ times meters per second faster when emitted by a source that is moving relative to the CMBR, as compared to light emitted by a source that is stationary relative to the CMBR.

Einstein's formula for transverse velocity addition was derived by assuming that Δy=Δy′ (no length contraction in the transverse direction), that Δy can be divided by the value of Δt derived from the Lorentz Δt equation, and that numerator and denominator are divided by Δt′, to derive transverse velocity. However, given that the Lorentz Δt equation pertains to longitudinal travel, where the computed forward and backward travel times are not equal (+v versus −v), the computed speeds for transverse light traveling distally versus medially will be different. If both the forward and backward travel times are combined in a time-weighted average, Einstein's transverse velocity addition formula yields an accurate average round-trip velocity. In view of these caveats, the analogous formula in alternative model is,

$$\frac{Δ y}{Δ {t}_{x}} ( alternative velocity addition ) = \frac{{v}_{y 2}}{( {γ}_{S} \pm \frac{{v}_{x 1} {v}_{x 2}^{′}}{{c}^{2}} )} \qquad ( 26 )$$

If the “object” traveling at velocity v_{y2} is light traveling at speed c, then the formula yields the correct y-component of velocity when a combined, time-weighted average Δtₓ is computed for IRF motion in the x-positive and x-negative directions.

When v_{y2}=c and vₓ₁=0, then γₛ=1, and Δy/Δt=c. When vₓ₂′=0 and vₓ₁≠0 then

$$\frac{Δ y}{Δ {t}_{x}} = \frac{{v}_{y 2}}{{γ}_{s}}$$

### Refractive Index

Light travels at different speeds through different substances according to the formula,

c_{medium}=c/n

where n is the refractive index of the medium. The refractive index for water is 4/3, and for glass approximately 3/2. Light travels slower in these media than it does in a vacuum. In 1859 Fizeau reported an experiment [27] showing the impact that the movement of water has on the speed of light passing through the water. Fizeau derived a formula describing the relationship between the speed of the water and the speed of the light passing through it,

$${c}_{m e d i u m} = c / n \pm v ( 1 - \frac{1}{{n}^{2}} ) \qquad ( 27 )$$

This formula seemed to confirm Fresnel's “partial aether drag” hypothesis [28].

However, in 1907, Max von Laue proposed [29] that Fizeau's equation was actually the first term in a series expansion of Einstein's velocity addition formula in which the speed of light through a medium is v₂=c/n,

$${c}_{medium , von Laue} = \frac{\frac{c}{n} + v}{1 + \frac{\frac{vc}{n}}{{c}^{2}}} = \frac{\frac{c}{n} + v}{1 + \frac{v}{c n}} = \frac{c ( \frac{1}{n} + \frac{v}{c} )}{1 + \frac{v}{c n}} \qquad ( 28 )$$

and where v is the velocity of the medium relative to a stationary observer. The concept is that once light enters the refractive medium, it has entered a moving IRF where v is the speed of the IRF and c/n is Δx′/Δt′ within the IRF. Therefore an observer traveling within the IRF, along with the moving medium, would measure light to travel at speed c/n meters per second′. It should be noted that the apparatus containing the medium does not move, only the medium within the apparatus moves. Therefore the pathlength within the apparatus is equal to Δx, not ax′. Equation (28) yields a combined velocity as seen from the stationary frame, Δx/Δt, measured in meters per second.

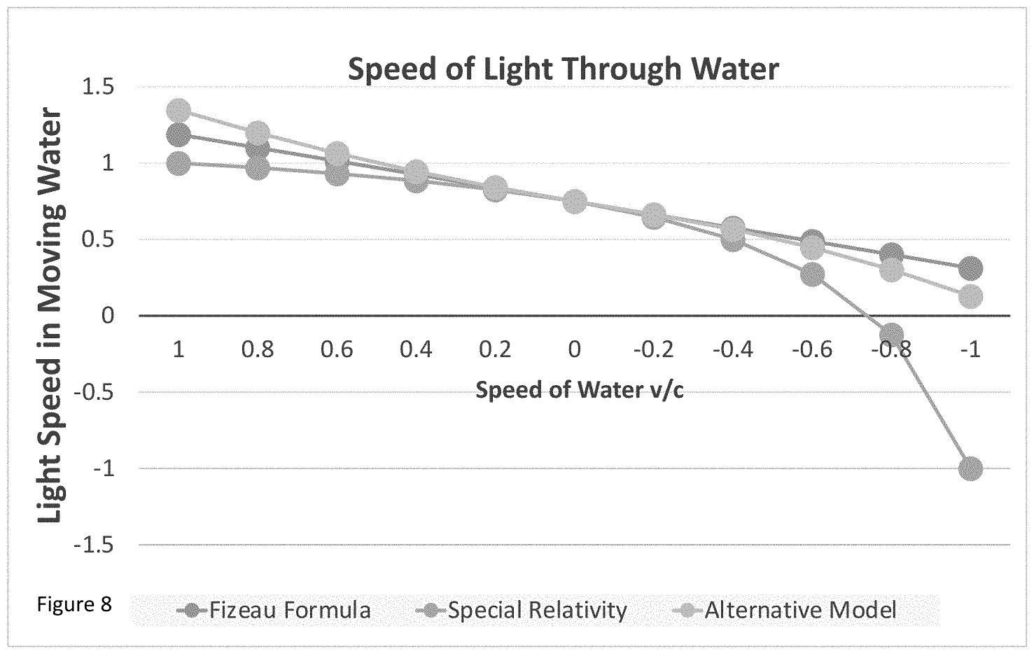

Although the scientific community seems to have accepted Equation (28), there is no definitive proof [30]. Moreover, Equation (28) behaves peculiarly for values of v≤−c/n (see FIG. 8). For example, when v=−c/n, light encounters water moving towards it at the speed that light travels in stationary water, at which point Equation (28) predicts that light comes to a complete stop. That may be possible, but as the antiparallel speed of water is increased, Equation (28) predicts that light reverses direction, and not only begins to travel backwards, but does so far faster than the incremental speed of the oncoming water. This would suggest that the special relativity velocity addition formula, and a series expansion of it to extend the Fizeau formula, are not applicable.

The alternative longitudinal velocity addition formula for light traveling through a refractive medium (ignoring dispersive terms) utilizes:

γₘ=\sqrt{1+vₘ²/c²}

where vₘ is the speed of the medium relative to the stationary frame. The observed speed of light originating in the stationary frame and passing through the medium is given by Equation (29).

$${c}_{medium , alternative} = {c}_{m} = \frac{{γ}_{m} c ( \frac{1}{n} + \frac{{v}_{m}}{{γ}_{m} c} )}{1 + \frac{{v}_{m}}{{γ}_{m} c n}} \qquad ( 29 )$$

Here, the Δx transformation of the alternative model contains the equivalent of a γₘ²Δx′ term that, once divided by γₘΔt′ produces the γₘc/n term in the numerator. The speed of light within the moving medium remains Δx′/Δt′=c/n; but the stationary frame speed becomes γₘc/n, as opposed to c/n for special relativity, because the alternative model does not contract lengths by a factor of gamma. The equivalent vₘγₘΔt′ term of the alternative Δx transformation becomes vₘ after division by γₘΔt′; and it represents the average extra distance that the medium travels while light traverses the full Δx length of the apparatus, as opposed to light traveling a shorter distance of Δx′ if the medium is stationary (when light is traveling in the direction of the moving medium).

When n>1, Equation (29) predicts a gradual slowing of light speed with increasing refractive medium speed, but, unlike the von Laue formula, not a reversal of direction when medium speeds are less than or equal to c. The original (not expanded) Fizeau formula predicts similar behavior as Equation (29) (see FIG. 8). Moreover, Equation (29) predicts a fairly symmetric distribution of light speeds, centered around c/n, for positive and negative water velocities. For example, when

$$\frac{v}{c} = + 0.6 and - 0.6 ,$$

the unweighted average speed of light through water using Equation (29) is approximately 0.756 c, which is very close to the speed of light in still water, 0.750 c. However, the unweighted average speed of light using Equation (28) is approximately 0.601 c. This is peculiar, since one would expect the impact of a moving medium on differential light speed to be symmetrical with respect to the velocity of the medium's motion.

Note that when n=1, then cₘ equals γₘc. And if vₘ=0, then cₘ=c/n.

Eighteenth century scientists thought that the annual aberration of light was caused by the movement of their telescopes, due to the Earth's orbit around the Sun, while light traveled through the telescope. Experiments performed in the 19^{th} century with water-filled telescopes disproved this idea, since the refractive index of the water could have cause the angle of aberration to change, which it did not. Although the scientific community has concluded that Einstein's use of the Lorentz transformations to derive the relativistic aberration formula provides the correct answer, this is doubtful based on the problems outlined in this disclosure's section on aberration.

The alternative model can explain the results of the water-filled telescope experiments without the drawbacks of the relativistic interpretation. Assume that the distance from the light source (star) and the front end of the telescope is y1 and the length of the telescope is y2. Then the total light path in the y-direction is,

Δy=y1+y2.

Assume the light path in the x-direction is the initial x-axis displacement of the receiver from the source, Δx′, plus the x-directional distance the receiver moves while light travels from source to receiver, vΔt,

$$Δ x = Δ {x}^{′} + v Δ t , \\ where$$

$$Δ t = t 1 + \frac{y 2}{\frac{c}{n}} .$$

Here, t1 is the time that elapses while light travels from the source to the front of the telescope, and

$$y 2 / ( \frac{c}{n} )$$

is me time mat elapses while light travels through the medium having refractive index n within the telescope. The tangent of the angle from the source at the instant of emission to the receiver at the instant of reception is,

$$tan {ϕ}_{s} = \frac{Δ y}{Δ x} = \frac{y 1 + y 2}{Δ {x}^{′} + v ( t 1 + \frac{n \cdot y2}{c} )}$$

Since y1>>y2 and vt1>>n·y2/c, the impact of the refractive medium is negligible. However, to obtain an exact solution,

$$t 1 = \frac{Δ {x}^{′} + ( \frac{v}{c} ) \sqrt{{γ}_{{ϕ}_{s}}^{2} Δ {x}^{′2} + y {1}^{2} ( {γ}_{{ϕ}_{s}}^{2} - \frac{{v}^{2}}{{c}^{2}} )}}{{γ}_{{ϕ}_{s}}^{2} - \frac{{v}^{2}}{{c}^{2}}} .$$

### Impact of Refractive Media on Doppler Effect

The passage of light through refractive media will change the speed and wavelength of light, but not its frequency. The number of waves exiting a lens or atmosphere each second will equal the number of waves entering the lens or atmosphere each second. Therefore the frequency of light passing through a medium in the stationary frame, fᵣ, will be governed by Equation (19).

The general equation for wavelength in the stationary frame will be

$${λ}_{γ} ( longitudinal , Doppler ) = \frac{{c}_{m}}{{f}_{r}}$$

where cₘ is governed by Equation (29).

It is worth noting that most experiments involving the measurement of wavelength cause light to pass through a stationary lens and/or an atmosphere before measurement. When light exits a lens and passes through stationary air, which has a refractive index of approximately 1, γₘ will approximately equal 1, and its speed will be cₘ=c. Therefore, superluminal light emitted from a moving source will be slowed to speed c by passage through air. And when the source moves longitudinally, wavelength after passage through stationary air will be,

$${λ}_{r , air} = \frac{c}{{f}_{r}} = {γ}_{s} {λ}_{0} ( 1 - \frac{v}{{γ}_{{ϕ}^{C}}} ) \qquad ( 30 )$$

The v/γ_{ϕ}c ratio is determined by the speed of the moving source as a fraction of the speed of light in vacuum. The refractive medium does not change this ratio because light reaches the medium after this ratio has been established, and therefore the medium does not change light's frequency. Interestingly, the formula for stationary receiver wavelength is similar to Einstein's equation for the longitudinal Doppler effect.

$${λ}_{r} ( S R ) = {γ}_{L} {λ}_{0} ( 1 - \frac{{v}_{e}}{c} )$$

where vₑ is the longitudinal velocity in the Einstein model. As with energy, these formulas produce the same result if

$${v}_{e} = \frac{v}{{γ}_{ϕ}} = \frac{v}{{γ}_{s}}$$

for longitudinal setups.

Of note, the arithmetic mean and geometric mean of the alternative and Einstein's wavelength formulas equal (γₛλ₀ and λ₀) and (γ_{L}λ₀ and λ₀) respectively.

### Experimental Validation

Even though special relativity theory appears to have some flaws, experiments performed to date have yet to overturn it. The Ives Stilwell experiment [6] measured both a first and higher order longitudinal Doppler effect on wavelength at a longitudinal source velocity of about 0.3% c. Since light emitted by the fast moving hydrogen source (moving source, stationary receiver) passed through glass lenses and air prior to measuring wavelength, the equation for non-vacuum wavelength, Equation (30), is applicable. This means that the predictions of special relativity and of the alternative model will differ only by the difference between γ_{L} and γₛ on the higher order term

higher order difference=λ₀(γₛ−γ_{L})

Ives and Stillwell did not measure the speed of the hydrogen ions, but rather calculated it from the voltage applied and charge and mass of the ions. However, since the particles were accelerated with an electric field, it can be assumed that the speed of the ions was of a vₑ type. If so, the first order term of the alternative model formula for wavelength is,

γₛv/γ_{ϕ}c≈v/c

for approximately longitudinal measurements. This means that the first order terms predicted by the alternative model and special relativity will be the same.

The difference between γ_{L}vₑ versus vₛ on the first order term is zero,

$$first order difference = \frac{{γ}_{L} {λ}_{0} {v}_{e}}{c} - \frac{{γ}_{s} {λ}_{0} v}{{γ}_{s} c} = 0 .$$

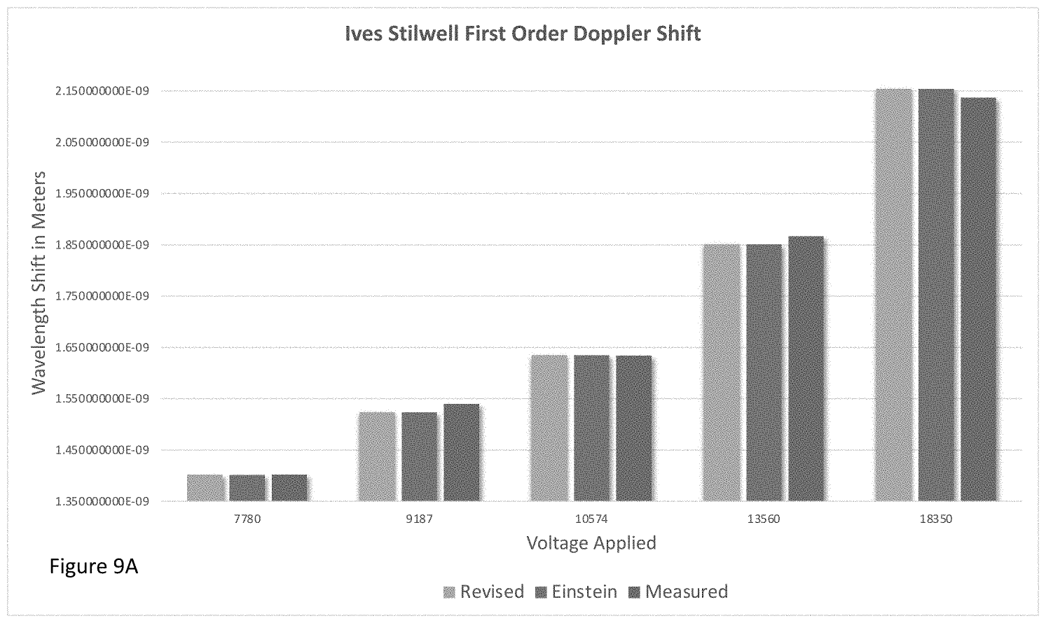

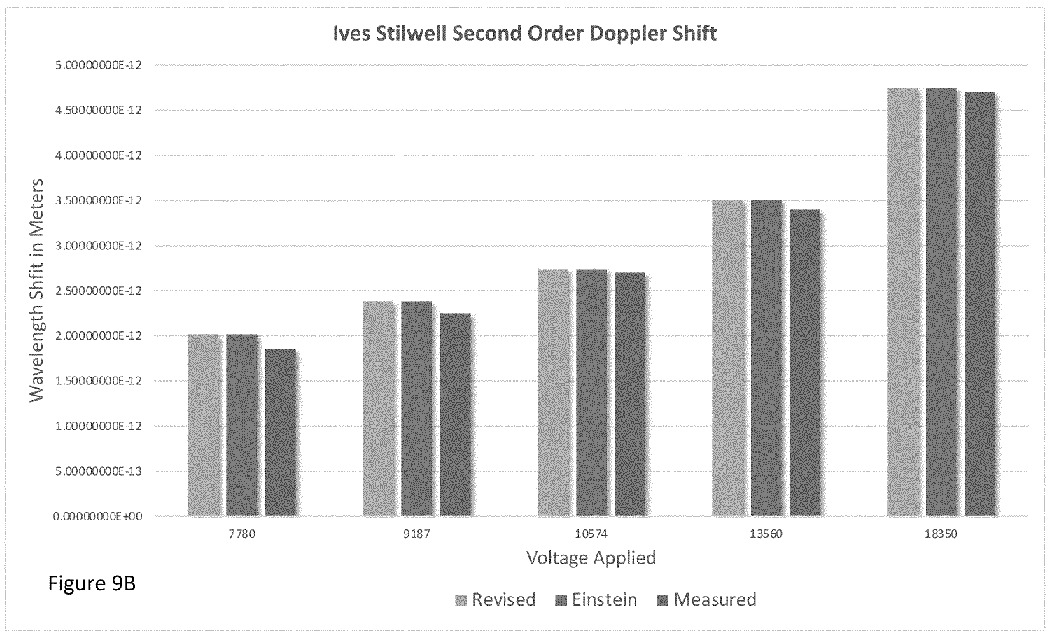

At 0.3% c, these gamma factors in the second order term differ at the 11^{th} decimal place, a difference that would have been undetectable using their instrumentation. Both models agree with the experimental data, which demonstrates Doppler shifts with standard deviations of approximately 1% for the first order shift and 3% for the higher order shift. FIGS. 9a and 9b show the first and higher order wavelength shifts computed using the alternative model, Einstein's model, and the actual measurements made by Ives and Stilwell. (Irrespective of the limitations of the Ives Stilwell experiment, the alternative model predicts different wavelengths for longitudinal versus transverse light in a vacuum coming from the same moving source. On Earth, the wavelengths would be made identical by the refractive index of air. But in the vacuum of space, the difference would also not be noticeable with today's instrumentation. The speed at which the Earth orbits the sun is approximately 0.01% of c, yielding a value of 1.000000005 for both γₛ and γ_{L}. This would create a difference in longitudinal versus transverse visible light wavelengths on the order of approximately 10⁻¹⁵ meters. This distance is 3 to 4 orders of magnitude below the current detection limits of the most sensitive spectrographs. It is estimated that our solar system travels with respect to the cosmic microwave background radiation at approximately 10 times this rate, which would still result in undetectable differences in longitudinal versus transverse wavelengths. Therefore, at the natural speeds of the bodies within our solar system, the difference between longitudinal versus transverse wavelengths would be difficult to detect.)

Since the gamma factors of special relativity and the alternative model are so similar at low speeds, an experiment involving much higher speeds is needed to differentiate them. Several sets of experiments have measured the impact of the first and higher order longitudinal Doppler effects on frequency from excited ⁷Li+ atoms traveling at up to one third of c [7,8,9].

Botermann et al [9] accelerated ⁷Li+ atoms to a kinetic energy of 58.6 MeV/u. The rest energy for these ions is,

Eᵣₑₛₜ=mc²=6.536×10³ MeV

The ratio of Eₜₒₜₐₗ divided by mc² (Eᵣₑₛₜ) is equal to γ_{L} or γₛ, depending on the model. For 58.6 MeV/u of kinetic energy, this ratio becomes,

$$\frac{{E}_{t o t a l}}{{E}_{rest}} = \frac{6 .536 \times {10}^{3} + 7 \times 58.6}{6 .536 \times {10}^{3}} = 1.062758 = {γ}_{L} = {γ}_{s}$$

Velocities can be computed corresponding to this energy ratio,

$${v}_{e} = c \sqrt{1 - \frac{1}{{γ}_{L}^{2}}} = c \sqrt{( 1 - {( \frac{{E}_{r}}{{E}_{t}} )}^{2} )} = 0.3 \; 3855 c$$

$$v = c \sqrt{{γ}_{s}^{2} - 1} = c \sqrt{{( \frac{{E}_{t}}{{E}_{r}} )}^{2}} - 1 = 0.3 \; 598 c$$

$$Therefore , \\ \frac{{v}_{s}}{{v}_{s , SR}} = \frac{v}{{v}_{e}} = 1.062758 = {γ}_{L} = {γ}_{s}$$

The experimental setup in Botermann et. al. allowed the authors to measure the maximal excitation frequencies for the moving ions, which are governed by the equations for moving receivers,

$$\frac{{f}_{r}^{′}}{{γ}_{s , r} ( 1 \pm \frac{{v}_{e}}{c} )} = {f}_{source} \qquad ( 31 )$$

They excited the ⁷Li+ ions with two laser sources, one aimed parallel to the direction of the ion beam, and one antiparallel. They determined the excitation frequencies at which each laser maximally excited the ions by detecting emitted light with photomultiplier tubes (PMTs) positioned transversely with respect to the beam. (It is important to note that the stimulating laser light originated in the lab frame, and therefore traveled at c meters per second.)

Botermann et al used the following equation to determine whether the system was obeying special relativity theory,

$$\frac{{f}_{a} {f}_{p}}{{f}_{0 , 1}^{′} {f}_{0 , 2}^{′}} = \frac{1}{{γ}_{L}^{2} ( 1 - \frac{{v}_{e}^{2}}{{c}^{2}} )} = 1$$

where fₐ and fₚ represent the observed maximal antiparallel and parallel excitation frequencies for the moving ions in waves per second, and f_{0,1}′ and f_{0,2}′ represent two different maximal excitation frequencies for stationary ⁷Li+ ions in waves per second′. (Even though the ⁷Li+ ions were moving rapidly, their core emission and absorption frequencies remain numerically the same when measured in moving frame waves per second′ as the core emission and absorption frequencies of stationary ⁷Li+ ions. In other words, fᵣ′ (waves per second′) will be numerically the same as f₀ (waves per second). But when fᵣ′ is converted to lab frame units of waves per second, f_{r,s}′=fᵣ′/γ=f₀′/γ waves per second.) Although the equation above was found to equal unity with the experimental data, it should be noted that the following equation would also equal unity.

$$\frac{{f}_{a} {f}_{p}}{{f}_{0 , 1}^{′} {f}_{0 , 2}^{′}} = \frac{1}{{γ}_{s}^{2} ( 1 - \frac{{v}^{2}}{{γ}_{s}^{2} {c}^{2}} )} = \frac{1}{{γ}_{s}^{2} ( 1 - \frac{{v}_{e}^{2}}{{c}^{2}} )} = 1$$

where for longitudinal motion, γₛ²=1+γ_{L}²vₑ²/c².

The authors reported, “The ⁷Li+ ions are generated in a Penning ion gauge (PIG) source and accelerated by the GSI accelerator facility to a final energy of 58.6 MeV/u, which corresponds to a velocity of β=0.338.” Assuming the authors measured a velocity of β=0.338, this combination of energy and velocity, irrespective of the frequency data, would suggest that γ_{L} is the appropriate gamma factor for this experimental setup, not γ_{s,s}. It should be noted, however, that the magnetic field used to accelerate the ions to their final velocity pointed in a direction transverse to the direction of ion motion, and “traveled” or “communicated” with the ions at speed c. Such a field cannot accelerate an ion to a speed greater than c, and ion speed vₑ would approach speed c asymptotically [31,32,33].

In other words, an ion traveling at v is associated with the same amount of energy as an ion that has been accelerated in a magnetic field to velocity vₑ=vₛ/γ_{L}. The use of γ_{L}vₑ in Einstein's energy-momentum relation is consistent with the use of γ_{L}vₑ in Einstein's relativistic Doppler equations, and is necessitated by the inability of electromagnetic fields to accelerate charged particles to speed c and beyond, even with ever-increasing amounts of energy. The extra energy required to bring the speed of such particles asymptotically toward c is represented in the γ_{L} term preceding vₑ, and is reflected in the emission speed of photons from particles accelerated to speed vₑ. The alternative model captures the value of γ_{L}vₑ in the single term v, covering more general conditions where accelerating forces may or may not be limited to a delayed action communicated at speed c.

Botermann et al reported that the rest frame transition wavelength for the ⁷Li+ ions is 548.5 nm, and that the rest frame transition frequency is 5.465×10¹⁴ waves per second, yielding a light speed of c meters per second. In order for the moving ⁷Li+ ions to observe a light speed of c meters per second′, the moving frame wavelengths would have to be contracted, as governed by the special relativity equation,

$${λ}_{r , SR}^{′} = \frac{{λ}_{0}}{{γ}_{L , r} ( 1 + \frac{{v}_{r}}{c} )} = {λ}_{0} \frac{\sqrt{1 - \frac{{v}_{r}}{c}}}{\sqrt{1 + \frac{{v}_{r}}{c}}}$$

Therefore, the wavelength observed by the moving ⁷Li+ ion receivers, λ_{r,SR}′, must be length contracted by γ_{L,r} in order for the receivers to observe a light speed of c meters per second′. This means that the length of the section of the Experimental Storage Ring (ESR) (The ESR has a circumference of approximately 108 meters) in Darmstadt lying between the parallel and antiparallel lasers would have to physically contract by approximately 6% for each and every excitation and emission in order for the special relativity model to be valid. Each excited particle would demand its own length contraction event. If many particles are being excited at the same time, multiple overlapping contractions of the ESR, involving different contracted distances for each particle-laser interaction, in both directions, must occur simultaneously. Since the lasers are attached to the storage ring, the storage ring itself must contract, not merely the space within the ring. This fantastic requirement does not call into question the validity of the results presented by Botermann et al, but it brings serious doubt to the validity of the constancy of the speed of light postulate of the special theory of relativity, and the concept of length contraction.

It is known that objects within the universe are moving at speeds that exceed c. Astronomers compute z-parameters according to the standard formula, where here a positive value for v means that the source is moving away from the receiver,

$$z ( Einstein ) = \frac{{λ}_{r}}{{λ}_{0}} - 1 = γ ( 1 + \frac{v}{c} ) - 1 = \frac{\sqrt{1 + \frac{v}{c}}}{\sqrt{1 - \frac{v}{c}}} - 1$$

It is assumed that λ₀ is the emission wavelength of a source at rest, and λᵣ is the observed wavelength. The z-parameter is used to measure “red shifts” and “blue shifts” of light from receding and approaching celestial bodies, respectively. The z-parameter is intended to gauge the degree to which a star's observed wavelength deviates from the presumed original resting emission wavelength, which is governed by the atoms or molecules emitting light.

Astronomers compute a star's/galaxy's velocity from the z-parameter using,

$$v / c ( Einstein ) = \frac{{( z + 1 )}^{2} - 1}{{( z + 1 )}^{2} + 1}$$

Consistent with Einstein's postulate regarding the speed of light, v/c does not exceed 1 regardless of how large z is observed to be.

One formula for the z parameter for the alternative model is,

$$z ( alternative , vacuum ) = \frac{{λ}_{r}}{{λ}_{0}} - 1 = {γ}_{s} ( {γ}_{s} + \frac{v}{c} ) - 1$$

This formula holds for a stationary source transmitting light to a moving receiver, regardless of whether light passes through a refractive medium first; and also for a stationary receiver and moving source, provided that light never passes through a refractive medium

A star's velocity can be computed from this alternative z-parameter using,

v/c(alternative,vacuum)=z/\sqrt{2z+1}

However, if the light from moving sources first passes through a stationary lens, and/or Earth's atmosphere, or other refractive media, then its speed will be slowed to c, and its wavelength will be governed by

$$λ ( alternative , media ) = {λ}_{0} ( {γ}_{s} + \frac{v}{c} )$$

For such wavelengths, the z parameter will be

$$z ( alternative , media ) = ( {γ}_{s} + \frac{v}{c} ) - 1$$

A source's velocity can be computed from such a z-parameter using,

$$v / c ( alternative , media ) = \frac{{( z + 1 )}^{2} - 1}{2 ( z + 1 )} \qquad ( 32 )$$

Table 2 lists some sample z values with corresponding v/c values for special relativity and the alternative model for light from a source moving longitudinally with respect to the Earth, and that has passed through a refracting medium prior to measuring wavelength (which is the most likely scenario for astronomical measurements).

TABLE 2
z-values, and computed v/c values for light that has
traveled through a refracting medium.

| Value of z | v/c Alternative | v/c Einstein |
|---|---|---|
| 0.001 | 0.0009995 | 0.0009995 |
| 0.01 | 0.0099505 | 0.0099500 |
| 0.1 | 0.0954545 | 0.0950226 |
| 0.5 | 0.4166667 | 0.3846154 |
| 1.0 | 0.7500000 | 0.6000000 |
| 1.25 | 0.9027778 | 0.6701031 |
| 1.5 | 1.0500000 | 0.7241379 |
| 2 | 1.3333333 | 0.8000000 |
| 5 | 2.9166667 | 0.9459459 |
| 10 | 5.4545455 | 0.9836066 |

In the alternative model, v/c can exceed 1. The largest z-value measured to date is approximately 11, which would translate to a recession velocity of about 5.96 times c, and a longitudinal light speed of about 6.04 c. The alternative model therefore provides an alternative to the hypothetical “expansion of spacetime”, and instead allows matter and energy to have superluminal recession speeds through stationary space without invoking expansion of space or spacetime. The alternative model also increases the theoretical radius of the “observable universe”, since γₛc will always exceed v.

If v/c>c for an approaching emitter, the emitter will be traveling near the speed of the longitudinal light that it emits. If an emitter originates far away from a receiver, the light coming from the emitter may not have reached the receiver. Although the majority of visible stars and galaxies appear to be receding, it is possible that another set of stars and galaxies are approaching Earth at speeds exceeding c. For example, if a source travels at 5c, the longitudinal light that it emits will travel approximately 2% faster than the source itself. Light coming from a distant source of this type might not have had time to reach the Earth and, as such, may not yet be visible. But the mass of the source will be present in the universe, which would influence gravitational forces. Moreover, the light emitted from sources moving transversely will travel at speed c. It will take much longer for such light to reach the Earth, and therefore such objects may not be visible from the Earth, yet their gravitational contribution will be real

The superluminal speeds attainable with the alternative model help to explain a visible universe that is larger, in light years, than the presumed age of the universe. And if gravitational forces emitted from sources moving longitudinally with respect to an object upon which the source interacts travel at γₛc, there are implications for the Lambda-CDM model for cosmology.

### Michelson Morley and Kennedy Thorndike

The Michelson Morley and Kennedy Thorndike experiments involved passing light through beam splitting glass, and then air, prior to measuring potential differences in travel time. As shown in Equation (29) for light passing through refracting media (glass, air), the speed of light will be determined in part by the γₘ term, which is dependent on the velocity of the media with respect to the stationary frame. Both experiments attempted to detect the impact of differences in the velocity of the Earth on travel time. According to Equation (29) light will travel through air at approximately γₘc when moving in the direction of Earth's velocity, as seen by a stationary observer in space, and at c when moving in a direction in which the velocity of the medium is zero in the direction of light travel. If the angle of travel lies in between these directions, it will travel at an intermediate speed. However, the round-trip time of travel will remain the same for all angles. Therefore experiments designed to detect differences in travel time will yield null results, since travel distances are similarly proportional to longitudinal versus transverse speeds; and speeds measured in the moving (laboratory) frame will be c in all directions (It is interesting to note that the solution to the Michelson Morley experiment, cₓ=γₛc, is analogous to the relationship between vₛ and vₑ:vₛ=γₛvₑ. If time were to slow by a factor of γₛ in the longitudinal direction, both c and vₑ would increase by a factor of γₛ.).

### Maxwell's Equations

The relationship between the speed of light and electromagnetic permittivity and permeability can be written as,

$$c = 1 / \sqrt{{μ}_{o} {ϵ}_{o}}$$

Since, under the alternative model, light that originates with an IRF is observed to travel at speed c within the IRF, Maxwell's electromagnetic equations remain the same within any IRF, regardless of its speed. An observer outside of a moving IRF will see light move faster in the longitudinal direction in vacuum, and therefore,

$${c}_{x} = {γ}_{s} / \sqrt{{μ}_{o} {ϵ}_{o}}$$

and at speed c when directed purely transverse to the direction of IRF motion,

$${c}_{transverse} = 1 / \sqrt{{μ}_{o} {ϵ}_{o}}$$

Since, to date, all measurements of permittivity and permeability have been made within an IRF (e.g. a laboratory), or first passed through a refractive medium if originated from outside of the IRF, the relationship c=1\sqrt{μₒεₒ} holds. If permittivity and permeability were to be measured from a different reference frame, then the results would depend on the velocity of the moving reference frame, the absence of refractive media in the path within the measuring IRF, and the relative direction of the electromagnetic radiation with respect to the IRF of origin.

### Absolute Versus Relative Frames

Special relativity's first postulate is that the laws of physics are the same in all IRFs, and an observer in an IRF should not be able to determine the velocity of the IRF. If this is true, a moving receiver should detect the same signal from a stationary source as a stationary receiver from a moving source. The argument is that neither receiver nor source knows their own velocity, and therefore cannot determine if their IRF is moving away or toward the other IRF, and vice versa.

However, Champeney, et al [21] demonstrated that stationary receivers detect a higher order red shift from moving sources, and moving receivers detect a higher order blue shift from stationary sources. In each case, one member was moving faster than the other relative to the lab frame. If, from the perspective of either member of the pair, the other member were moving, then each should have experienced a frequency shift in the same direction. But that is not what happened. There was a clear polarity to the effect consistent with a fundamental change in the emission frequency proportional to the emitter's velocity relative to the lab frame. This is strongly suggestive of a preferred frame.

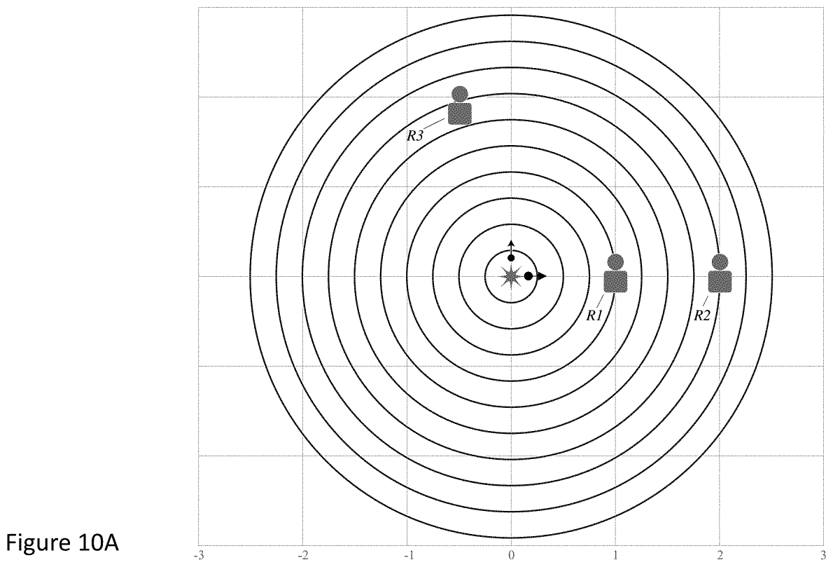

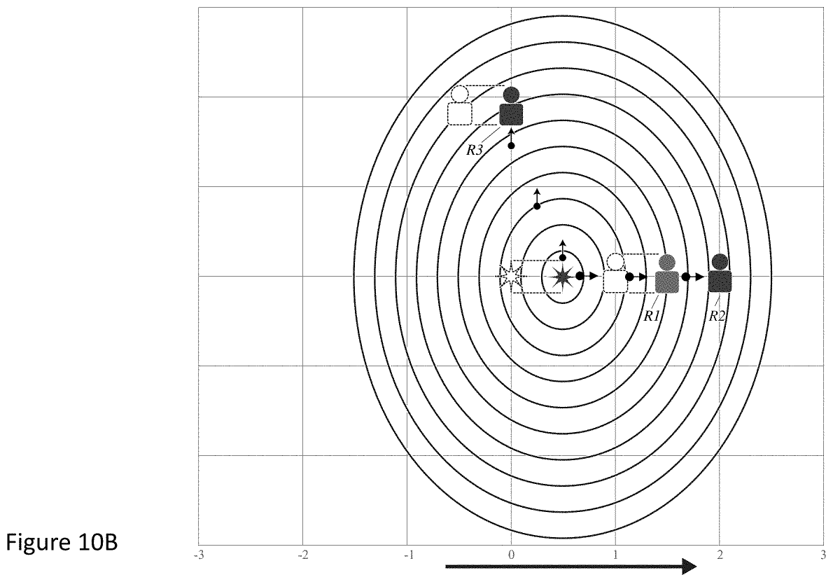

The dimensional asymmetry of the proposed length contraction phenomenon, and its consequential differential impact on the higher order Doppler shift, creates a compelling argument that the laws of physics are not the same in all IRFs. FIG. 10 shows a hypothetical example with a light source and three different receivers, R1, R2, and R3. The source and receivers R1 and R3 are moving along with an IRF that is traveling at speed v; whereas receiver R2 is not moving with the IRF (In order to illustrate the perception of the higher order Doppler shift, the effect of the first order Doppler shift was not included in the diagram.). Receiver R3 is shown to be trailing the source by vdt meters in the x-direction, where dt is the time required for light to travel 90 degrees from the x-axis to the vertical position of R3, the angle being measured from the stationary frame. In this setup, light emitted at a 90 degree angle from the source should strike R3 as R3 moves to a position parallel to the x-axis where the source was located at the moment the source emitted each photon that strikes R3. This eliminates the first order Doppler effect on R3 and also causes R3 to perceive the light to be arriving at a right angle, so receiver R3 should not expect a primary Doppler effect. R3 should observe a steady stream of longer wavelength light being emitted from the source. FIG. 10A represents the relative positions of the elements before showing the effects of length contraction. FIG. 10B shows the elements along with their higher order frequency characteristics, and the effects of length contraction on wavelength. The IRF is shown to have traveled in the x-direction to illustrate which elements are within the moving IRF. Receiver R2 does not change position in the stationary frame between FIGS. 10A and 10B. According to special relativity, receiver R1 should not detect a higher order Doppler wavelength shift, as a consequence of length contraction. Receiver R1 also should not detect a change in source emission frequency since receiver R1's clock has slowed to the same clock rate as the source's. But, as seen in the Ives Stilwell experiment, receiver R2 does detect a higher order Doppler wavelength shift (after averaging the parallel and antiparallel combined wavelength shifts), which presents an inconsistency since receiver R2 detects the same waves from the same source as receiver R1. (Receiver R2 could have been located between the source and receiver R1 with the same result, so there is no validity to an argument that the distances between waves might re-expand beyond the bounds of receiver R1.) But since the wavelengths emitted by the source cannot be different for receivers R1 and R2, either lengths contract, in which case receivers R1 and R2 should both detect no red shift, or lengths do not contract, in which case both receivers should detect a wavelength red shift. Additionally, receiver R3 is moving along with the moving IRF and should detect the higher order Doppler shift (subject to change with different IRF velocities), since special relativity does not claim length contraction in a direction orthogonal to the direction of motion. Thus receivers R1 and R3 will experience different wavelengths coming from the source, the magnitude of the difference being dependent on IRF velocity. Worse yet, receiver R3's clock will beat at the same rate as the source's clock, due to the effect of velocity on time dilation; so receiver R3 will detect the same frequency as the source's emissions, measured in waves per second′, yet receiver R3 will detect longer wavelengths. And since light speed is equal to frequency multiplied by wavelength, receiver R3 will measure light to be traveling faster than c. These inconsistencies challenge the validity of both postulates of special relativity, and thus the basis for conjecturing that there is no absolute frame of reference.

Special relativity does not differentiate between its versions of Equations (9) and (10) by offering the aberration of light as an explanation for numerically different outputs. It uses c for light speed in Equation (9), which makes Equations (10) and (9) identical when vₛ=v and vᵣ=0 compared to when vᵣ=v and vₛ=0. Special relativity ignores the fact that the dimensional units for Equation (9) are waves per second′, whereas the dimensional units for Equation (10) are waves per second. Although red flags are raised when one observer measures light speed at c meters per second, while another observer measures the speed of the same light to be c meters per second′, at least these measurements come from different observers in different frames of reference where length contraction in all directions (which would also violate the special relativity model) could reconcile the measurements. However, when special relativity theory claims that the same observer at the same location and time will measure the frequency of light to be same whether denominated in waves per second or waves per second′, where the setups differ by deeming the receiver to be moving or stationary, there is a problem.

The Lorentz transformations attempt to provide for a pseudo-symmetry between the two perspectives of two different IRFs; but this requires some creative mathematics. The treatment of Δx′ in the Δx transformation leaves out a factor of gamma that would otherwise have been required, absent length contraction. This elimination of a gamma factor is necessary to claim the symmetry between IRF perspectives, since the Δx′ transformation must have its own gamma factor in order to appear to treat distances symmetrically. In essence, the Lorentz transformations achieve the natural gamma squared transformation of travel-length in two, partial steps rather than one full step, the gap being bridged by length contraction.

The alternative transformations achieve the γₛ² scaling in one step, which is what occurs without length contraction. The consequence is that, in the alternative model, the transformations for Δx and Δx′ do not treat travel lengths symmetrically. From one perspective, light travels the proper length. From the other perspective, light travels γₛ² further than the proper length, plus an amount consistent with the clock offset (2). A reversal of perspectives does not allow for subsequent increases of distance by another factor of γₛ². The implication is that the alternative model presumes an absolute or preferred frame of reference, where all IRF velocities are relative to it. Observers in different IRFs will still perceive relative motion between IRFs, but the laws of physics will depend on velocity with respect to an absolute frame, rather than merely to relative frames.

Given that the alternative model does not demand symmetrical perspectives between IRFs, the alternative Δt′ transformation can be restated. Above, the alternative Δt′ transformation was written using a similar logic for the Lorentz Δt′ transformation to maintain some consistency prior to introducing an absolute frame of reference.

Δt′=γₛΔt−γₛvΔx/cₓ²

where γₛ represents the inverted seconds′ per second conversion. Now that symmetry is not required and an inversion is not needed, the alternative Δt′ transformation can be rewritten according to an absolute frame of reference. The four alternative transformations then become,

### Alternative Transformations (Final)

Δx=γₛ²Δx′+γₛvΔt′

Δt=γₛΔt′+vΔx′/c²

Δx′=Δx−vΔt

Δt′=Δt/γₛ−v(Δx−vΔt)/γₛc²

In all four alternative transformations, γₛ represents either a dimensionless meters/meter when applied to distances, or seconds/second′ when applied to time. The third and fourth alternative transformations are merely the reversal of the first two, and do not attempt to portray a symmetrical swapping of perspectives.

To help understand its meaning, the second term of the alternative Δt′ transformation can be rewritten as,

$$\frac{v ( Δ x - v Δ t )}{{γ}_{s} {c}^{2}} = \frac{{γ}_{s}^{2} v Δ {x}^{′}}{{γ}_{s} {γ}_{s}^{2} {c}^{2}} = \frac{v Δ {x}^{′}}{{γ}_{s} {c}^{2}}$$

where v is the speed of the moving IRF. The second terms of the Δt and Δt′ transformations relate to clock synchronization in moving IRFs. In the Δt transformation, the second term is equal to the offset between a clock adjacent to the “rear” mirror and a clock adjacent to the “forward” mirror in FIGS. 2A and 2B (2). The amount of offset as observed from the stationary frame is the velocity times the proper length divided by the speed of the means of synchronization squared (light at speed c or γₛc).

(In the alternative model, clocks arranged along the axis of IRF motion are typically synchronized with an electromagnetic signal traveling at γₛc. The signal must traverse a proper distance of Δx′ meters while the IRF is moving at speed v, which increases the round-trip distance between the source clock and the receiver clock by a factor of γₛ². This is the average distance in the stationary frame that separates two events that observers in the moving frame believe occur simultaneously. According to the alternative Δt transformation, the time difference between such events in the stationary frame is vyₛ²Δx′/γₛ²c²=vΔx′/c², which is the actual time offset between the two clocks, measured in seconds. This time difference can be thought of as the extra time required for the synchronization signal to travel the extra distance that the IRF moves in γₛ²Δx′/γₛc seconds. v/γₛc is a ratio equal to the distance that the IRF travels divided by the distance the synchronization signal travels in any given amount of time. When this ratio is applied to the γₛ²Δx′/γₛc seconds of synchronization time, the result is vΔx′/c² seconds.

The vΔx′/c² term can be written as γₛvΔt′/γₛc=Δt′v/c, where Δt′=Δx′/c. When looking at massive elements, like particles instead of light, the Δdt′ term can be replaced with Δx′/vₚ′, which is the time required for particles to travel the distance Δx′ in the moving frame. If the particles move at longitudinal speed γₛvₚ′ in the stationary frame, then when γₛ²Δx′/γₛvₚ′ is multiplied by the ratio v/γₛvₚ′, the result is the extra time required for a massive particle to travel the average distance the IRF moves during a particle's round trip. The resulting extra time is Δx′v/v′ₚ².)

### Potential Experiments

An experiment that could differentiate between Einstein's theory of special relativity and the alternative model would have significant implications with respect to the speed of light, the ability to travel faster than c, the reality or non-reality of length contraction, the relationship between subatomic particle energy and speed, the relationship between light frequency and energy, and the size and evolution of the universe.

The differences between γₛ and γ_{L} are extremely small at speeds attainable with satellites and other large scale tools, so direct measurement of the difference between longitudinal and transverse light speed will be challenging. Table 3 lists some values of γₛ and γ_{L} for various values of v/c.

TABLE 3
Comparison of γₛ to γ for various values of v/c.

| Value | | | |
|---|---|---|---|
| of v/c | Description | γₛ | γ_{L} |
| 0.000013 | GPS Satellite | 1.00000000008414 | 1.00000000008414 |
| 0.000100 | Earth Orbits Sun | 1.00000000500693 | 1.00000000500693 |
| 0.000167 | Mercury Orbits Sun | 1.00000001390813 | 1.00000001390813 |
| 0.000767 | Sun Through Galaxy | 1.00000029429590 | 1.00000029429607 |

The second terms of the alternative Δt and Δt′ transformations (the clock offset terms) are equal to the speed of the IRF times the proper length between clocks, divided by c² for Δt or divided by γₛc² for Δt′. The second term of the Δt transformation computes the time difference between the synchronized clocks, denominated in seconds as observed from the stationary perspective. In the moving frame, the second term of the Δt′ transformation is the same, except for a factor of γₛ in the denominator, which converts the numerical value of the clock offset time from seconds to seconds′. In other words, synchronized clocks differ in time by vΔx′/c² stationary frame seconds, but if a moving observer could actually measure the amount by which the readings on the clocks differ, the observer would measure a difference of vΔx′/γₛc² seconds' on the slower-tempo, time-dilated clocks. If the Lorentz Δt transformations are written in a format similar to the format of the final alternative transformations,

$$Δ t = {γ}_{L} Δ {t}^{′} + {γ}_{L} v Δ {x}^{′} / {c}^{2}$$

$$Δ {t}^{′} = \frac{Δ t}{{γ}_{L}} - v Δ {x}^{′} / {c}^{2}$$

the Lorentz clock offset terms are a factor of gamma-fold greater than for the alternative model. The clock offset terms are related to the Sagnac effect, which has been measured for Earth's rotation to be approximately 207 nanoseconds for a full equatorial trip [34]. The alternative Δt transformation would predict such a value to be equal to vΔx′/c², in seconds, and the Lorentz Δt transformation would predict the value to be equal to γ_{L}vΔx′/c² seconds.

If light is transmitted from a moving emitter to a moving receiver, the time for light to travel in the forward direction should be, in stationary frame seconds in the alternative model,

Δt_{f}=γₛΔt′+vΔx′/c²

and in the Lorentz/Einstein model,

$$Δ {t}_{f , SR} = {γ}_{L} Δ {t}^{′} + {γ}_{L} v Δ {x}^{′} / {c}^{2}$$

The return times in the alternative model would be,

$$Δ {t}_{r} = {γ}_{s} Δ {t}^{′} - v Δ {x}^{′} / {c}^{2}$$

and in the Lorentz/Einstein model,

$$Δ {t}_{r . SR} = {γ}_{L} Δ {t}^{′} - {γ}_{L} v Δ {x}^{′} / {c}^{2}$$

The sums of the forward and return times would be,

Δt_{f}+Δtᵣ=2γₛΔt′

and

Δt_{f,SR}+Δt_{r,SR}=2γ_{L}Δt′

The differences between the times would be

Δt_{f}−Δtᵣ=2vΔx′/c²

and

Δt_{f,SR}−Δt_{r,SR}=2γ_{L}vΔx′/c²

The ratio of the differences divided by the sums for the alternative model would be,

$$\frac{Δ {t}_{f} - Δ {t}_{r}}{Δ {t}_{f} + Δ {t}_{r}} = \frac{v}{{γ}_{s} c}$$

and in the Lorentz/Einstein model,

$$\frac{Δ {t}_{f , SR} - Δ {t}_{r , SR}}{Δ {t}_{f , SR} + Δ {t}_{r , SR}} = \frac{v}{c}$$

If the velocity of the emitter and receiver are known with precision, these ratios might determine which model more closely fits the data.

Another test of the alternative model could involve measuring the frequency and wavelength of light coming from stars and galaxies receding or approaching longitudinally, provided that the effects of refractive media can be eliminated. When cos ϕ=1 for longitudinal light, multiplication of frequency times wavelength produces a light speed of γₛc. In other words, if both the frequency and wavelength of light traveling from stars approaching or receding from the Earth longitudinally could be measured in vacuum, without first passing through an atmosphere, then the product of these measurements should exceed c. It is not clear what will happen if the light is first passed through a medium such as refractive glass that is stationary with respect to the laboratory. If the light exiting the glass re-enters a vacuum, it could resume travel at Δ_{s,s}c; but it is possible that it will resume travel at c from the perspective of the “laboratory”. In the latter case, wavelength would be altered and the product of frequency times altered wavelength would be c.

Kinetic energy in the alternative model is (γₛ−1)mc². If the kinetic energy of a rapidly-moving object could be measured, it may be possible to differentiate between (γₛ−1)mc² and (γ_{L}−1)mc². However, it is important that the object not be accelerated using a force that is limited to action at speed c, since this will change the relationship between applied energy and object velocity.

If two objects that move toward or away from each other at the same speed relative to the Earth send signals to each other, then the frequency received by each object should be governed by

$${f}_{r}^{′} = {f}_{s}^{′} \frac{1 + \frac{{v}_{r}}{{γ}_{s , s} c}}{1 - \frac{{v}_{s}}{{γ}_{s , s} c}}$$

Note that γ_{s,s} is computed using source speed in both instances. Therefore this ratio should be different than

$${f}_{r , SR}^{′} = {f}_{s , SR}^{′} \frac{1 + \frac{{v}_{r}}{c}}{1 - \frac{{v}_{s}}{c}}$$

which is what would be predicted by special relativity. Creation of an interference pattern between source and receiver signals might allow the detection of these differences.

Unfortunately, particle accelerators that use electromagnetic radiation as the accelerating force are not likely to reveal the difference between the models due to the properties of electromagnetic radiation. Even if the accelerating force were applied longitudinally rather than transversely, the force would still operate at speed c in the stationary, laboratory frame and would show the same limitations.

A mechanical force, such as a centrifugal force used in the Mossbauer experiments (21) might reveal the difference between γₛ and γ_{L}. However the detector would need to detect photons emitted at right angles to the radius of the centrifugal device (traveling longitudinal to the direction of motion at the instant of emission). A strobe-type emission at the instants that the source and receiver are positioned at a right angle with respect to the radius would allow the detection of higher-order frequency differences, taking the arithmetic mean of the frequencies when the rotor is spun in either direction.

A Fizeau experiment would require a medium to travel nearly 0.1% of c to produce a differential shift of one tenth of a fringe unit between the special relativity model and the alternative model.

The first term of the alternative Δx transformation contains a γₛ²Δx′ term instead of a γ_{L}Δx′ term. The difference between γₛ²−Δ_{L} will grow faster than either γₛ or γ_{L} as IRF speed increases. If one measures the distance that an intra-IRF light signal travels longitudinally, measured both from within the IRF and from a stationary frame, the measurements could differentiate the models. Special relativity would dictate that the light as observed from the stationary frame traveled a contracted distance. Whereas the alternative model would predict a γₛ² fold increase in distance (plus the γₛvΔt′ term).

Another potential experiment would involve the aberration of light. Annual aberration is related to the speed at which the Earth orbits the Sun. But space telescopes that orbit the Earth also experience light aberration in relation to Earth's speed and their speed relative to the Earth. Special relativity predicts that the angle of aberration, alpha, will be,

$$α ( SR ) = {ϕ}_{r}^{′} - {ϕ}_{s} = {ϕ}_{r}^{′} - arctan ( \frac{sin {ϕ}_{r}^{′}}{γ ( cos {ϕ}_{r}^{′} - \frac{v}{c} )} )$$

So if the angle ϕᵣ′ is known, then alpha can be computed.

A method to compute alpha in the alternative model, with knowledge only of v, c, and ϕᵣ′ and without knowledge of the distance between a source and receiver, is a bit more complicated. The angle ϕₛ can be iteratively back-calculated from the following expression.

$$tan {ϕ}_{r}^{′} = \frac{sin {ϕ}_{s}}{cos {ϕ}_{s} - \frac{{v}_{r}}{{γ}_{ϕ} c}}$$

Alpha can then be calculated using the known value of ϕᵣ′ and the calculated value of ϕₛ,

α=ϕᵣ′−ϕₛ

The calculated values of alpha will be the same for sources with a 90 degree angle of declination (Δx′=0). But when the angle of declination is 45 degrees, the special relativity and alternative model formulas predict different values for alpha. Unfortunately modern day telescopes, even the Hubble telescope, do not have the angular resolving power to differentiate the two models. But perhaps a telescope in the future, one that has about 10 times the angular resolving power of the Hubble telescope might be able to differentiate the two models.

### Discussion

The constancy of the speed of light has been one of the bedrocks of modern physics. All known measurements of light speed are consistent with this concept. The alternative model concurs that the speed of light as measured within an IRF is a constant, c, in all directions. The alternative model also predicts that light will move at c in a direction orthogonal to IRF movement, as seen from another IRF. The possibility that light could move at a different speed when directed other than in an orthogonal direction has been given little consideration, other than Ritz's emission hypothesis put forth in 1908 [35]. The emission hypothesis has been shown to be inconsistent with experimental results, due to the fact that it utilizes a classical summation of velocities.

If it is assumed that the emission of light at the atomic level involves a phenomenon that is isotropic in all dimensions in the source's frame, then these constraints should require emissions to move at velocities proportional to the incremental distances as observed from a different frame. The alternative model hypothesizes that a source of light imparts a velocity to the emitted light in proportion to the distance a harmonic element within the source must travel in a given amount of time and in a given direction, thus causing longitudinal light to be propelled γₛ fold faster than the velocity of orthogonally transmitted light. The emission speeds would not change simply due to the motion of the observer, since the effect would be absolute with respect to a preferred frame. The motion of the observer would merely change the relative speed that light travels between source and observer.

Length contraction is problematic. In addition to the logical inconsistencies associated with the treatment of the same transverse light traveling at c meters per second and c meters per second′, one must consider the impracticality of causing materials having different compressibility to contract without provision made for the different energies required, the impracticality of causing materials to contract over distances spanning billions of light years, and the impracticality of requiring materials that are contained within overlapping IRFs and moving at different velocities to contract differentially in different dimensions. Unfortunately, the impetus to propose length contraction arose not from direct observation of length contraction itself, but from the inability or unwillingness of 19^{th} century physicists to explain the Michelson Morley experiment in a way that deviated from the belief that light must travel in circular waves through some type of homogeneous medium. It is unclear why Einstein, who initially shed the idea of a speed-defining medium, still held to the notion that light must travel at the same speed in all directions. But he did. He adopted the Lorentz transformations into special relativity, and that dictated the formula for the gamma factor used in special relativity, despite the singularity and associated problems that come with it.

Length contraction creates “paradoxes”. The “pole in the barn” paradox involves a long pole that cannot fit between two barn doors unless the pole is moving so fast that a presumed length contraction causes it to be smaller than the distance between the doors [15]. Again, there seems to be a departure from material science in the proposed solution to this paradox, calling upon an almost supernatural intervention. In the words of Minkowski, “ . . . for the contraction is not to be looked upon as a consequence of resistances in the ether, or anything of that kind, but simply as a gift from above . . . ” [36], Bell's spaceship paradox [37], and Ehrenfest's spinning disk paradox [38] present similar challenges to length contraction.

The alternative model shares none of these length related challenges. Poles do not need to squeeze into barns, trains do not need to shrink, and spacetime does not need to stretch. The alternative transformations concur with the realities of observation without invoking gifts from above.

The Lorentz transformation Δt=γ_{L}Δt′+γ_{L}vΔx′/c² utilizes the factor γ_{L} in its second term. The second term represents the extra time required for light to travel the distance that the front clock moves from its original position while light travels between the clocks. Using the Lorentz/Einstein model, but without length contraction, this extra distance would be γ²Δx′v/c; and the extra time required for light to travel that extra distance would be γ²Δx′v/c². But since this result does not reconcile with the Michelson Morley result when longitudinal light travels at speed c, LFE invented length contraction to reduce the extra distance to γΔx′v/c and the extra time to γΔx′v/c². The γΔx′v/c² term yields a different time value than the Δx′v/c² clock offset term, because the latter is denominated in seconds' in the Einstein model, and the former in seconds.

The alternative model Δx=γₛ²Δx′+γₛvΔt′ transformation computes the expected γₛ² increase in longitudinal distance traveled, as seen from the stationary perspective; and computes an additional velocity-dependent increase in distance as a function of time, as reported in γₛdt′ seconds, as adjusted for time dilation.

The Δt=γₛΔt′+vΔx′/c² alternative transformation reports the expected, same-location γₛΔt′ passage of time as denominated in stationary seconds, plus the vΔx′/c² clock synchronization term, as denominated in stationary seconds. No gamma term appears in the second term because the speed of the means being used for synchronization (longitudinal light) travels at γₛc instead of c.

The Δx′=Δx−vΔt alternative transformation makes no pretense of being symmetric with respect to reference frames. It is simply a reversal of the Δx transformation. The −vΔt term subtracts the extra distance that light travels beyond Δx′ as seen from the preferred frame. It is comprised of γₛvΔt′, which is the extra distance that light travels as seen from the stationary perspective if events occur at the same location dt′ seconds′ apart in the moving IRF (Δx′=0); plus the v²Δx′/c² term, which is the extra distance the IRF travels due to the clock offset.

The Δt′=Δt/γₛ−v(Δx−vΔt)/γₛc² transformation is simply a reversal of the Δt transformation. The Δt/γₛ term converts the seconds that have passed into seconds′. The v(Δx−vΔt)/γₛc² term, abbreviated as vΔx′/γₛc², converts the clock offset time into time-dilated seconds′, and subtracts them. Again, there is no pretense of symmetry between the Δt′ and Δt transformations.

Time dilation is an important part of the alternative model. The passage of time is generally measured by oscillating motion, and if such motion is extended over a longer path length without increasing the speed of the oscillating element, then the duration of each oscillation will increase. While time dilation's origins are not fully understood at the atomic level, oscillation frequencies will slow in response to IRF motion without the addition of energy, as observed from a stationary frame. If the center of motion of an oscillating element is to remain stationary within a moving IRF, the oscillation path length will need to be longer, as seen from a stationary frame. When the oscillations in the moving frame move orthogonal to the axis of IRF motion, the stationary frame path length will be γₛ fold longer than the path length in the moving frame. And when the oscillations in the moving frame move parallel to the axis of IRF motion, the stationary frame path length will be γₛ² fold longer. The generic value of γₛ will be dependent on the velocity of the moving IRF as seen from the stationary frame, squared, divided by the stationary frame speed of the oscillating element in the direction of IRF motion, squared,

$${γ}_{s} = \frac{1}{\sqrt{1 - \frac{{v}^{2}}{{c}_{x}^{2}}}}$$

where cₓ is the stationary frame speed of the oscillating element in the direction of IRF motion.

In order for oscillations to remain synchronized in all dimensions, the speed of the oscillating “element(s)”, as seen from the stationary frame, will need to be faster in the longitudinal dimension than in the orthogonal dimensions. This may require the addition of more energy to the system when accelerating the object containing the oscillating element.

Overall, the alternative model fits observational data as well, and sometime better than special relativity. The alternative longitudinal velocity addition formula tracks the original Fizeau equation for light speed traveling through moving refractive media more closely than the addition formula from special relativity. It also predicts “upstream” and “downstream” average speed to be approximately the speed at which light moves through stationary media; whereas the special relativity formula predicts a skewed average speed. The logical basis for such skewing is elusive. The special relativity formula also predicts that light will travel backwards when directed antiparallel to a fast moving, refractive medium; and that its backwards velocity will increase incrementally faster than incremental increases in the speed of the medium. The rationale for this is also elusive.

The alternative model is consistent with stars and galaxies traveling faster than c, which helps to explain how a universe that is approximately 90 billion light years in diameter could have formed less than 14 billion years ago. In the ΛCDM concordance model, objects with redshift greater than z˜1.46 are presumed to be receding faster than the speed of light [39]. It may not be a coincidence that Equation (32) predicts a recession velocity of approximately the speed of light when z is equal to 1.46.

The fact that γₛ is intrinsic to the energy-momentum and the mass-energy equations is remarkable. And given the parallels between γ in Einstein's modified energy-momentum relation, mass-energy equation, and Lorentz's distance and time transformations, versus the parallels between the unmodified energy-momentum relation, the unmodified mass-energy equation, and the alternative model's unmodified distance and time transformations, there is more than ample motivation to justify experiments that will differentiate the models.

If the alternative model is found to be a more accurate description of reality, then the transmission of information and matter at superluminal speeds, and non-locality, are no longer prohibited. The alternative model opens the possibility that photons might have mass, that the relationship between energy and velocity does not suffer from a singularity, and that our understanding of the geometry, evolution, and dynamics of the universe can take on a new direction.

### REFERENCES

¹ Einstein, A. On the electrodynamics of moving bodies. Annalen der Physik, 1905, Vol. 17. 891.
² Morin, D. Special Relativity. 2017. ISBN-10: 1542323517.
³ Lorentz, H. A. Electromagnetic phenomena in a system moving with any velocity smaller than that of light. Proc. Acad. Sci. (Amsterdam), 1904, Vol. 6. 809.
⁴ Michelson, A. A. & Morley, E. W. The relative motion of the Earth and the luminiferous aether. Am. J. Sci., 1887, Vol. 34. 333-345.
⁵ Fitzgerald. The Ether and the Earth's Atmosphere. 328, s.l.: Science, 1889, Vol. 13. 390.
⁶ Ives, H. E. & Stilwell, G. R. An Experimental Study of the Rate of a Moving Atomic Clock. 7, Optical Society of America, 1938, Vol. 28. 215-226.
⁷ Kaivola, M., Poulsen, O., Riis, E., Lee, S. A. Measurement of the Relativistic Doppler Shift in Neon. 4, Phys. Rev. Lett., 1985, Vol. 54. 255-258.
⁸ Grieser, R., Klein, R., Huber, G., Dickopf, S., Klaft, I., Knobloch, P., Merz, P. A test of special relativity with stored lithium ions. 2, s.l.: Applied Physics B, 1994, Vol. 59. 127-133.
⁹ Botermann, B., et. al. Test of Time Dilation Using Stored Li+ Ions as Clocks at Relativistic Speed. 12, Phys. Rev. Lett., 2014, Vol. 113. 120405(1-5).
¹⁰ Terrell, J. Invisibility of the Lorentz Contraction. 4, s.l.: Phys. Review. 116, 4, pg 1041, 1959, Vol. 226. 1041.
¹¹ Rayleigh, Lord. Does Motion through the Aether cause Double Refraction? Philosophical Magazine, 1902, Vol. 4. 678.
¹² Brace, D B. On double refraction in matter moving through the aether. s.l.: Philosophical Magazine, 1904. S. 6 Vol 7, 40.
¹³ Larmor, J. On the ascertained absence of effects of motion through the aether, in relation to the constitution of matter, and on the FitzGerald-Lorentz hypothesis. Philosophical Magazine, 1904. Call L42, 621-625.
¹⁴ Trouton F. T., Rankine A. On the electrical resistance of moving matter. Proc. Roy. Soc., 1908. 80 (420): 420.
¹⁵ Rindler, Wolfgang. Length Contraction Paradox. American Journal of Physics, 1961. 29 (6): 365-366.
¹⁶ Taylor, Edwin F. and Wheeler, John Archibald. Special Relativity, Spacetime Physics: Introduction to. s.l.: New York: W. H. Freeman, 1992. p. 116.
¹⁷ Wells, Willard H. Length paradox in relativity. s.l.: American Journal of Physics, 1961. 29 (12): 858-858.
¹⁸ Shaw, R. Length contraction paradox. s.l.: American Journal of Physics, 1962. 30 (1): 72-72.
¹⁹ Ashby, N. Relativity in the Global Positioning System. s.l.: Living Rev. Relativity, 2003. 6, 1.
²⁰ Einstein, A. Uber das Relativitatsprinzip and die aus demselben gezogene Folgerungen (About the principle of relativity and the conclusions drawn from it). Jahrb. Radioakt. Elektronik 4, 411 (1907).
²¹ Champeney, D. C., Isaak, G. R., and Khan, A. M. A time dilation experiment based on the Mossbauer effect. Proc. Phys. Soc. 85, 583 (1965).
²³ Chou, C. W., Hume, D. B., Rosenband, T., Wineland, D. J. Optical Clocks and Relativity. s.l.: Science, 2010, Vol. 329. 10.1126/science.1192720.
²⁴ Planck, M. On the law of distribution of energy in the normal spectrum. Annalen der Physik, vol. 4 p 553 (1901).
²⁵ Einstein, A. On a heuristic point of view concerning the production and transformation of light. Annalen der Physik 17, 132-148 (1905).
²⁶ Einstein, A. Does the inertia of a body depend upon its energy content? Annalen der Physik. 18, 639 (1905).
²⁷ Fizeau. Sur Les Hypotheses Relatives A L'Ether Lumineux. s.l.: Annales de chimie et de physique, 1859, Dec. 3 serie, LVII.
²⁸ Fresnel, A. Lettre d'Augustin Fresnel à François Arago sur l'influence du mouvement terrestre dans quelques phénomènes d'optique. s.l.: Annales de chimie et de physique, 1818, Vol. 9. 57-66.
²⁹ Laue, M. von. The Entrainment of Light by Moving Bodies in Accordance with the Principle of Relativity. 1, s.l.: Annalen der Physik, 1907, Vol. 23. 989-990.
³⁰ Lerche, I. 12, s.l.: Am. J. Physics, 1977, Vol. 45. 1154-1163.
³¹ Wiedemann, H. Particle Accelerator Physics. Heidelberg: Springer, 2015. ISSN 1868-4513 e-ISSN 1868-4521
³² Feynman, R. Feynman Lectures on Physics. s.l.: Addison-Wesley, 1963. 63-21707.
³³ Rafelski, J. Relativity Matters. Heidelberg: Springer, 2017. 2017935709.
³⁴ Allan, D W., Weiss, M. A., and Ashby, N. Around-the-World Relativistic Sagnac Experiment.
³⁵ Martinez, A. Ritz, Einstein, and the Emission Hypothesis. Phys. Perspect., 2004, Vol. 6. 4-28.
³⁶ H. A. Lorentz, A. Einstein, H. Minkowski and H. Weyl, translated by W. Perrett and G. B. Jeffery. The Principle of Relativity: A Collection of Original Memoirs on the Special and General Theory of Relativity. s.l.: Dover Publications, 1952. p. 81.
³⁷ Bell, J. S. How to teach special relativity. s.l.: Progress in Scientific Culture, 1976. 1(2).
³⁸ Ehrenfest, P. Uniform Rotation of Rigid Bodies and the Theory of Relativity. s.l.: Physikalische Zeitschrift, 1909, Vol. 10. 918.
³⁹ Davis, T. M and Lineweaver, C. H. Expanding Confustion: common misconceptions of cosmological horizons and the superluminal expansion of the universe. 2003, Nov. 13. arXiv:astro-ph/0310808v2

What is claimed is:

1. A system for transmitting information from a first location to a second location, comprising:
a conduit running between the first and second locations;
a material within the conduit;
a signal source at the first location configured to transmit a signal through the material in the conduit;
a material mover in fluid communication with the conduit or source of signal;
and
a signal detector at the second location configured to detect the signal.

2. The system of claim 1, wherein the conduit comprises a metal tube.

3. The system of claim 1, wherein the conduit comprises a closed loop such that material moving through the conduit from the first location returns to the first location in a return conduit.

4. The system of claim 1, where the material is a gas, a supercooled substance, or a superconducting substance.

5. The system of claim 4, wherein the gas is helium.

6. The system of claim 1, wherein the material mover is a pump.

7. The system of claim 1, wherein the material mover is configured to move the material through the conduit at a speed of at least 0.001 c, wherein c is the speed of light in vacuum.

8. The system of claim 1, wherein the material mover is configured to move the material forward and backward in the conduit in an alternating fashion.

9. The system of claim 8, wherein the maximum speed of the material in the conduit is at least 0.001 c, wherein c is the speed of light in vacuum.

10. The system of claim 1, wherein the signal is electromagnetic radiation.

11. The system of claim 1, wherein the signal source comprises a laser.

12. The system of claim 11, wherein the laser is pulse modulated.

13. The system of claim 1, wherein the conduit comprises one or more windows to permit light to pass in or out of the conduit.

14. A method of transmitting information from a first location to a second location, the method comprising:
providing a conduit between the first and second locations;
moving material within the conduit at a speed of at least 0.001 c, wherein c is the speed of light in vacuum; and
transmitting light encoding the information through the moving material.

15. The method of claim 14, wherein the material is a gas.

16. The method of claim 15, wherein the material is helium gas.

17. The method of claim 14, comprising moving material within the conduit at a speed of at least 0.005 c.

18. The method of claim 14, comprising moving material within the conduit at a speed of at least 0.01 c.

19. The method of claim 14, wherein moving the material comprises moving the material forward and backward in an alternating fashion, wherein the maximum speed of the alternating moving material is at least 0.001 c.

20. The method of claim 19, wherein the material is oscillated at a rate of at least 1 kHz.

21. The method of claim 14, wherein the information is encoded using pulse modulation.
